(19) United States
(12) Patent Application Publication
(10) Pub. No.: US 2024/0208779 A1
(43) Pub. Date: Jun. 27, 2024

(54) INSTALLATION VESSEL, LIFTING DEVICE, PILE GRIPPER, CONTROL UNIT AND METHOD

(71) Applicant: Itrec B.V., SCHIEDAM (NL)

(72) Inventors: Diederick Bernardus WIJNING, SCHIEDAM (NL); Joop ROODENBURG, SCHIEDAM (NL)

(73) Assignee: Itrec B.V., SCHIEDAM (NL)

(21) Appl. No.: 18/288,717

(22) PCT Filed: Apr. 29, 2022
(86) PCT No.: PCT/EP2022/061578

§ 371 Date: Oct. 27, 2023

(30) Foreign Application Priority Data
Apr. 30, 2021 (NL) 2028124
Jul. 15, 2021 (NL) 2028741
Aug. 27, 2021 (NL) 2029075

(51) Int. Cl. B66C 23/18; B66C 23/52; E02B 17/00

(52) U.S. Cl. CPC B66C 23/185; B66C 23/52; E02B 17/00; E02B 2017/0039; E02B 2017/0065; E02B 2017/0091

(57) ABSTRACT

A vessel for installation of a pile for supporting a wind turbine includes a hull, a lifting device, and a pile gripper. The lifting device includes a base, an elongate, upright superstructure, and a lifting assembly and the pile gripper includes a gripper base and a gripper device. The pile engagement device and the gripper device are, by respective movabilities thereof in an X-Y plane relative to the vessel, whilst both engaging a pile, and whilst supporting the pile, simultaneously movable relative to the hull from an inboard retaining position in which the pile engagement device is in the upper position and the pile is above the hull, to an outboard installation position of the pile in which the pile is outside the contour of the vessel.

### FIELD OF THE INVENTION

An offshore wind turbine comprises a mast supporting a nacelle and the blades of the wind turbine. The mast is mounted on a foundation, typically in the form of a monopile, i.e. a cylindrical foot section, part of which is driven into the sea floor. As an alternative foundation, a jacket, i.e. a truss or frame work installed on the sea floor, can be used.

At present many offshore wind turbine parks are planned to allow for a significant electricity production. For reasons of efficiency the wind turbines have an ever increasing capacity and size. Nowadays 5 MW turbines and 8 MW are being planned. In the future even 14 MW turbines are envisaged. In known designs a 8 MW turbine has a diameter of the hub with blades of 160 metres combined with a height of the hub at about 120 metres above sea level. A proposed 14 MW turbine has a blades diameter of 220 metres combined with the hub at about 160 metres above sea level.

The weight of a wind turbine including mast, nacelle and blades, at least in future designs, may well be over 1000 t. The foundation itself may well weigh several hundred tonnes, e.g. depending on the type of foundation. The foundation is installed first by driving the pile into the sea bottom after which the wind turbine, the wind turbine comprising a mast, nacelle and blades, is installed on the pile. The wind turbine may be installed at once as a whole or by assembling the wind turbine in parts on the pile. A transition piece may be provided between the pile and the mast of the wind turbine.

To facilitate transport of monopiles to the installation sight, the piles are transported to the installation site in a horizontal position. Storing the monopiles in a horizontal position keeps the center of gravity of these monopiles close to the water surface, which is beneficial for the vessel transporting the monopiles.

At the installation site, the monopiles have to be upended, i.e. a top end of the monopile is lifted relative to a bottom end of the monopile to bring the pile from the horizontal position into a vertical or upright position.

For example from WO2019103611 it is known to transport monopiles in a horizontal position, and to, at the installation site, up-end the monopiles using two deck mounted cranes. The monopiles are stored on the deck of the vessel between two deck mounted cranes. Furthermore, the monopiles are stored with a top end in an overboard position, and with a bottom end supported on a track cart, which track cart is mounted on a track. To upend the monopile, the two cranes lift a top end of the monopile and the bottom end of the pile is guided along the guide track.

For example from WO2019231329 a similar process is known, wherein the monopiles are upended by a single crane. The bottom end of the monopiles is supported by a monopile gripper that tilts with, and supports, the monopile during the upending.

Transporting and upending of monopiles is furthermore known from for example EP3650686A1, WO2019149674A1 and WO2018052291.

A monopile may have a diameter of 10 meter or more, a length of 60 meters or more and a weight of 500 mt or more. There is a trend towards larger wind turbines and a desire to install offshore wind turbines at locations with larger water depths than currently encountered. Both result in larger and heavier foundations. Hence, it is expected that in the near future monopiles need to be installed that are larger than 100 meters, possibly 120 meters or larger. The weight of such piles may be larger than 1000 mt, possibly 1300 mt or above.

Also, there is a trend towards cost reduction in installing off shore wind turbines, in particular to increasing the efficiency of wind turbine installation. This can for example be achieved by shortening the installation process and by enlarging the operational window, i.e. making the installation process less dependent of the circumstances, such as wind, heave, etc.

### OBJECT OF THE INVENTION

The invention relates to a vessel and a method for installation of a foundation of an offshore wind turbine, in particular of monopiles. It is an object of the invention to provide an alternative installation vessel and method for upending monopiles. It is a further object of the invention to provide an improved installation vessel and method for upending monopiles. It is a further object of the invention to provide a installation vessel and method for upending monopiles that allow for a more controlled upending process, and to thus preferably allow for an enlarged operational window.

It is furthermore proposed to assemble wind turbines offshore, i.e. on a dedicated vessel. Thus, the wind turbines can be transported pre-assembled to the installation site, which is much easier than transporting an assembled wind turbine over large distances. At the installation site, the wind turbine is assembled and installed on a foundation, e.g. a foundation pile or floating foundation.

### SUMMARY OF THE INVENTION

According to a first aspect, the invention therefore provides a lifting device according to clause 31.

According to the first aspect, the invention provides a lifting device for upending an elongate wind turbine component, e.g. a foundation pile for supporting a wind turbine or a mast for supporting the nacelle of a wind turbine, onboard a vessel.

According to the invention, the lifting device comprises:
a base, wherein the base is configured to secure the lifting device to the hull of the vessel,
an elongate, upright superstructure,
a trolley guide, e.g. a track comprising one or more guide rails, extending along the upright superstructure in the longitudinal direction thereof,
a trolley, coupled with the trolley guide for being movable along the upright superstructure, guided by the trolley guide, wherein the trolley is provided with a wind turbine component engagement device that is configured to engage, and pivotably support, a wind turbine component at the top end thereof, or wherein the trolley is configured to receive such a wind turbine component engagement device, optionally via a coupler provided to the trolley, for supporting a wind turbine component engagement device,
a lifting assembly connected or connectable to the wind turbine component engagement device and/or the coupler therefor, e.g. via the trolley, and configured to move the trolley with the wind turbine component engagement device, and/or the coupler therefor, when connected, and therewith, the top end of the supported wind turbine component, along the trolley guide, and therewith along the superstructure from a lower position of the wind turbine component with its top end at or near the base to an upper position with the top end remote from the base and an upright orientation of the wind turbine component alongside the superstructure.

A wind turbine component may refer to a pile, or a foundation pile, for supporting the mast of a wind turbine, or to a mast, for supporting the nacelle of a wind turbine.

With a lifting device according to the first aspect of the invention, a wind turbine component can be pivoted from a horizontal transport position into an upended or upright position. During this up-ending of the wind turbine component, a top end of the wind turbine component is guided by the trolley, which trolley in turn is guided by the trolley guide extending long the upright superstructure. The lifting device thus enables a more controlled movement of the wind turbine component during upending. Supporting the top end of the wind turbine component during the upending process provides the wind turbine component with additional stability, which is beneficial when upending large and/or heavy monopiles.

In contrast, when upending a monopile in the prior art, the top end of the wind turbine component is supported at the end of a free hanging hoisting wire. The free hanging hoisting wire is flexible, which thus allows for swing of the top end in a direction substantially perpendicular to the hoisting wire. Therefore, in such an upending process, the position of the top end of the wind turbine component cannot be controlled. For example, movement of the vessel due to sea conditions may cause sway of the wind turbine component, which in turn may cause damage to up-end equipment, for example to a cart supporting a bottom end of the and turbine component during the up-ending process. Therefore, when upending a foundation pile, in the prior art preferably a jack-up vessel is used and/or the upending is only performed under optimal weather conditions.

Thus, guiding the top-end of the monopile according to the first aspect of the invention allows for a more controlled process, more in particular allows for a more controlled movement of the top end of the monopile. This is in particular beneficials when upending large and heavy monopiles. Also, when the movement of the top end of the monopile is controlled by a trolley, the top end is not moved by wind or swing of the vessel, which might be the case when the top end is supported by a traditional crane. Thus, with the lifting device according to the first aspect of the invention, the upending process is less susceptible to weather, which allows for a larger operational window.

In use, the lifting device preferably is set up at an end of an upend deck, which cart track is provided with a cart track and a support cart for guiding the bottom end of the wind turbine component during the upend process. In such a configuration, the lifting device according to the first aspect of the invention allows for guiding both the bottom end and the top end of the wind turbine component during the upend process, and therefore enables an even more controlled movement of the wind turbine component during upending.

In an embodiment, the lifting assembly is a hoisting assembly comprising a hoisting winch and an associated hoisting wire, so that the trolley, and therewith the wind turbine engagement device and/or the coupler therefor, when connected, is movable along the guide by operating the hoisting winch.

In this embodiment, a hoist is used for moving the trolley. Providing the lifting assembly with hoisting winch and associated hoisting wire enables using the trolley as a hoisting device, for example for lifting and lowering loads in a location adjacent the upright super structure.

In an alternative embodiment, the trolley is for example moved along the trolley guide using a rack and pinion drive system. A rack and pinion drive may for example be used when ability to lift very heavy loads is more important than lifting speed.

In a further embodiment, the hoisting assembly comprises an upper sheave assembly at the upright superstructure, and the hoisting assembly is connected or connectable to wind turbine component engagement device and/or the coupler therefor via a load coupling device comprising a lower sheave assembly, e.g. by means of a connection thereof to the trolley, the hoist wire being arranged in multiple falls through the upper and lower sheave assemblies to enable the crane to lift the load using the hoisting winch.

In such an embodiment, the multiple falls arrangement enables lifting heavy loads, while the load coupling device facilitates using the trolley to lift other loads besides wind turbine components, in particular foundation piles and/or masts. For example, the hoisting assembly may be used to lift the nacelle and/or the blades of a wind turbine, to thus enable the use of the lifting device in assembling a wind turbine.

In an embodiment, the lifting device is a crane, the base of the lifting device is a crane base, and the upright superstructure is an upright crane superstructure. In this embodiment, the crane superstructure comprises a crane housing and a boom, wherein the boom extends between a boom base end and a boom top end, wherein the boom is at the boom base end pivotable supported by the crane housing around a horizontal boom pivot axis, the boom having lowered positions for lifting a load at a horizontal distance from the crane base, and a raised upend position to form the upright superstructure, for upending the pile alongside the crane base, and wherein preferably at least part of the trolley guide is mounted to the boom. In this embodiment, the crane further comprises a luffing winch and an associated luffing wire, wherein the luffing winch is mounted on the crane housing and the luffing wire extends between the luffing winch and the boom, to enable pivoting of the boom between the lowered and the raised upend position around the horizontal boom pivot axis.

Incorporating at least part of the trolley guide in a boom, which boom can be pivoted into a raised upend position, allows for the lifting device to be used as a crane, and expands the working area of the lifting device and the functionality of the lifting device. With the boom in one of the lowered portions a load can be lifted at a horizontal distance from the crane base, and with the boom in the raised upend position, the crane forms the upright superstructure for the controlled upending of wind turbine components. In a further preferred embodiment, the crane is configured to lift wind turbine components from a storage deck onto an upend deck, and/or from a quay or supply vessel onto the vessel the crane is mounted on.

In an embodiment, the lifting device, e.g. the crane, further comprises a slew bearing provided between the base and the superstructure, e.g. between the crane base and the crane housing, wherein the slew bearing enables the superstructure to slew about a vertical slew axis relative to the base.

In such an embodiment, the slew bearing enables moving a lifted wind turbine component, for example an upended foundation pile from an inboard position to an outboard position, by slewing the lifting device, e.g. the crane housing.

In an alternative embodiment, the lifting device, e.g. the crane, comprises a deck mounted track. The track enables moving the lifting device, e.g. the crane housing, relative to the vessel, and thus enables moving a lifted wind turbine component, for example enables moving an upended foundation pile from an inboard position to an outboard position.

According to the first aspect, the invention furthermore provides a crane for upending an elongate wind turbine component, e.g. a foundation pile for supporting a wind turbine or a mast for supporting the nacelle of a wind turbine, onboard a vessel, the crane comprising
a crane base, the crane being configured to via the crane base be secured to the hull of the vessel, and
an elongate, upright crane superstructure, comprising:
a crane housing; and
a boom, wherein the boom extends between a boom base end and a boom top end, wherein the boom is at the boom base end pivotable supported by the crane housing around a horizontal boom pivot axis, the boom having lowered positions for lifting a load at a horizontal distance from the crane base, and a raised upend position to form the upright superstructure, for upending the pile alongside the crane base,
a slew bearing provided between the crane base and the crane housing, wherein the slew bearing enables the crane superstructure to slew about a vertical slew axis relative to the base;
a luffing winch and an associated luffing wire, wherein the luffing winch is mounted on the crane housing and the luffing wire extends between the luffing winch and the boom, to enable pivoting of the boom between the lowered and the raised upend position around the horizontal boom pivot axis;
a trolley guide, e.g. a track comprising one or more guide rails, extending along the upright crane superstructure in the longitudinal direction thereof,
a trolley, coupled with the trolley guide for being movable along the upright crane superstructure, guided by the trolley guide, wherein the trolley is provided with a wind turbine component engagement device that is configured to engage, and pivotably support, a wind turbine component at the top end thereof, or wherein the trolley is configured to receive such a wind turbine component engagement device, optionally via a coupler provided to the trolley, for supporting a wind turbine component engagement device,
a hoisting assembly, the hoisting assembly comprising
an upper sheave assembly at the upright superstructure
a load coupling device comprising a lower sheave assembly
a hoisting winch and an associated hoisting wire,
wherein the hoist wire is arranged in multiple falls through the upper and lower sheave assemblies to enable the crane to lift the load using the hoisting winch, and
wherein the hoisting assembly is connected or connectable to the wind turbine component engagement device and/or the coupler therefor via a load coupling device, e.g. by means of a connection thereof to the trolley, and so that the trolley, and therewith the wind turbine engagement device and/or the coupler therefor, when connected, is movable along the guide by operating the hoisting winch to move the trolley with the wind turbine component engagement device, and/or the coupler therefor, when connected, and therewith, the top end of the supported wind turbine component, along the trolley guide, and therewith along the upright crane superstructure from a lower position of the wind turbine component with its top end at or near the base to an upper position with the top end remote from the base and an upright orientation of the wind turbine component alongside the upright crane superstructure.

With a crane according to the first aspect of the invention, the boom of the crane can be pivoted in an upend position for upending the wind turbine component with a top end of the wind turbine component guided by the trolley. This allows for controlled upending, in particular with large and heavy monopiles and wind turbine masts.

The pivotable boom can be pivoted between a lowered hoist position for lifting a load at a distance from the crane base and a raised upend position for upending wind turbine components into an upright position adjacent the crane base. The crane preferably is set up at an end of an upend deck with a cart track and a support cart for guiding the bottom end of the wind turbine component during the upend process. The boom of the crane is provided with a trolley guide and an trolley for guiding the top end of the monopile during the upending process.

Thus, the upend crane according to clause 1 allows for guiding both the bottom end and the top end of the wind turbine component during the upend process, and therefore enables a more controlled movement of the wind turbine component during upending. Supporting the top end of the wind turbine component during the upending process provides the wind turbine component with additional stability, which is beneficial when upending large and/or heavy monopiles.

For example, when upending a monopile in the prior art the top end of a monopile is supported by a crane, which allows for swing of the top end. Guiding the top-end of the monopile according to the invention allows for a more controlled process, more in particular allows for a more controlled movement of the top end of the monopile. This is in particular beneficials when upending large and heavy monopiles. Also, when the movement of the top end of the monopile is controlled by a trolley, the top end is not moved by wind or swing of the vessel, which might be the case when the top end is supported by a traditional crane. Thus, with the crane according to clause 1 the upending process is less susceptible to weather, and allows for a larger operational window.

According to the first aspect, the invention furthermore provides an upend crane, to be supported by the hull of a vessel adjacent an upend deck for upending wind turbine components, e.g. piles or masts, wherein the upend crane comprises:
a crane base,
a crane housing and a slew bearing provided between the crane base and the crane housing, wherein the slew bearing enables the crane housing to slew about a vertical slew axis;
a boom, wherein the boom extends between a base end and a top end, wherein the boom is at the base end pivotable supported by the crane housing for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom, to enable pivoting the boom between the lowered and the raised upend position; and
a hoist, wherein the hoist comprises a hoisting winch and an associated hoisting wire, wherein the hoisting wire is guided via an upper sheave assembly in the boom to a lower sheave assembly of the load coupling device for coupling with a load, e.g. a top end of a wind turbine component, to enable the crane to lift the load using the hoisting winch;
a trolley guide, e.g. a track comprising one or more guide rails, mounted to the boom of the crane; and
a trolley, coupled with the trolley guide for being guided along the boom of the crane, wherein the trolley is provided with a wind turbine component engagement device that is configured to pivotably support a wind turbine component at the top end thereof, or wherein the trolley is configured to receive a wind turbine component engagement device and/or a load coupling device supporting a wind turbine component engagement device.

It is noted that is known to provide a vessel with a rigid upright tower provided with a trolley guide and an trolley for upending a monopile. This type of construction is not provided with a pivotable boom, and therefore is not configured for lifting a load at a distance from the tower. An up end crane according to the first aspect of the invention is configured for controlled upending, i.e. guiding the top end of a wind turbine component, and for lifting a load, i.e. lifting a load with the boom in a lowered position and preferably for pivoting the boom while supporting the load to thus move the load towards or away from the base of the crane.

The crane according to the first aspect of the invention can be used with a floating vessel, i.e. a non-jack-up type floating hull, that is configured to maintain a position and orientation relative to an installation site. Thus, the vessel does not need to be anchored or jacked up to enable installation of a monopile, which allows for a fast process. Furthermore, such a vessel can be deployed in deeper water, for the installation of large size monopiles, as well.

The boom of the crane can be pivoted in a lowered hoist position to enable the crane to lift a load at a distance from the crane base. Furthermore, by pivoting the boom while the crane supports a load, the load can be moved towards or away from the base of the crane.

When the boom is raised in the upend position, it is in a substantially vertical or upright position. When the load coupling device, supported by the hoisting wire of the hoisting winch, is engaged by the trolley, the trolley can be used to guide the load coupling device along the boom of the crane. Thus, sway of the load coupling device relative to the boom is prevented, and the top end of a wind turbine component supported by the load coupling device can be moved along the boom in a controlled manner.

With a crane according to the invention, the boom of the crane can be pivoted in an upend position for upending the wind turbine component with the bottom end of the wind turbine component being guided by a cart on a upend track and with the top end of the wind turbine component being guided by the trolley and the trolley guide. Preferably, when the boom is in the upend position, the boom, or at least the trolley guide mounted to the boom, extends in an essentially vertical direction.

In a further embodiment, the crane housing is provided with a boom support for engaging the boom when in the upend position, which boom support prevents the boom from moving beyond the upend position. In addition or as an alternative, the crane is provided with boom securing means for securing the boom in the upend position during the upend process.

In an embodiment, the crane comprises a boom securing device, the boom securing device comprising a stop for positioning the boom in the raised upend position thereof, and a boom locking device, for locking the boom in the raised upend position. Such a boom securing device is for example provided on a gantry that is mounted on, or is part of, the crane housing. By securing the boom, it is prevented that the boom moves out of the upend position during the upend process, and preferably the boom is fixed in position, to prevent any pivoting of the boom.

In a further embodiment, the boom securing device comprises an active damper, e.g. hydraulic cylinders, that resiliently engage the boom, when the boom is moved into the upend position, e.g. engage the boom when it is at an angle of 3 degrees with the vertical. In an embodiment, boom restrainer comprises hydraulic cylinders that are forced into an extend position. Thus, when the boom pivots upwards and engages the cylinders, the cylinders provide a resilient force that pushes the boom in the downward direction.

Thus, when the boom is a the top zone it is engaged by the damper, and when it is lowered out of the top zone, the damper disengages the boom. In an embodiment, the damper engages the boom when the boom is at an angle of 6 degrees or less, for example 3 degrees or less with the vertical.

In an embodiment, the crane comprises a boom mobiliser, for pivoting the boom out of the raised upend position, e.g. a hydraulic cylinder operative for pushing or pulling the boom, or a boom mobilisation winch with an associated wire for pulling the boom for pivoting the boom, out of the raised upend position. Thus, after the upend process, the boom can be pivoted out of the upright position, e.g. the boom can be pushed away from the upend position by a cylinder, of can pulled away from the upend position by a winch with associated wire.

It is noted that the luffing wires may only effectively support the boom, and enable lowering of the boom, when the boom is out of the upright position, e.g. is at an angle of 3 degrees or more with the vertical. Thus, the boom mobiliser can be used to move the boom from the upright position into a position in which the luffing wires can support the boom.

In a further embodiment, the boom mobiliser is integrated in the boom securing device, for example the boom securing device comprises hydraulic cylinders that function as a damper for receiving the boom when pivoted into the upend position and that push the boom out of the upend position after the upending process.

In an embodiment, the trolley is provided with a wind turbine component engagement device that is configured to engage, and pivotably support, a wind turbine component, e.g. a monopile or mast, at the top end thereof. Thus the trolley is configured to engage the upper end of a wind turbine component such as a foundation pile, positioned horizontally on the deck, at a top end thereof. In an alternative embodiment, the trolley is configured to receive the wind turbine component engagement device, optionally via a coupler provided to the trolley, for supporting a wind turbine component engagement device, In such an embodiment, the wind turbine component device can be removed from the trolley. In an embodiment, the wind turbine component engagement device is configured to be connected to a load connector supported by hoisting wires of the lifting device, and the trolley is configured to be coupled with the load connector, and thus with the monopile component engagement device, for guiding the monopile engagement device along the trolley guide.

In an embodiment, the load coupling device of the crane is configured to be coupled with a monopile engagement device, e.g. a monopile top end clamp, that is configured to pivotably support a monopile at the top end thereof.

In an embodiment, the trolley is configured to be coupled with a wind turbine component engagement device. The monopile engagement device preferably is configured to pivotable support the top end of the wind turbine component, to enable the monopile to pivot relative to the load coupling device and the trolley during upending.

In an embodiment, the lifting device is provided with a boom, and the load coupling device and the trolley are configured to be coupled, and the trolley is provided with a load coupling device configured to be coupled with the top end of the wind turbine component. In such an embodiment, the hoisting wire of the hoisting winch supports a load coupling device that can be used for coupling to the trolley. When the boom is raised in the upend position and the load coupling device, that is supported by the wire of the upend winch, is connected to the trolley, the trolley can be used to upend a wind turbine component.

When the boom is lowered from the upend position into a hoist position, and the load coupling device is not coupled with the trolley, the load coupling device can be used to lift a load at a distance from the crane base.

In an embodiment, the lifting device is provided with a boom, i.e. is configured as a crane, and the crane further comprises a secondary hoist comprising a secondary hoisting winch with an associated secondary hoisting wire supporting a secondary load coupling device configured to be connected to a load, and the hoisting wire is guided via a crown block to the load coupling device for lifting a load at a distance from the crane base using the secondary hoisting winch. In such an embodiment, the crane is provided, in addition to the hoist, with a secondary hoist, the secondary hoist comprising a secondary hoisting winch for, when the boom is a lowered position, lifting loads at a distance from the base of the crane. In an embodiment, the secondary hoist is configured to lift and lower the trolley along the trolley guide, more in particular to move the trolley along the trolley guide in a position to engage or disengage the load coupling device of the main hoist.

In an embodiment, the trolley is configured to engage the load coupling device such that when they are coupled, the trolley moves with the load coupling device along the trolley guide. Thus, the main hoist can be used to move the trolley along the trolley guide.

In an embodiment, the trolley guide furthermore extends along the base of the lifting device, Thus the trolley can be moved from the super structure onto the base of the lifting device.

In an embodiment wherein the lifting device is provided with a boom, the trolley guide extends below the horizontal boom pivot axis of the boom, at least when the boom is in the upend position. In such an embodiment, the trolley guide extends along the boom of the crane and below the boom of the crane. Thus, the trolley can not only be moved along the boom of the crane, but can be lowered below the boom of the crane, when the boom is in the upend position. Extending the trolley guide along the base and/or below the boom pivot axis allows for moving the trolley closer to the upend deck. This is for example beneficial when the boom pivot axis is positioned at some distance above the upend deck of the vessel. Because the trolley can be moved close to the upend deck, it can be optimally positioned relative to the top end of a wind turbine component, or can even be parked close to the deck to facilitate access by personnel, for example for adaptation of maintenance of the trolley.

In a further embodiment, the lower section of the trolley guide, preferably the section that extends below the boom pivot axis, is mounted to the crane housing and is hingable connected to the section of the trolley guide connected to the boom, or is separate or separable from the trolley guide connected to the boom, such that it does not pivot with the boom, and with the trolley guide connected to the boom, when the boom is pivoted about the boom pivot axis.

In an embodiment, the trolley guide comprises a superstructure section that is mounted to the elongate upright superstructure of the lifting device, and a base section that is mounted to the base of the lifting device, such that the trolley can be moved from the elongate upright superstructure onto the base and vice versa. This allows for a base having a substantial height, while still enabling the trolley to be lowered close to the deck surface.

In an embodiment, the trolley guide comprises a boom section that is mounted to the boom of the crane, and a base section that is mounted to the base of the crane, and wherein the trolley is movable from the boom section onto the base section, for example for coupling the top end of the wind turbine component to the wind turbine component engagement device.

In this embodiment, the trolley guide comprises a base section that is mounted to the base of the crane, and thus extends along the base of the crane, and below the boom pivot axis. Thus, the base section of the trolley guide does not move with the crane housing and the boom when these are slewed about the vertical axis.

In a preferred embodiment, the lifting device is combined with a cart track configured to guide cart supporting a bottom end of a wind turbined component. In such an embodiment, the base section of the trolley guide preferably is aligned with the cart track, such that it can be used to lower the trolley in a position close to the deck and in alignment with the cart track, and to thus enable guiding the load coupling device in a position close to the deck. Guiding the load coupling device close to the deck allows for engaging a monopile that is set up close to the deck. When the trolley cannot be lowered close to the deck, the lower section of the upending movement may not be guided, and therefore may not be optimally controlled. This configuration allows for a compact trolley and/or wind turbine component engagement device. Furthermore, the track can be set up close to the deck, and does not have to be raised, to present the wind turbine component at a height that allows for the top of the wind turbine component to be coupled with the load coupling device to enable a controlled fully controlled, i.e. guided, upend movement.

Preferably, the base section of the trolley guide is dimensioned to receive the trolley. Thus, the trolley can be parked on the base section of the trolley guide. When the trolley is parked on the base section, for example the boom of the crane can be operated without it supporting the trolley. This is in particular beneficial when the boom of the crane is to be used to lifting a load, and not for upending a wind turbine component.

In a further embodiment, the base of the crane or lifting device is provided with multiple trolley guide base sections, that each can be aligned with the trolley guide section provided on the boom or superstructure by slewing the crane house or superstructure in the correct position. In an embodiment, the one or more trolley guide bases are configured to park one or more secondary trolleys, e.g. a secondary trolley that can be used in combination with the trolley supporting the top end of the wind turbine component, for engaging a lower end of the wind turbine component to stabilise the wind turbine component when it is lifted by the crane, or a secondary trolley configured to be used instead of the main trolley, wherein the secondary trolley is configured to engage and support a nacelle or wind turbine blades for assembling a wind turbine.

In an embodiment, the trolley guide comprises a boom section that is provided with a lower section that extends below the pivot axis of the boom, and the base section of the trolley guide aligns with this lower section of the boom guide when the crane is slewed in the correct position.

In an alternative embodiment, the base section of the trolley guide extends up to, or beyond, the boom pivot axis.

In an embodiment, the trolley guide comprise one or more guides, e.g. one or more rails, and the trolley is provided with guide engagement devices, for example guide wheels, that engage the guides, and that movable secure the trolley to the trolley guide. Thus the trolley can only move along the trolley guide and not in a direction perpendicular to the trolley guide.

In an embodiment, the upend crane is mounted on a vessel having a upend deck and the vessel furthermore comprises a storage deck, supported by the hull of the vessel, wherein the storage deck is provided with storage racks for supporting multiple monopiles or masts in a horizontal position, wherein the storage deck and the storage racks are configured to support multiple wind turbine components parallel to each other and preferably parallel to a longitudinal axis of the vessel.

In an embodiment, the storage racks are configured to support a row of multiple, for example three, wind turbine components on the storage deck. In a further embodiment, the storage racks are configured to support two or more rows, one row stacked upon the other row, of multiple wind turbine components. Preferably the storage deck is located adjacent the upend deck, and the wind turbine components are stored on the storage deck parallel to the cart track. This facilitates moving the wind turbine components from the storage deck to the upend deck an onto the cart track, because the orientation of the wind turbine components does not have to be changed when they are lifted from the storage deck onto upend deck.

In an embodiment, the upend crane is mounted on a vessel and is located at one end of a storage deck and/or an upend deck. In a further embodiment, the vessel is provided with an upend deck and a storage deck that are both part of a single deck.

In an embodiment, the upend deck and the lifting device are configured such that the wind turbine component, when supported in a horizontal position on the upend deck and with the top end of the wind turbine component coupled to the load coupling device, is parallel to a longitudinal axis of the vessel.

In an embodiment, the upend crane is mounted on a vessel and is located at one end of the storage deck, and the vessel is provided with a storage crane at an opposite end of the storage deck, and wherein the upend crane and the storage crane are configured to together lift a wind turbine components from the storage deck to the upend deck, the crane and the storage crane each lifting an end of the wind turbine components. In such an embodiment, the crane and the storage crane are positioned to lift a wind turbine components in a horizontal position from the storage deck onto the upend deck. In a further embodiment, the cranes can furthermore be used to lift a wind turbine components from a supply vessel or from the quay onto the storage deck.

In an embodiment, the upend deck and storage deck are both part of a single vessel deck.

In an embodiment, the upend deck and the crane are configured such that the wind turbine component, when supported in a horizontal position on the upend deck and with the top end of the wind turbine component coupled to the load coupling device, is parallel to a longitudinal axis of the vessel.

In an embodiment, the wind turbine component engagement device, and/or the coupler therefor, if present, is arranged on an active X-Y motion device, configured for moving the wind turbine component engagement device e.g. via the coupler therefor, if present, relative to the trolley guide in an X-Y plane of the vessel, when the lifting device is secured to the hull.

In an embodiment, an active horizontal motion device is mounted between the trolley and the load coupling device, when received in the trolley, and/or a wind turbine component engagement device supported by the load coupling device.

The active horizontal motion device is adapted to actively compensate for sea-state induced horizontal displacement of the wind turbine component engagement device in two non-parallel horizontal directions, e.g. in orthogonal horizontal directions, while the wind turbine component is supported in an upright position by the wind turbine component engagement device. Thus providing the lifting device or crane with an active horizontal motion device enables more accurately positioning of the wind turbine component relative to a wind turbine component installation location adjacent the vessel, because the active horizontal motion device allows for compensating for deviations of the vessel, for example cause by a sea current, relative to the wind turbine installation location. It is submitted that this is in particular beneficial when the vessel is a floating vessel.

When the vessel is a non-floating vessel, e.g. a jack up vessel, the lifting device or crane can be provided with a horizontal motion device, to compensate for deviations of the vessel relative to the installation location that have occurred during anchoring of the vessel. In this situation, active, i.e. continuous, compensation is not required because the vessel is in a fixed position relative to the installation location.

In a further embodiment, the active horizontal motion device comprises one or more motor powered displacement actuator assemblies, e.g. a hydraulic power assembly including a pump and one or more hydraulic cylinders or a winch assembly.

In an embodiment, the active X-Y motion device comprises an X-Y motion compensating actuation control system, wherein the active motion compensating actuation system has an active sea-state induced motion compensation mode in which the actuation system is operated to compensate for sea-state induced motion of the vessel in the X-Y plane. In further embodiment, the active X-Y motion compensating actuation control system also controls the movement of a pile gripper in the X-Y plane. Thus, the position in the X-Y plane of a pile supported at a top end by the lifting device and engaged at a lower end by the pile gripper can be actively controlled.

In an embodiment, the active X-Y motion device, e.g. including the active motion compensation actuation control system, comprises one or more first tracks, e.g. rails, and one or more second tracks, e.g. rails, extending non-parallel to one another in the X-Y plane of the vessel when the lifting device is secured to the hull, which second tracks are movable over the first tracks, the actuation system further comprising one or more first X-Y motion actuator assemblies operative between the first tracks and the second tracks, for moving the second tracks over the first tracks, and one or more second X-Y motion actuator assemblies operative between the second tracks and the wind turbine component engagement device and/or the coupler therefor, for moving the wind turbine component engagement device and/or the coupler over the second tracks.

In a further embodiment, the first and second X-Y motion actuator assemblies of the active X-Y motion device are motor powered displacement actuator assemblies, e.g. hydraulic power assemblies each including a pump and one or more hydraulic cylinders, or winch assemblies.

In an embodiment, the crane further comprises a trolley hoist comprising a trolley hoisting winch with an associated trolley hoisting wire, and the trolley hoisting wire is guided via a crown block to the load trolley for moving the trolley along the trolley guide. In such an embodiment, the hoist of the crane is used when lifting loads, and the trolley hoist is used, for moving the trolley, when upending wind turbine components.

In an embodiment, the crane further comprises a secondary hoist comprising a secondary hoisting winch with an associated secondary hoisting wire supporting a secondary load coupling device configured to be connected to a load, and wherein the hoisting wire is guided via a crown block to the load coupling device for lifting a load at a distance from the crane base using the secondary hoisting winch.

In an embodiment, the hoisting wire passes between the upper sheave assembly and the lower sheave assembly, and the hoisting winch has a power sufficient to support and lift the wind turbine component, e.g. to lift an assembled wind turbine or a pile.

In an embodiment, the crane further comprises a crane tower for supporting the wind turbine component. In such an embodiment, the boom is provided on the crane at one side thereof relative to the slew axis of the crane, and the crane tower is provided on the opposite side of the crane relative to the slew axis. Furthermore, the crane tower extends between a base end and a top end thereof, and is mounted in a fixed and upright orientation on the crane housing for slewing with the boom of the crane about the slew axis. The crane tower is provided with:
a tower trolley guide, e.g. a track comprising one or more guide rails, extending along the tower in a longitudinal direction thereof,
a tower trolley, coupled with the tower trolley guide for being movable along the tower, guided by the tower trolley guide, e.g. wherein the tower trolley is provided with a wind turbine component engagement device that is configured to couple to, and support, a wind turbine component at the top end thereof, or e.g. wherein the trolley is configured to receive such a wind turbine component engagement device and/or a coupler for supporting a wind turbine component engagement device, and
a tower hoisting winch and an associated hoisting wire, wherein the hoisting wire is guided via the top of the crane tower for hoisting the crane trolley along the trolley guide for lifting and lowering the wind turbine component.

For example, the crane tower can be used for supporting a monopile in a gripper and for lowering the monopile in a vertical position into the water adjacent the vessel, while upending a mast using the boom of the upend crane.

In an embodiment, the lifting device, e.g. the crane housing and/or the boom of the crane, is provided with wind turbine component securing arms or tuggers for engaging a lower section of a wind turbine component supported by the lifting device in its upright orientation, in particular for preventing sway of the wind turbine component during slewing of the crane whilst supporting the wind turbine component in the upright orientation.

This configuration enables the lifting device to move the wind turbine component from one location to another location, for example from an onboard location to an overboard location for installation of the wind turbine component at the installation site, for example for mounting the mast of an assembled wind turbine onto a foundation.

In an embodiment, the elongate upright structure comprises a trolley guide provided on the elongate upright superstructure, a trolley connected to the trolley guide, and a jib, and an upper sheave assembly is provided in the jib and hoisting wires of the lifting assembly, extending between a trolley of the lifting device and the sheave assembly provided in the jib, are horizontally spaced from the elongate upright superstructure, and are preferably substantially in line with the central axis of a wind turbine component supported in its upright orientation by the lifting device. In a further embodiment, the portion of the hoisting wires that extends between the trolley and the sheave assembly runs parallel to the trolley guide.

In such an embodiment preferably the hoisting wire is aligned with the center of gravity of the support wind turbine component, when the wind turbine component is upended. In such an embodiment the jib, and not the trolley, supports the weight of a lifted wind turbine component. Thus the trolley can be of a comparatively light design.

In a further embodiment, the lifting device is embodied as a crane and the boom of the crane comprises a jib, and the upper sheave assembly is provided in the jib such that the hoisting wire, at least when connected to the wind turbine component engagement device, e.g. via the coupler and/or trolley, extends horizontally spaced from the boom, and are preferably substantially in line with the central axis of a wind turbine component supported in its upright orientation by the wind turbine component engagement device.

In such an embodiment, the hoisting wire is positioned away from the boom. The hoisting wire, or more in particular the section of the hoisting wire that is luffed between the upper sheave assembly and the lower sheave assembly, is aligned with the wind turbine component supported by the crane in the vertical position. This configuration makes that the trolley is not subjected moment forces caused by the weight of a wind turbine component supported by the crane.

In yet a further embodiment, a portion of the hoisting wires that extends between the trolley and the upper sheave assembly runs parallel to the trolley guide.

In an embodiment, the boom is an A-frame, comprising two legs, and wherein the trolley guide is provided on both legs. In a further embodiment, the crane boom at the base end thereof comprises a gantry, and at the top end comprises a gantry jib, and is provided with one or more gantry wires extending between the gantry and the gantry jib, and wherein the luffing wire extends between the luffing winch and the boom extends between the luffing winch and the gantry of the boom. This configuration reduces bending forces in the A-frame of the boom, in particular when the boom also comprises a jib for spacing the hoisting wire from the boom.

In an embodiment, the boom forms an A-frame, comprising two legs, and the trolley guide is provided on both legs of the A-frame, e.g. one or more tracks, e.g. rails, on each leg.

In an embodiment, the trolley is provided with a wind turbine component engagement device that is configured to pivotably support a wind turbine component at the top end thereof, and wherein the trolley is configured to be coupled with the load coupling device of the hoist. Thus, in such an embodiment, the hoist is used to move the trolley along the trolley guide and the trolley is coupled to the wind turbine component.

In an alternative embodiment, the trolley is configured to receive a wind turbine component engagement device that is supported by the load coupling device of the hoist. In such an embodiment, the hoist is used for moving the load coupling device, which load coupling device supports the wind turbine component engagement device, and via that a wind turbine component. When the wind turbine component is received in the trolley, the hoist can also be used for moving the trolley along the trolley guide.

In an alternative embodiment, the trolley is configured to receive the load coupling device of the hoist, which load coupling device is supporting a wind turbine component engagement device that is configured to pivotably support a wind turbine component at the top end thereof. Thus, the trolley cab be moved with the hoist when the load coupling device is received in the trolley.

In an embodiment, lifting device is configured as a crane, and the crane comprises a trolley hoist comprising a trolley hoisting winch with an associated trolley hoisting wire, and the trolley hoisting wire is guided via a crown block to the trolley for moving the trolley along the trolley guide. In such an embodiment, the trolley is provided with a dedicated hoist, and preferably a hoisting trolley is provided for lifting loads, when the boom of the crane is in one of the lowered positions, i.e. for lifting a load horizontally spaced from the crane base.

In an embodiment, the crane comprises a secondary hoist comprising a secondary hoisting winch with an associated secondary hoisting wire supporting a secondary load coupling device configured to be connected to a load, and the hoisting wire is guided via a crown block to the load coupling device for lifting a load horizontally spaced from the crane base using the secondary hoisting winch. Thus, the first hoisting winch can be used for moving the trolley and thus for upending wind turbine components, and optionally for lifting loads with the boom in a lowered position. The secondary hoisting winch can used exclusively for lifting loads with the boom in one of the lowered positions.

The invention furthermore provides an installation vessel, for installation and preferably transport of wind turbine components, e.g. piles, e.g. monopiles, or masts, the installation vessel comprising:
a hull, the hull forming an upend deck,
a lifting device, e.g. a crane, according to the invention, wherein the lifting device is supported by the hull of the vessel adjacent the upend deck,
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal from the crane to a position adjacent the crane;
a gripper, the gripper extending outside a contour of the vessel, e.g. for guiding a monopile being lowered in a vertical position into the water adjacent the vessel or for engaging, and preferably stabilising, a floating foundation for mounting a mast.

In an embodiment, the vessel furthermore comprises a storage deck, supported by the hull of the vessel, wherein the storage deck is provided with storage racks for supporting multiple wind turbine components in a horizontal position, wherein the storage deck and the storage racks are configured to support multiple wind turbine components parallel to each other and preferably parallel to a longitudinal axis of the vessel.

In an embodiment, the lifting device comprises a jib at a top end of the upright superstructure, for spacing the hoisting wire at a distance from the upright superstructure, and a slew bearing, for slewing the upright superstructure about a vertical slew axis relative to the base.

In a further embodiment, the lifting device is located at one end of the storage deck, and wherein the vessel is provided with a storage crane at an opposite end of the storage deck, and wherein the lifting device and the storage crane are configured to together lift wind turbine components from the storage deck to the upend deck, the lifting device and the storage crane each lifting an end of the wind turbine component.

In an embodiment, the upend deck and storage deck are both part of a single vessel deck.

In an embodiment, in a further embodiment, the upend deck and the lifting device are configured such that the wind turbine component, when supported in a horizontal position on the upend deck and with the top end of the wind turbine components coupled to the load coupling device, is parallel to a longitudinal axis of the vessel.

In an embodiment, the cart track is aligned with the slew axis of the lifting device, such that a central axis of the wind turbine component supported at one end by the cart and at an opposite end coupled with the trolley is aligned with the slew axis of the lifting device.

In an embodiment, the upend deck with the cart track is located on the central axis of the vessel, and the lifting device is mounted away from the central axis of the vessel, e.g. along the side of the vessel. In such an embodiment, the cart track is thus not aligned with the slew axis of the lifting device. In such an embodiment, the wind turbine component is aligned with the central axis of the vessel during the upend process. In a further embodiment, the gripper is located on the for engaging a pile on the central axis of the vessel as well, and the wind turbine component can be moved into the gripper without substantially deviating from the center line of the vessel. The latter allows for an efficient transfer of the wind turbine component from the upend location above the vessel to the installation location adjacent the vessel, i.e. outside the contour of the vessel.

In an alternative embodiment of an installation vessel according to the invention, the cart track is aligned with the slew axis of the lifting device, such that a central axis of the wind turbine component supported at one end by the cart and at an opposite end coupled with the trolley is aligned with the slew axis of the lifting device, e.g. the upending crane. Thus, the weight of the wind turbine components is optimally transferred to the lifting device during the upending process.

In a further embodiment, at least part of the storage deck is aligned with a central longitudinal axis of the vessel, such that a wind turbine components can be stored on the storage deck on the centerline of the vessel. In such an embodiment, the upend deck is adjacent the central longitudinal axis of the vessel, and a wind turbine components supported on the upend deck is not located above the central longitudinal axis of the vessel.

In an embodiment, the gripper is a monopile gripper, and is located at the stern of the vessel for engaging a pile that is supported by the lifting device on the central longitudinal axis of the vessel. This is in particular beneficial when the hull of the vessel has an elongate shape. When the gripper is thus located on the center line of the vessel, transfer of the wind turbine component to the installation site, in particular landing the monopile on the seafloor or the mast on a foundation, does not cause a major shift in balance of the vessel, and therefore does not require the use of active ballast to compensate for roll of the vessel.

In an embodiment, the gripper is x-y compensated, i.e. is configured to position a wind turbine component, supported by the lifting device, preferably the upend crane, in an upended, i.e. upright, position, in the X-Y plane, and thus compensate for movement of the vessel relative to wind turbine component installation location.

In an embodiment, the trolley is an x-y compensated trolley, i.e. is configured to position the top of the wind turbine component, supported in the upended position, in the X-Y plane, and thus compensate for movement of the vessel relative to wind turbine component installation location. For example, in an embodiment, an active horizontal motion device is mounted between the trolley and the load coupling device, when received in the trolley, and/or a wind turbine component engagement device supported by the load coupling device, the active horizontal motion device being adapted to actively compensate for sea-state induced horizontal displacement of the monopile engagement device in two non-parallel horizontal directions, e.g. in orthogonal horizontal directions, while the wind turbine component is supported in an upright position by the wind turbine component engagement device.

In a further embodiment, the active horizontal motion device comprises one or more motor powered displacement actuator assemblies, e.g. a hydraulic power assembly including a pump and one or more hydraulic cylinders or a winch assembly.

In a further embodiment, the active horizontal motion device is connected to a horizontal motion device linked to the gripper, for moving the load coupling device and/or the wind turbine component engagement device in dependence of movement of the gripper. For example, a control device can be provided that controls both the horizontal motion device of the trolley and the horizontal motion device of the gripper.

In an embodiment, the vessel comprises a recess at the aft of the vessel, the recess being flanked by two deck portions. In a further embodiment, the gripper is a mono pile gripper configured to guide a monopile in the recess. In yet a further embodiment, the monopile gripper is mounted on one of the deck portions and the upend crane is mounted on the opposite deck portion.

In an embodiment, the upend deck is provided on the central axis of the vessel, and is aligned with the recess, and on opposite sides of the upend deck a storage deck is provided, the storage decks being aligned with the deck portions, and the storage deck aligned with the deck portion on which the crane is mounted, is provided with storage for wind turbine blades.

In an embodiment, the vessel is provided with a wind turbine assembly station at an end of the upend deck and adjacent the lifting device, preferably the upend crane, for assembling a wind turbine, i.e. for mounting a nacelle on a mast and for providing the nacelle with blades,

In an embodiment, the lifting device comprises a blade installer device, which blade installer device can be mounted to the trolley, for supporting wind turbine blade and for positioning the blade relative to a nacelle mounted on a mast supported in a wind turbine assembly station adjacent the lifting device, preferably the upend crane.

In a further embodiment, the blade installer device comprises:
a base configured to be mounted to the trolley, or to be integrated with a dedicated trolley;
a connector, wherein the connector is configured for engaging a wind turbine blade, or for engaging a blade support that is removably mounted on the blade;
a pivot arm, which is at a base end is connected to the base for, in use, pivoting about a vertical axis. and is at an opposite end connected to the connector for, in used pivoting about a vertical axis.

In an embodiment, the trolley is configured for supporting an assembled wind turbine, and the lifting device is configured as an upend crane that is provided with a second trolley, for engaging the mast of the assembled wind turbine at a lower end thereof, to stabilise the wind turbine when supported by the upend crane.

In an embodiment, the gripper is foundation gripper, configured to engage a floating foundation, to position the floating foundation in the horizontal plane relative to the vessel and/or to stabilise the floating foundation relative to the vessel.

In an embodiment, the gripper is a monopile gripper, configured for guiding a monopile that is being lowered adjacent the vessel using the lifting device or the upend crane.

In an embodiment, the vessel comprises a foundation gripper and a monopile gripper, preferably the pile gripper is integrated in the foundation gripper.

In an embodiment, the lifting device is configured as a crane, and the crane further comprises a crane tower for supporting a wind turbine component, e.g. a monopile, on a side of the crane opposite the boom. For example, the crane tower can be used for supporting a monopile in the gripper and for lowering the monopile in a vertical position into the water adjacent the vessel, while upending a mast using the boom of the upend crane.

The crane tower extends between a base end and a top end, and is mounted in a fixed and upright position on the crane housing for rotation with the boom of the crane about the vertical slew axis, wherein the crane tower is provided with a
an support trolley, configured to support a wind turbine component at the top end thereof;
a trolley guide, e.g. a track comprising one or more guide rails, for guiding the trolley along the crane tower;
a hoisting winch and an associated hoisting wire, wherein the hoisting wire is guided via the top of the crane tower for hoisting the trolley along the trolley guide, e.g. for lowering a monopile towards the seafloor.

In an embodiment, the lifting device is configured as a crane, and the crane housing and/or the boom of the crane is/are provided with wind turbine component securing arms or tuggers for engaging a lower section of a wind turbine component supported by the crane in a vertical position, in particular for preventing sway of the wind turbine component during slewing of the crane while supporting the wind turbine component in the vertical position. Thus the crane can also be used for moving the wind turbine component from one location to another location, for example from an onboard location to an overboard location for installation of the wind turbine component at the installation site, for example for mounting the mast of an assembled wind turbine onto a foundation.

In an embodiment, the upend hoisting wire is, or wires are, passed between the upper sheave assembly and the lower sheave assembly, and wherein the hoisting wire or wires are connected to hoist winches of the crane, the winches having a capacity sufficient to lift the wind turbine component.

In an embodiment, the lifting device is configured as a crane, and the boom comprises a jib, and wherein the upper sheave assembly is provided in the jib such that the hoisting wire, when the load coupling device is received in the trolley, is positioned away from the boom. in such an embodiment, the hoisting wire, or more in particular the section of the hoisting wire that is luffed between the upper sheave assembly and the lower sheave assembly, is aligned with the wind turbine component supported by the crane in the vertical position. This configuration makes that the trolley is not subjected moment forces caused by the weight of the wind turbine component.

In a further embodiment, the boom at the base end comprises a gantry, and at the top end comprises a gantry jib, and is provided with one or more gantry wires extending between the gantry and the gantry jib, and wherein the luffing wire extending between the luffing winch and the boom extends between the luffing winch and the gantry of the boom.

The invention furthermore provides a method for upending a wind turbine component, preferably using a installation vessel according to the invention, the method comprising the steps:
lifting a monopile in a horizontal position onto the upend deck, using the crane with the boom in the lowered hoisting position for lifting one end of the monopile and a hoisting crane lifting an opposite end of the monopile;
moving the boom from the lowered hoisting position into the raised upending position;
engaging the monopile with the monopile engagement device;
upending the monopile using the crane with the boom in the lowered upend position for lifting one end of the monopile by moving the trolley along the boom from the lowered coupling position to the raised support position.

A further method according to the invention comprises the steps:
after upending, moving the pile from an upend location above the upend deck to an installation location, in which installation location the monopile is aligned with the monopile gripper, by slewing the crane about the vertical slew axis, over a slew angle of at least 180 degrees, preferably over a slew bearing of more than 180 degrees, e.g. over an slew angle of 190 degrees, moving the monopile from the upend deck over the side of the vessel, and subsequently towards a monopile gripper mounted to the rear end of the hull of the vessel.

The invention furthermore provides a crane, the crane to be supported by the hull of a vessel adjacent an upend deck for upending and installation of wind turbine components for supporting a wind turbine, wherein the crane comprises:
a crane base to be supported by the hull of the vessel;
a crane housing;
a slew bearing, provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered hoisting position and a raised upend position for upending wind turbine components;
a luffing winch and an associated luffing wire, wherein the luffing winch is mounted on the crane housing and the luffing wire extends between the luffing winch and the boom, to enable pivoting the boom between the lowered and a raised position;
a trolley, provided with a wind turbine component engagement device that is configured to pivotably support a wind turbine component at the top end thereof;
a trolley guide, e.g. a track comprising one or more guide rails, for guiding the trolley along the boom, wherein the trolley guide comprises a boom section that is mounted to the boom of the crane, and a base section that is mounted to the base of the crane, and wherein the trolley can be received on the base section of the trolley guide, to allow for operation of the boom without the trolley;
a hoisting winch and an associated hoisting wire, wherein the hoisting wire is guided via the boom and supports a load coupling device configured to be connected to a load and preferably to be connected to the trolley for hoisting the trolley along the trolley guide between a lowered coupling position, for coupling the load coupling device with the top end of the pile located in a horizontal position on the upend deck, and a raised support position, for supporting the wind turbine component in a vertical position.

The invention furthermore provides a crane, the crane to be supported by the hull of a vessel adjacent an upend deck for upending and installation of wind turbine components for supporting a wind turbine, wherein the crane comprises:
a crane base to be supported by the hull of the vessel;
a crane housing;
a slew bearing, provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered hoisting position for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom, to enable pivoting the boom between the lowered and the raised position;
a trolley, provided with a wind turbine component engagement device that is configured to pivotably support a wind turbine component at the top end thereof or configured to receive the wind turbine component engagement device and/or the load coupling de vice supporting the wind turbine component engagement device;
a trolley guide, e.g. a track comprising one or more guide rails, for guiding the trolley along the boom;
a hoisting winch and an associated hoisting wire, wherein the hoisting wire is guided via the top end of the wire and supports the load coupling device configured to be connected to a load and preferably to the trolley for hoisting the trolley along the trolley guide between a lowered coupling position, for coupling the trolley with the top end of the pile located in a horizontal position on the upend deck, and a raised support position, for supporting the wind turbine component in a vertical position;
preferably an active horizontal motion device that is mounted between the trolley on one side and the load coupling device and/or wind turbine component engagement device on the other side, the active horizontal motion device being adapted to actively compensate for sea-state induced horizontal displacement of the wind turbine component engagement device in two non-parallel horizontal directions, e.g. in orthogonal horizontal directions, while the wind turbine component is supported in an upright position by the wind turbine component engagement device.

In a further embodiment, the active horizontal motion device is connected to a horizontal motion device linked to the wind turbine component gripper, for moving the load coupling device and/or the wind turbine component engagement device in dependence of movement of the wind turbine component gripper.

The invention furthermore provides an installation vessel, for installation and preferably transport of monopiles and wind turbines, the vessel comprising:
a hull, the hull forming an upend deck,
a crane, supported by the hull of the vessel adjacent the upend deck, wherein the crane comprises:
a crane base,
a crane housing and a slew bearing provided between the crane base and the crane housing, wherein the slew bearing enables the crane housing to slew about a vertical slew axis;
a boom, wherein the boom extends between a base end and a top end, wherein the boom is at the base end pivotable supported by the crane housing for lifting a load at a distance from the crane base and a raised upend position for upending wind turbine components adjacent the crane base;
a luffing winch and an associated luffing wire, wherein the luffing winch is mounted on the crane housing and the luffing wire extends between the luffing winch and the boom, to enable pivoting the boom between the lowered and the raised upend position; and
a hoist, wherein the hoist comprises a hoisting winch and an associated hoisting wire, wherein the hoisting wire is guided via an upper sheave assembly in the boom to a lower sheave assembly of the load coupling device for coupling with a load, e.g. a top end of a wind turbine component, to enable the crane to lift the load using the hoisting winch;
a trolley guide, e.g. a track comprising one or more guide rails, mounted to the boom of the crane; and
a trolley, wherein the trolley is provided with a wind turbine component engagement device that is configured to pivotably support a wind turbine component at the top end thereof, or wherein the trolley is configured to receive a wind turbine component engagement device and/or a load coupling device supporting a wind turbine component engagement device.
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal form the crane to a position adjacent the crane; and
a gripper, the gripper extending outside a contour of the vessel, e.g. for guiding a monopile being lowered in a vertical position into the water adjacent the vessel or for engaging, and preferably stabilising, a floating foundation for mounting a mast, wherein the trolley is coupled with the trolley guide for being guided along the boom of the crane, for guiding the top end of the wind turbine component along the trolley guide while upending the monopile while the bottom end of the wind turbine component is guided by the cart and the upend track.

The invention furthermore provides an installation vessel, for installation and preferably transport of wind turbine components, e.g. monopiles or masts, the installation vessel comprising:
a hull, the hull forming an upend deck,
a crane, supported by the hull of the vessel adjacent the upend deck, wherein the crane comprises:
a crane base, a crane housing and a slew bearing provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered position and a raised position for lifting a load and for moving that load towards or away from the crane base;
a luffing winch and an associated luffing wire, wherein the luffing winch is mounted on the crane housing and the luffing wire extends between the luffing winch and the boom, to enable pivoting the boom between the lowered and the raised position; and
a hoist, the hoist comprising a hoisting winch and an associated hoisting wire, wherein the hoisting wire is guided via an upper sheave assembly in the boom to a lower sheave assembly of the load coupling device for coupling with a load, e.g. the top end of a wind turbine component, to enable the crane to lift the load using the hoisting winch;
a cart track, extending along the upend deck;
a support cart for supporting a bottom end of the wind turbine component, wherein the support cart is supported by the cart track to enable the cart to move along the cart track for guiding the bottom end of the wind turbine component along the upend deck from a position distal form the crane to a position adjacent the crane;
a gripper, the gripper extending outside a contour of the vessel, e.g. for guiding a monopile being lowered in a vertical position into the water adjacent the vessel or for engaging a foundation for mounting a mast;
a trolley guide, e.g. a track comprising one or more guide rails, mounted to the boom of the crane; and
a trolley, coupled with the trolley guide for being guided along the boom of the crane, wherein the trolley is configured to engage the load coupling device for guiding the load coupling device, and thus for guiding the top end of the wind turbine component supported by the load coupling device, along the trolley guide while upending the wind turbine component using the hoist, wherein the boom of the crane can be pivoted in an upend position for upending the wind turbine component with the bottom end of the wind turbine component being guided by the cart and the upend track and with the top end of the wind turbine component being guided by the trolley and the trolley guide, and herein the vessel further comprises boom securing device, the boom securing device comprising a stop for positioning the boom in the upend position, and a boom locking device, for securing the boom in the upend position and/or a boom mobiliser, for moving the boom out of the upend position and away from the boom securing device, e.g. a hydraulic cylinder for pushing the boom away from the upend position, or a winch with association wire for pulling the boom away from the upend position.

The invention furthermore provides an installation vessel, for installation and preferably transport of monopiles for supporting a wind turbine, the installation vessel comprising:
a hull, the hull forming an upend deck,
a crane, supported by the hull of the vessel adjacent the upend deck, wherein the crane comprises:
a crane base, a crane housing and a slew bearing provided between the crane housing and the crane base, the slew bearing enabling the crane housing to slew about a vertical slew axis;
a boom, extending between a base end and a top end, wherein the boom is at the base end pivotable supported by the crane housing for pivoting about a horizontal boom pivot axis between a lowered position and a raised position for lifting a load and for moving that load towards or away from the crane base;
a luffing winch and an associated luffing wire, wherein the luffing winch is mounted on the crane housing and the luffing wire extends between the luffing winch and the boom, to enable pivoting the boom between the lowered and the raised position; and
a hoist, the hoist comprising a hoisting winch and an associated hoisting wire, wherein the hoisting wire is guided via a top block to a load coupling device for coupling with a load, e.g. the top end of a monopile, to enable the crane to lift the load using the hoisting winch;
a cart track, extending along the upend deck;
a support cart for supporting a bottom end of the monopile, wherein the support cart is supported by the cart track to enable the cart to move along the cart track for guiding the bottom end of the monopile along the upend deck from a position distal form the crane to a position adjacent the crane;
a monopile gripper, the monopile gripper extending outside a contour of the vessel, for guiding a monopile being lowered in a vertical position into the water adjacent the vessel;
a trolley guide, e.g. a track comprising one or more guide rails, mounted to the boom of the crane; and
a trolley, coupled with the trolley guide for being guided along the boom of the crane, wherein the trolley is configured to engage the load coupling device for guiding the load coupling device, and thus for guiding the top end of the monopile supported by the load coupling device, along the trolley guide while upending the monopile using the hoist, wherein the boom of the crane can be pivoted in an upend position for upending the monopile with the bottom end of the monopile being guided by the cart and the upend track and with the top end of the monopile being guided by the trolley and the trolley guide.

Herein, adjacent the crane is considered within reach of the crane when the boom of the crane is in the raised upend position.

According to a further aspect, the invention provides a vessel that enables transporting a pre-assembled wind turbine, or parts thereof, and is configured for assembling the wind turbine at or near the installation site. In particular, the vessel is configured for upending the mast of the wind turbine, and preferably for mounting and testing of the nacelle, hub and blades, on the mast.

The hoisting device or upend crane according to the first aspect of the invention allows for upending a mast of a wind turbine offshore. In particular, due to the upend boom of the upend crane, the mast can be upended in a controlled manner. Furthermore, in an embodiment the hoisting device or upend crane can also be used for assembling the wind turbine.

The invention therefore enables assembling wind turbines offshore, and thus obviates the need for costly wind turbine installation plants located adjacent sea harbors. Furthermore, it is not necessary to transport assembled wind turbines over sea, which is time consuming and can only be done in limited weather windows.

In this approach the wind turbine foundation, based on the sea floor or of the floating type, may be pre-installed and the upend crane may be used to install the assembled wind turbine, i.e. mast with nacelle, hub and blades, on the foundation.

According to a second aspect, the invention furthermore provides a vessel, for offshore installation of a pile for supporting a wind turbine, according to claim 30.

The vessel according to the second aspect comprises a hull, a lifting device, and a pile gripper,
wherein the vessel comprises an upend deck extending in a longitudinal X-direction of the vessel, along which, for the purpose of upending by operation of the lifting device for lifting the top end of the pile, a bottom end of the pile is movable along a trajectory extending in the longitudinal direction (X) of the vessel from a position longitudinally distal from the lifting device, e.g. at the bow of the vessel, to adjacent the base of the lifting device, e.g. at the stern of the vessel, in which the pile is upended to its upright orientation alongside the lifting device in a retaining position,
wherein the pile gripper comprises
   a gripper base via which the pile gripper is supported by the hull, and
   a gripper device which is configured to engage the upright oriented pile at a lower end thereof, so as to restrict movement thereof relative to the gripper base in the X-Y plane, i.e. perpendicular to the longitudinal axis of the pile,
wherein the pile gripper has a receiving mode in which an opening in the gripper device is directed to the upend deck so that the pile is enabled to pass through the opening with its bottom end when being upended to its upright orientation in the inboard retaining position thereof,
and wherein the pile gripper has a guiding mode in which the bottom end of the pile, passed through the opening and upright orientated in the inboard retaining position, is enabled to extend through the gripper device and to be circumferentially engaged at its exterior by the pile gripper.

The gripper is configured to be mounted on the deck of a vessel such that the opening of the gripper, for receiving the bottom end of the pile faces the upend deck. In the prior art, the opening of a pile gripper typically faces away from a vessel.

According to the second aspect, the gripper is configured to receive the bottom end of the pile at the end of the upend process. More in particular, the gripper is configured to position the opening of the gripper device towards the upend deck to receive the bottom end of the pile at the end of the upend process.

The gripper can receive and engage the bottom end of the pile while that bottom end is still connected to a cart that guided the bottom end during the upending process along the upend deck. Thus, the pile can be engaged by the gripper prior to be released from the cart, and the position of the bottom end of the pile is continuously controlled. Therefore, there is no moment in the process of handing over the pile, from cart to gripper, at which the pile is uncontrolled and can be subjected to sway, for example due to movement of the vessel and the lifting device mounted on that vessel and supporting the pile.

In an embodiment, the gripper is provided with a gripper ring, for engaging the bottom end of the pile and guiding the pile in the vertical direction, which gripper ring is provided with one or more jaws for, in an opened condition, providing the ring with the opening for receiving the pile, and for, in a closed position, closing the opening such that the gripper ring encloses the bottom end of the pile. In a further embodiment, the ring is movably supported by the gripper base, such that the ring can pivot about a vertical axis, and the opening can be changed in a position facing towards the upend deck, for receiving the bottom end of the pile after being upended, and a position facing away from the upend deck, more preferably facing away form the vessel, to enable the top end of the pile, once driven into the sea floor, to be removed from the gripper. In such an embodiment, the gripper is configured for changing the position of the opening of the gripper ring.

The invention furthermore provide a vessel comprising an upend deck and a pile gripper according the second aspect, wherein the pile gripper is mounted on the hull of the vessel, and the opening of the pile gripper can be positioned towards the upend deck for receiving the bottom end of a pile at the end of an upending process.

According to a third aspect, the invention provides a vessel for offshore installation of a pile for supporting a wind turbine according to claim 1.

The vessel according to the third aspect of the invention comprises a hull, a lifting device, and a pile gripper, and has an X-Y plane, wherein the lifting device comprises
a base via which the lifting device is supported by the hull,
an elongate, upright superstructure,
a lifting assembly connected or connectable to a pile engagement device configured to engage a top end of a pile, optionally connected or connectable via a coupler for coupling to such a pile engagement device, and configured to support the pile engagement device, e.g. via the coupler therefor, when present, and to move the pile engagement device in a direction along the upright superstructure, between a lower position in which the pile engagement device is in a Z-direction of the vessel at or near the base of the lifting device and an upper position wherein the pile engagement device is in the Z-direction remote from the base wherein the pile extends in an upright orientation alongside the upright superstructure, for inboard upending of the pile and outboard lowering of the pile.

The pile engagement device and the coupler, if present, are configured, and arranged on the superstructure, such as to restrict movement of the engaged top end relative to the superstructure in a plane perpendicular to a longitudinal axis of the engaged pile.

The pile gripper comprises:
a gripper base via which the pile gripper is supported by the hull, and
a gripper device which is configured to engage the upright oriented pile at a lower end thereof, so as to restrict movement thereof relative to the gripper base in the X-Y plane, i.e. perpendicular to the longitudinal axis of the pile, and to guide a vertical movement of the pile through the gripper device, i.e. in the direction of the longitudinal axis of the pile.

The pile engagement device and the gripper device are, by respective movabilities thereof in the X-Y plane of the vessel, relative to the vessel, whilst both engaging the pile, and whilst supporting the pile, simultaneously movable relative to the hull from an inboard retaining position in which the pile engagement device is in the upper position and the pile is above the hull, to an outboard installation position of the pile in which the pile is outside the contour of the vessel.

The lifting device further comprises one or more displacement actuator assemblies operative between the vessel and the pile engagement device, for example between the base and the superstructure. The base of the pile gripper further comprises one or more displacement actuator assemblies operative between the gripper base and the gripper device for actuating the movement of the pile engagement device and the gripper device from the inboard retaining position to the outboard installation position.

With a vessel according to the third aspect of the invention is provided a vessel which is particularly efficient in the outboard placement of a pile which has been upended onboard the vessel by a lifting device lifting its top end while the bottom end moves towards this lifting device along an upend deck of the vessel.

The efficiency emanates from at least two effects of the simultaneous movability of the pile engagement device and the gripper device from the retaining position to the installation position.

Firstly, a transfer of the pile into a pile gripper of which the gripper device is, as is known in the art, already in the outboard installation position for receiving the pile in this position, is omitted, since the pile, in particular the bottom end thereof, is enabled to already extend inside the pile gripper in an inboard installation position, the inboard retaining position, directly after upending. After all, the upending ends in the inboard installation position. Such a known transfer is time consuming and requires advanced positioning control—as it would require careful positioning of the pile into the gripper device. In addition, such positioning takes place outboard the vessel, under the influence of the sea motions and the wind, which may further complicate the positioning and the control thereof. The positioning would have to be effectuated by the lifting device, which poses additional requirements thereto, certainly given the enormous size and weight of the pile which has to be handled thereby. Furthermore, additional requirements may be posed to the gripper device, as it must be suitable to receive the pile from the lifting device. Omission of this positioning therefore may provide significant advantages.

Secondly, the need for engagement of the pile by the lifting device, in particular the bottom end of the pile, after upending, in order to restrict movement thereof in the X-Y plane, which would be necessary in addition to the engagement of the top end by the pile engaging device, for safe displacement of the upright pile to the outboard gripper device, is eliminated. The bottom end of the pile is according to the present invention guided by the pile gripper during the displacement, and restricted in the X-Y plane.

The invention is based on the insight that the provision according to the invention of the movability of the gripper device synchronous with that of the crane, and the additional control that is necessary for actuating this movement, actually lead to a more efficient installation. The, to the skilled person at first sight cumbersome, investments in this additional control and movability, are, certainly when performing multiple installations of piles with the same vessel, actually expected to be at least outweighed by the advantages thereof in terms of installation efficiency, at least when configured and arranged according to claim 1.

In an embodiment of the installation vessel, the lifting device comprises a slew bearing between the base and the upright superstructure of the lifting device, wherein the slew bearing enables the superstructure to slew relative to the base about a slew axis extending in the Z-direction of the vessel. Considered in the X-Y plane of the vessel, the movement of the pile from the inboard retaining position to the outboard installation position therein involves a rotation of both the pile engagement device and the gripper device, and thus of the pile when engaged thereby, around the slew axis of the lifting device.

In an embodiment of the installation vessel, the gripper base comprises one or more gripper guides, e.g. gripper rails, mounted to a deck of the hull and defining a track for the gripper device, the gripper device comprising one or more shoes, e.g. rollers, for engaging the track, wherein the movement of the gripper device from the inboard retaining position to the outboard installation position of the pile involves moving the gripper device along the track.

In an embodiment of the installation vessel, the movement of the gripper device from the inboard retaining position to the outboard installation position of the pile has a movement trajectory which is for the pile engagement device defined by the slew bearing of the lifting device, and for the gripper device by the track therefor, which track is a curved track, e.g. wherein the movement trajectory is in the shape of a circle segment.

In an embodiment of the installation vessel, considered in the X-Y plane of the vessel, the base of the lifting device and the gripper base are spaced from one another, and the movement of the pile from the inboard retaining position to the outboard installation position has a movement trajectory which passes in between the base of the lifting device and the gripper base.

In an embodiment of the installation vessel, the movement of the pile from the inboard retaining position to the outboard installation position involves a relative movement of the pile engagement device with respect to the base of the lifting device which is opposite to the relative movement of the gripper device with respect to the gripper base.

In an embodiment of the installation vessel, the movement of the gripper device from the inboard retaining position to the outboard installation position of the pile has a movement trajectory which is for the pile engagement device defined by the slew bearing of the lifting device, and for the gripper device by the track therefor, which track is a linear track, e.g. wherein the movement trajectory is a track segment parallel to a linear axis of the vessel.

In an embodiment, the lifting device and/or the pile gripper are/is provided with an active horizontal motion device, adapted to move the pile engagement device and/or the gripper device relative to the base of the lifting device and the gripper base respectively, to actively compensate for sea-state induced horizontal displacement of the wind turbine component engagement device in two non-parallel horizontal directions, e.g. in orthogonal horizontal directions, while the wind turbine component is supported in an upright position by the wind turbine component engagement device.

In yet a further embodiment, the active horizontal motion device of the lifting device and/or the pile gripper are/is used when moving a wind turbine component, supported by the pile engagement device at a top end and engaged by the gripping device at a bottom end, from the inboard retaining position to the outboard installation position, to keep the pile engagement device and the gripper device vertically aligned, i.e. to keep the wind turbine component in a vertical upright position while it is moved from the inboard retaining position to the outboard installation position.

In an embodiment, a control system is provided that is linked to an active horizontal motion device of the pile gripper, wherein the control system is configured to move the gripper device relative to a slew axis of the lifting device to keep the gripper device vertically aligned with the pile engagement device while the wind turbine component is moved from the inboard retaining position to the outboard installation position, for example the gripper device is moved along a curved, e.g. a circular segment shaped, trajectory of the pile engagement device from the inboard retaining position to the outboard installation position.

In an embodiment, a control system is provided that is linked to an active horizontal motion device of the lifting device and to an active horizontal motion device of the pile gripper, wherein the control system is configured to move the pile engagement device and/or the gripper device relative to a slew axis of the respective lifting device and the pile gripper to keep them vertically aligned while the wind turbine component is moved from the inboard retaining position to the outboard installation position, for example is moved along a linear trajectory from the inboard retaining position to the outboard installation position.

In an embodiment of the installation vessel, the vessel comprises a recess in the longitudinal direction (X) of the vessel at the stern of the vessel, the recess being flanked laterally by two deck portions, wherein the trajectory of the movement from the inboard retaining position to the outboard installation position runs laterally in between the two deck portions, and wherein the outboard installation position is, considered in the X-Y plane of the vessel, inside the recess.

In an embodiment of the installation vessel, the base of the lifting device is located at one lateral side of the recess, e.g. at least partly on one of the two deck portions, and the gripper base is located at the other lateral side of the recess, e.g. at least partly on the other one of the two deck portions.

In an embodiment of the installation vessel, the vessel comprises an upend deck, along which, for the purpose of upending by operation of the lifting assembly of the lifting device for lifting the top end of the pile, a bottom end of the pile is movable along a trajectory extending in the longitudinal direction (X) of the vessel from a position longitudinally distal from the base of the lifting device, e.g. at the bow of the vessel, to adjacent the base of the lifting device, e.g. at the stern of the vessel, in which the pile is upended to its upright orientation alongside the upright superstructure in the inboard retaining position.

In an embodiment of the installation vessel, the gripper device comprises a ring comprising multiple pile engaging tools distributed about the circumference of the ring, each pile engaging tool being adapted to engage an exterior of the pile extending through the ring in the upright orientation thereof, e.g. each pile engaging tool comprising one or more pile guiding rollers.

In an embodiment of the installation vessel, the ring of the gripper device comprises a ring base and one or more movable jaws, e.g. two jaws, forming respective segments of the ring and being movable between a closed position, in which the ring forms a closed annulus, and an opened position, which enables the pile to pass laterally into and out of the ring through an opening in the annulus between the jaws.

In an embodiment of the installation vessel, the ring of the gripper device is slewable relative to the gripper base around a central slew axis of the ring in the closed position thereof, by means of one or more ring slew actuators, such that the opening between the jaws in the opened position of the ring is movable from an angular position with respect to the central slew axis in which the opening faces the upend deck of the hull of the vessel in the inboard retaining position of the pile, and an angular position with respect to the central slew axis in which the opening faces the water, including in the outboard installation position of the pile.

In an embodiment of the installation vessel, the vessel further comprises a control unit which is operatively connected to the displacement actuator assemblies of the lifting device and to the displacement actuator assemblies of the gripper, and is programmed for simultaneously operating the actuator assemblies of the lifting device and the pile gripper for simultaneously moving the pile engagement device and the gripper device relative to the vessel, and therewith, moving the engaged and supported pile, from the inboard retaining position to the outboard installation position.

In an embodiment of the installation vessel, the lifting device is a crane, the base of the lifting device is a crane base, the upright superstructure is an upright crane superstructure, and the lifting assembly is a hoisting assembly comprising one or more hoisting winches and one or more associated hoisting wires.

In an embodiment of the installation vessel, the upright superstructure of the lifting device is provided with a trolley guide, e.g. a track comprising one or more guide rails, extending along the upright superstructure in the longitudinal direction thereof, and the pile engaging device is arranged on the superstructure via a trolley movable along the guide, e.g. via the coupler, if present, e.g. the lifting assembly being connected or connectable to the pile engagement device and/or the coupler therefor by means of a connection thereof to the trolley.

In an embodiment of the installation vessel, the hoisting assembly comprises an upper sheave assembly at the upright superstructure, and the hoisting assembly is connected or connectable to the pile engagement device and/or the coupler therefor via a load coupling device comprising a lower sheave assembly, e.g. by means of a connection thereof to the trolley, the hoist wire being arranged in multiple falls through the upper and lower sheave assemblies to enable the crane to lift the load using the hoisting winch.

In an embodiment of the installation vessel, the crane superstructure comprises
a crane housing and
a boom, wherein the boom extends between a boom base end and a boom top end, wherein the boom is at the boom base end pivotable supported by the crane housing around a horizontal boom pivot axis, the boom having lowered positions for lifting a load at a horizontal distance from the crane base, and a raised upend position to form the upright superstructure, for upending the pile alongside the crane base,
   the crane further comprising:
a luffing winch and an associated luffing wire, wherein the luffing winch is mounted on the crane housing and the luffing wire extends between the luffing winch and the boom, to enable pivoting of the boom between the lowered and the raised upend position around the horizontal boom pivot axis.

In an embodiment of the installation vessel, the pile gripper comprises an active motion compensating actuation system for moving the gripper device relative to the vessel in an X-Y plane of the vessel, wherein the actuation system comprises an active sea state induced motion compensation mode in which the actuation system is operated to compensate for sea state induced motion of the vessel in the X-Y plane, including maintaining the outboard installation position independent of the sea state induced vessel motion.

In an embodiment of the installation vessel, the active motion compensation actuation system of the gripper comprises one or more first tracks, e.g. rails, and one or more second tracks, e.g. rails, extending non-parallel to one another in the X-Y plane of the vessel, which second tracks are movable over the first tracks, the actuation system further comprising one or more first compensating actuators operative between the first tracks and the second tracks, for moving the second tracks over the first tracks, and one or more second compensating actuators operative between the second tracks and the gripper device, for moving the gripper device over the second tracks.

In an embodiment of the installation vessel, the pile engagement device, and optionally the coupler therefor, if present, is arranged on an active motion compensating actuation system of the trolley of the lifting assembly, wherein the active motion compensating actuation system is configured for moving the pile engagement device e.g. via the coupler therefor, if present, relative to the trolley guide in an X-Y plane of the vessel, wherein the actuation system comprises an active sea state induced motion compensation mode in which the actuation system is operated to compensate for sea state induced motion of the vessel in the X-Y plane, including maintaining the outboard installation position independent of the sea state induced vessel motion.

In an embodiment of the installation vessel, the active motion compensation actuation system of the trolley comprises one or more first tracks, e.g. rails, and one or more second tracks, e.g. rails, extending non-parallel to one another in the X-Y plane of the vessel which second tracks are movable over the first tracks, the actuation system further comprising one or more first compensating actuator assemblies operative between the first tracks and the second tracks, for moving the second tracks over the first tracks, and one or more second compensating actuator assemblies operative between the second tracks and the pile engagement device and/or the coupler therefor, for moving the pile engagement device and/or the coupler over the second tracks.

In an embodiment of the installation vessel, the control unit is operatively connected to, and programmed to simultaneously operate, the active motion compensating actuation systems of the lifting device and the pile gripper, for synchronously and correspondingly moving in the X-Y plane of the vessel the pile engagement device and the gripper device relative to the vessel, so as to compensate for sea state induced motions of the vessel in the X-Y plane, including maintaining the outboard installation position independent of the sea state induced vessel motion.

According to the third aspect, the invention furthermore provides a pile gripper, for use on a vessel according to the third aspect of the invention, according to claim 23.

The pile gripper comprises:
a gripper base, the pile gripper being configured to via the gripper base be secured to the hull of the vessel, and
a gripper device which is configured to engage the pile at a lower end thereof in an upright orientation of the pile, so as to restrict horizontal movement thereof relative to the hull of the vessel, when the gripper base is secured thereto, and to guide a movement of the pile through the gripper device parallel to the upright longitudinal axis of the pile,
wherein the base of the pile gripper provides a movability of the gripper device such that, when secured to the hull, near an edge thereof, the gripper device is movable relative to the vessel from an inboard retaining position of the pile in which the pile is above the hull, to an outboard installation position of the pile in which the pile is outside the contour of the vessel whilst engaging a lower end of a pile in an upright orientation thereof and restricting the horizontal movement thereof, so as to guide the movement of the pile while the pile is at least partly being supported via a pile engagement device of the lifting device performing the same movement simultaneously,
wherein the gripper base further comprises one or more displacement actuator assemblies operative between the vessel and the gripper device, when secured to the hull, near an edge thereof, for moving the gripper device relative to the vessel, for actuating the movement of the gripper device from the inboard retaining position to the outboard installation position,
wherein the movement of the gripper device from the inboard retaining position to the outboard installation position of the pile preferably has a trajectory relative to the vessel in the shape of a circle segment.

The third aspect of the invention furthermore relates to a vessel provided with such pile gripper, wherein the gripper base is secured to the hull of the vessel near an edge thereof.

According to the third aspect, the invention furthermore provides a lifting device, for use on a vessel according to the third aspect of the invention, according to claim 25.

The lifting device according to the third aspect of the invention comprises:
a base via which the lifting device is configured to be secured to the hull for support thereby,
an elongate, upright superstructure,
a lifting assembly connected or connectable to a pile engagement device configured to engage a top end of a pile, optionally connected or connectable via a coupler for coupling to such a pile engagement device, and configured to support the pile engagement device, e.g. via the coupler therefor, when present, and to move the pile engagement device in a direction along the upright superstructure, between a lower position in which the pile engagement device is in a Z-direction of the vessel at or near the base of the lifting device and an upper position wherein the pile engagement device is in the Z-direction remote from the base wherein the pile extends in an upright orientation alongside the upright superstructure, for inboard upending of the pile and outboard lowering of the pile,
wherein the pile engagement device and the coupler, if present, are configured, and arranged on the superstructure, such as to restrict movement of the engaged top end relative to the superstructure in a plane perpendicular to a longitudinal axis of the engaged pile,
wherein the pile engagement device is, when the base is secured to the hull, near an edge thereof, by a movability thereof relative to the vessel, e.g. to the base of the lifting device, whilst engaging the pile and at least partly supporting the engaged pile via its top end, movable relative to the hull from an inboard retaining position in which the pile engagement device is in the upper position and the pile is above the hull, to an outboard installation position of the pile in which the pile is outside the contour of the vessel, so as to move the pile while the movement is being guided by a gripper device of a pile gripper performing the same movement,
wherein the lifting device further comprises one or more displacement actuator assemblies operative between the vessel and the pile engagement device, for example between the base and the superstructure, for actuating the movement of the pile engagement device from the inboard retaining position to the outboard installation position, when the base is secured to the hull.

The third aspect of the invention furthermore relates to a vessel provided with such a lifting device, wherein the gripper base is secured to the hull of the vessel near an edge thereof.

The third aspect of the invention furthermore relates to a vessel provided with such a pile gripper, wherein the gripper base is secured to the hull of the vessel near an edge thereof.

According to the third aspect, the invention furthermore provides a control unit, for use on a vessel according to the third aspect of the invention, according to claim 27.

A control unit according to the third aspect of the invention is configured to be operatively connected to the displacement actuator assemblies of the lifting device and to the displacement actuator assemblies of the pile gripper, and is programmed for simultaneously operating the lifting device actuators and the gripper actuators for simultaneously moving the pile engagement device relative to the vessel, and therewith, moving the engaged and supported pile, from the inboard retaining position to the outboard installation position.

In an embodiment, the control unit is configured to be operatively connected to, and programmed to simultaneously operate, the active motion compensating actuation systems of the lifting device and the pile gripper, for synchronously and correspondingly moving in the X-Y plane of the vessel the pile engagement device and the gripper device relative to the vessel, so as to compensate for sea state induced motions of the vessel in the X-Y plane, including maintaining the outboard installation position independent of the vessel motion.

In an embodiment, the control unit is configured to be operatively connected to the ring slew actuators, and programmed to operate the slew actuators such that the opening faces the upend deck prior to reaching the inboard retaining position of the pile, so that the pile is enabled to pass through the opening with its bottom end when being upended to its upright orientation in the inboard retaining position thereof, and such that the opening faces the water after the pile has reached the inboard retaining position, preferably after operating the displacement actuator assemblies of the lifting device and the pile gripper for moving the pile to the outboard installation position.

In an embodiment, the lifting device is set up at the end of an upend deck, and in line with the upend deck. In such an embodiment, the pile gripper is set up to receive the lower end of a pile after the pile has been upended. In such an embodiment, the upended pile, more in particular the lower end thereof, preferably is introduced into the ring of the pile gripper, more in particular is moved through the opening of the ring, by a slewing the movement of the crane while supporting the pile in an upended, upright position. Once the lower end of the pile is introduced in the pile gripper, and the opening of the ring is closed, the lifting device, more in particular the pile engagement device and the pile gripper, more in particular the gripper device, whilst both engaging the pile, and whilst supporting the pile, simultaneously move relative to the hull from an inboard retaining position in which the pile engagement device is in the upper position and the pile is above the hull, to an outboard installation position of the pile in which the pile is outside the contour of the vessel.

According to a fourth aspect, the invention furthermore provides a pile gripper, for use on a vessel according to the third aspect of the invention.

The pile gripper according to the fourth aspect of the invention comprises:
a gripper base, the pile gripper being configured to via the gripper base be secured to the hull of the vessel, and
a gripper device which is configured to engage the pile at a lower end thereof in an upright orientation of the pile, so as to restrict horizontal movement thereof relative to the hull of the vessel, when the gripper base is secured thereto, and to guide a movement of the pile through the gripper device parallel to the upright longitudinal axis of the pile,
wherein the base of the pile gripper provides a movability of the gripper device such that, when secured to the hull, near an edge thereof, the gripper device is movable relative to the vessel from an inboard retaining position of the pile in which the pile is above the hull, to an outboard installation position of the pile in which the pile is outside the contour of the vessel whilst engaging a lower end of a pile in an upright orientation thereof and restricting the horizontal movement thereof, so as to guide the movement of the pile while the pile is at least partly being supported via a pile engagement device of the lifting device performing the same movement simultaneously,
wherein the gripper base further comprises one or more displacement actuator assemblies operative between the vessel and the gripper device, when secured to the hull, near an edge thereof, for moving the gripper device relative to the vessel, for actuating the movement of the gripper device from the inboard retaining position to the outboard installation position,
wherein the gripper device comprises a ring comprising multiple pile engaging tools distributed about the circumference of the ring, each pile engaging tool being adapted to engage an exterior of the pile extending through the ring in the upright orientation thereof, e.g. each pile engaging tool comprising one or more pile guiding rollers,
wherein the ring of the gripper device comprises a ring base and one or more movable jaws, e.g. two jaws, forming respective segments of the ring and being movable between a closed position, in which the ring forms a closed annulus, and an opened position, which enables the pile to pass laterally into and out of the ring through an opening in the annulus between the jaws,
wherein the ring of the gripper device is slewable relative to the gripper base around a central slew axis of the ring in the closed position thereof, such that the opening between the jaws in the opened position of the ring is movable from an angular position with respect to the central slew axis in which the opening, when the gripper base is secured to the hull, faces an upend deck of the vessel in the inboard retaining position of the pile, and an angular position with respect to the central slew axis in which the opening faces the water, including in the outboard installation position of the pile.

Thus, with a pile gripper according to the fourth aspect of the invention, the gripper is provided with a slewable gripper ring, for engaging the bottom end of the pile and guiding the pile in the vertical direction. By slewing the ring, the position of the opening can be adapted and the ring can receive and release piles, or at least a bottom end thereof, in different directions. This configuration enables the gripper to engage a pile that is still supported above deck, for example a pile supported above the upend deck at the end of the upending process, for with a closed opening guiding the bottom end of the pile while the pile is moved from an inboard to an outboard position, and for releasing the pile with the opening facing away from the vessel.

A pile gripper according to the fourth aspect of the invention is configured to engage a bottom end of a pile in an upright position, for example at the end of an upending process, for guiding the bottom end, for example while being moved from an inboard position to an outboard position, and for releasing a pile in an upright position, for example after the pile has been driven into the seafloor. The pile gripper thus enables full control of the position of the bottom end of the pile from upending to being drive in the sea floor, and thus improves the process for installing foundations piles offshore.

The invention furthermore provides a vessel for offshore installation of a pile for supporting a wind turbine, the vessel comprising a hull, a lifting device, and a pile gripper according to the fourth aspect of the invention, and wherein the pile gripper is secured to the hull of the vessel, near an edge thereof, by mounting of the gripper base to the hull.

According to a fourth aspect, the invention furthermore provides a pile gripper comprising a ring that is slewable relative to a gripper base around a central slew axis of the ring. Such a pile gripper comprises:
a gripper base, the pile gripper being configured to via the gripper base be secured to the hull of the vessel, and
a gripper device which is configured to engage the pile at a lower end thereof in an upright orientation of the pile, so as to restrict horizontal movement thereof relative to the hull of the vessel, when the gripper base is secured thereto, and to guide a movement of the pile through the gripper device parallel to the upright longitudinal axis of the pile,
wherein the gripper device comprises a ring comprising multiple pile engaging tools distributed about the circumference of the ring, each pile engaging tool being adapted to engage an exterior of the pile extending through the ring in the upright orientation thereof, e.g. each pile engaging tool comprising one or more pile guiding rollers,
wherein the ring of the gripper device comprises a ring base and one or more movable jaws, e.g. two jaws, forming respective segments of the ring and being movable between a closed position, in which the ring forms a closed annulus, and an opened position, which enables the pile to pass laterally into and out of the ring through an opening in the annulus between the jaws,
wherein the ring of the gripper device is slewable relative to the gripper base around a central slew axis of the ring in the closed position thereof, such that the opening between the jaws in the opened position of the ring is movable from an angular position with respect to the central slew axis in which the opening, when the gripper base is secured to the hull, faces an upend deck of the vessel in the inboard retaining position of the pile, and an angular position with respect to the central slew axis in which the opening faces the water, including in the outboard installation position of the pile.

Herein the X-Y plane of a vessel has an X-direction, which as is known in the art corresponds to the longitudinal direction of the vessel, and a Y-direction corresponding to the transverse direction of the vessel and perpendicular to the X-direction. The X-Y plane is spanned by the X- and Y-directions. The vessel also has a Z-direction perpendicular to the X-Y plane. Thus, when the vessel floats in equilibrium on perfectly flat water, the X-Y plane is horizontal and the Z-direction is vertical.

Advantageous embodiments of the upend crane and the installation vessel according to the invention and the method according to the invention are disclosed in the sub claims and in the description, in which the invention is further illustrated and elucidated on the basis of a number of exemplary embodiments, of which some are shown in the schematic drawing. In the figures, components corresponding in terms or construction and/or function are provided with the same last two digits of the reference numbers.

It will be appreciated by the skilled person that a technical feature discussed herein as required or as optional with respect to one embodiment or aspect of the invention may be equally applicable to one or more other embodiments or aspects described herein, with the feature performing its designation function. Such combinations are all envisaged herein unless a combination would result in a technical impossible solution and/or not meet the desired functionality.

### BRIEF DESCRIPTION OF THE DRAWINGS

The invention will now be described with reference to the appended figures. In the figures:

FIG. 1 shows, in a perspective view, an embodiment of a pile installation vessel according to the invention, at the start of an upending phase,

FIGS. 2-4 show, in the same perspective view, the same vessel during the upending of a pile,

FIG. 5 shows, in the same perspective view, the same vessel at the end of the upending phase,

FIG. 6 shows in the same perspective view, the same vessel at the start of a displacement phase,

FIG. 7 shows in the same perspective view, the same vessel during displacement of the upended pile,

FIG. 8 shows in the same perspective view, the same vessel at the end of the displacement phase and the start of a securing phase,

FIG. 9 shows in the same perspective view, the same during a securing phase, namely, after lowering of the pile towards the sea bottom,

FIG. 10 shows in the same perspective view, the same vessel during the securing phase, namely while picking up a pile driving device,

FIG. 11 shows in the same perspective view, the same vessel during the securing phase, namely after displacement of the pile driving device,

FIG. 12 shows in the same perspective view, the same vessel at the end of the securing phase, namely after operation of the pile driving device,

FIG. 13 shows in the same perspective view, the same vessel during release of the pile,

FIG. 14 shows, in a side view, the same vessel according to the invention, at the start of the upending phase,

FIG. 15 shows, in the same side view, the same vessel during the upending of a pile,

FIG. 16 shows, in the same side view, the same vessel at the end of the upending phase,

FIG. 17 shows in the same side view, the same vessel at the start of a displacement phase, shows in the same side view, the same vessel after displacement of the upended FIG. 18 pile, and during the securing phase, namely after lowering of the pile,

FIG. 19 shows in the a top view, the same vessel at the start of the upending phase,

FIG. 20 shows, in the same top view, the same vessel during the upending of a pile,

FIG. 21 shows, in the same top view, the same vessel at the end of the upending phase,

FIG. 22 shows in the same top view, the same vessel at the start of a displacement phase,

FIG. 23 shows in the same top view, the same vessel after displacement of the upended pile, and during the securing phase, namely after lowering of the pile,

FIG. 24 shows a schematic top view of an exemplary embodiment of an installation vessel provided with an upend crane or lifting device;

FIG. 25 shows a schematic side view of a crane according to the invention, with a boom in an upend position and a trolley depicted in a first and a second position;

FIG. 26 shows a schematic side view of the crane of FIG. 26 with the boom of the crane in the upend position and in a lowered position, and with a trolley parked on a section of the trolley guide located on a base of the crane;

FIG. 27 shows a schematic top view of another exemplary embodiment of an installation vessel provided with an upend crane and an upend deck that is aligned with the central axis of the vessel;

FIG. 28 shows the vessel of FIG. 27 with the boom of the upend crane depicted in both a raised upend position and a lowered position;

FIG. 29 shows a side view of the vessel of FIG. 27 with the upend crane and a storage crane supporting a wind turbine component;

FIG. 30 shows a side view of the vessel of FIG. 27 with the boom of the upend crane in the upend position and shows a monopile depicted in multiple intermediate positions of the upend process;

FIG. 31 show a rear view of the vessel of FIG. 30, and show the crane supporting the monopile in the gripper at the stern of the vessel;

FIG. 32 show a rear view of the vessel of FIG. 30, and show the crane lowering the monopile towards the seafloor, the monopile being guided by the gripper;

FIG. 33 show a rear view of the vessel of FIG. 30, and show the crane supporting a hammer for driving the monopile into the seafloor;

FIG. 34 shows a mast depicted in multiple intermediate positions of the upend process;

FIG. 35 shows the upend crane mounting a nacelle on the mast, the mast being supported in an upright position;

FIG. 36 shows the upend crane supporting an assembled wind turbine in an overboard position, i.e. outside a contour of the vessel, at an installation location;

FIG. 37 shows a top view of another exemplary embodiment of a vessel configured for transporting wind turbine components, for assembling a wind turbine, and for mounting the assembled wind turbine on a foundation, wherein the vessel is provided with an upend crane and an upend deck that is aligned with the central axis of the vessel;

FIG. 38 shows a schematic side view of the crane of FIG. 37 with the boom of the crane in the upend position, and with a trolley supporting a blade installer device supporting a blade adjacent a nacelle of a wind turbine being assembled;

FIG. 39 shows in close up the blade installer of FIG. 38;

FIG. 40 shows a top view of another exemplary embodiment of a vessel provided with an upend crane, of which only the crane base is depicted, an upend deck that is aligned with the central axis of the vessel, and a gripper for guiding monopiles, the gripper being supported on the deck of the vessel, wherein the gripper is positioned to receive the lower end of a monopile supported by the upend crane;

FIG. 41 shows a top view of the vessel of FIG. 40, wherein the gripper moves with the crane to transfer the maniple from an onboard position to an offboard position; and

FIG. 42 shows a top view of the vessel of FIG. 40, wherein the gripper is positioned to guide the monopile at the installation location.

### DETAILED DESCRIPTION OF EMBODIMENTS

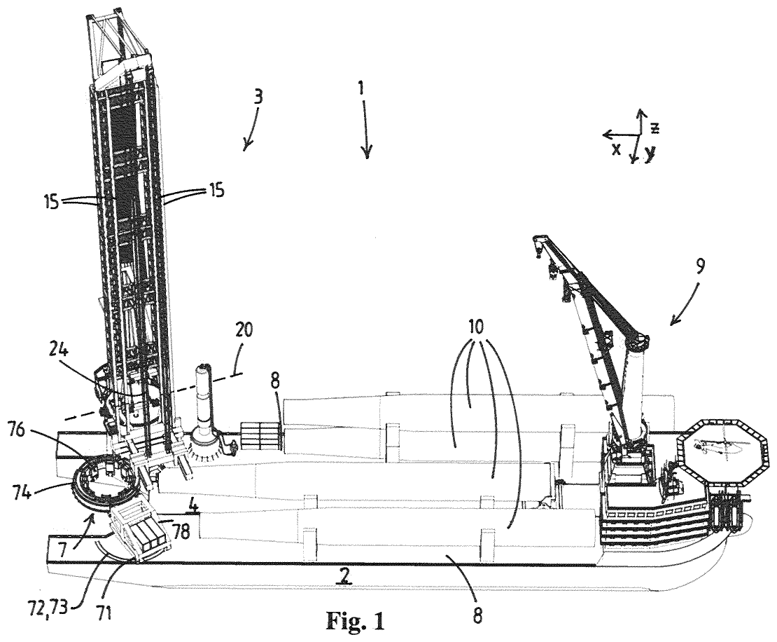

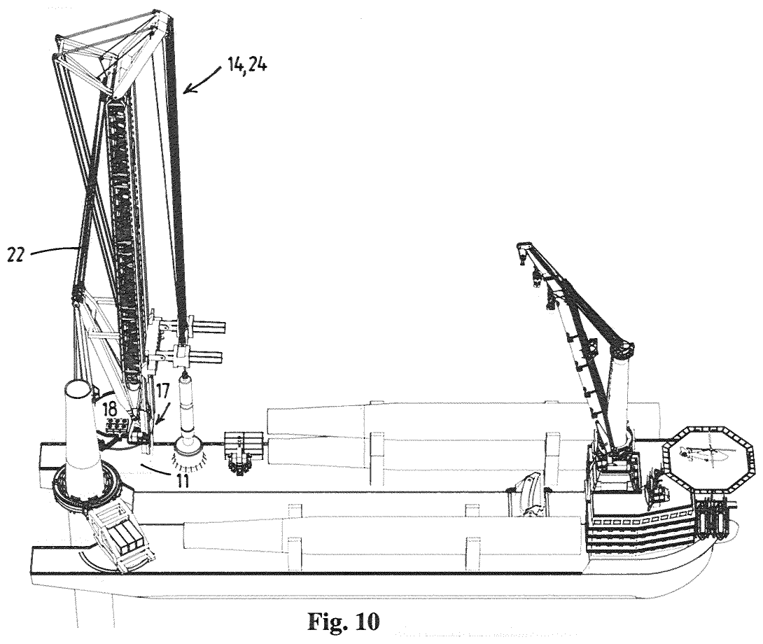

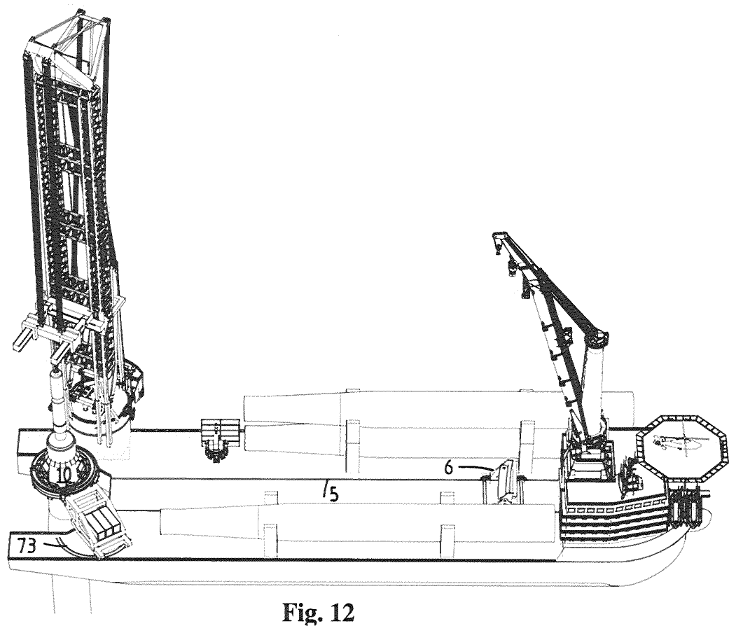

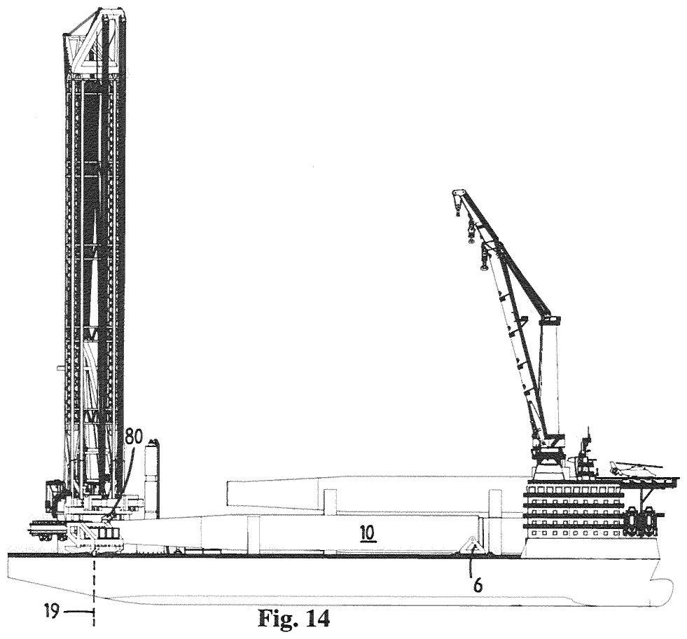

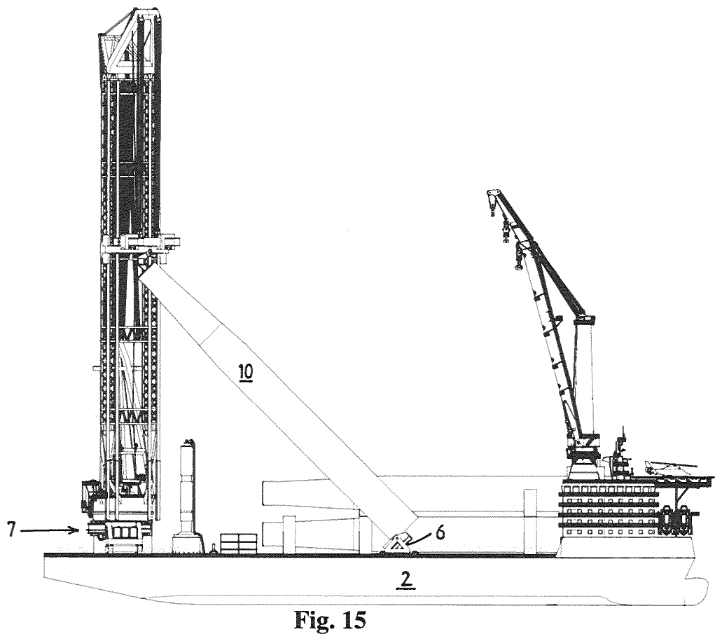

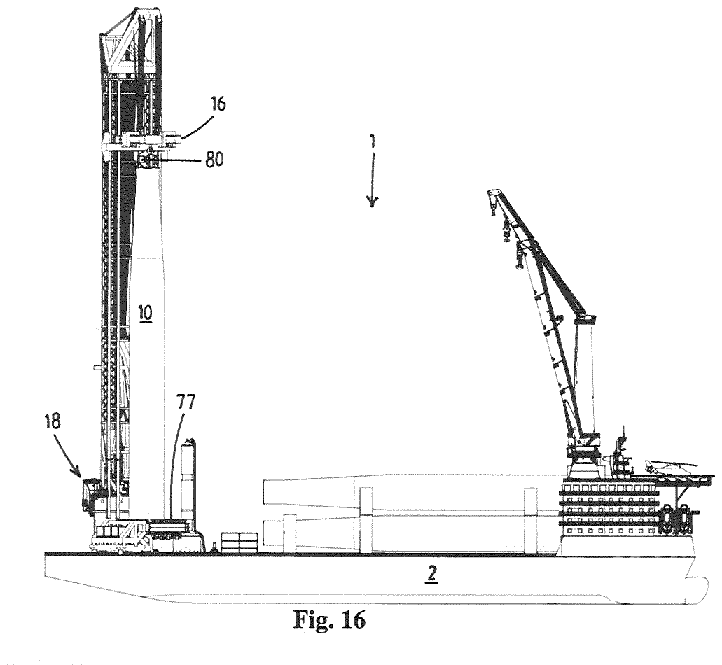

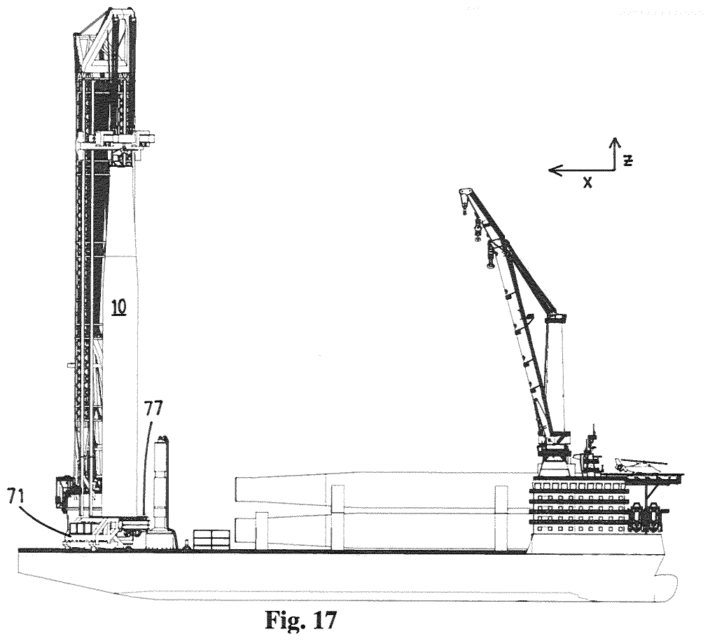

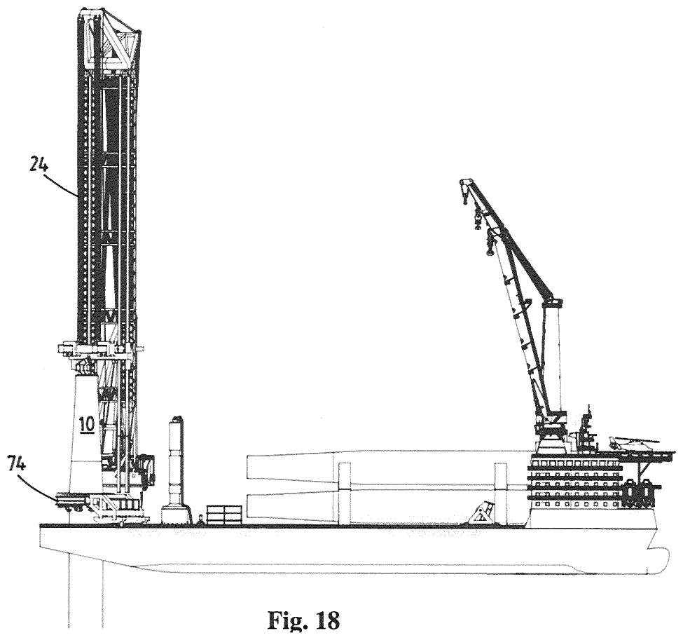

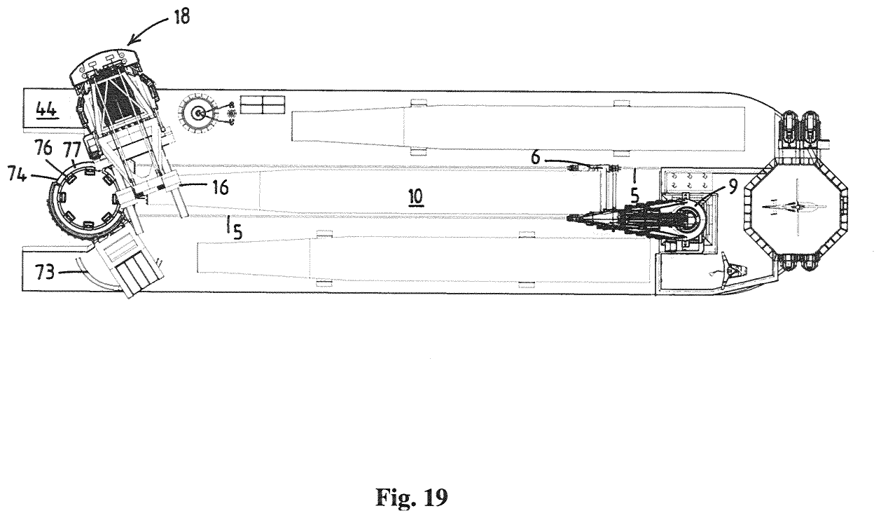

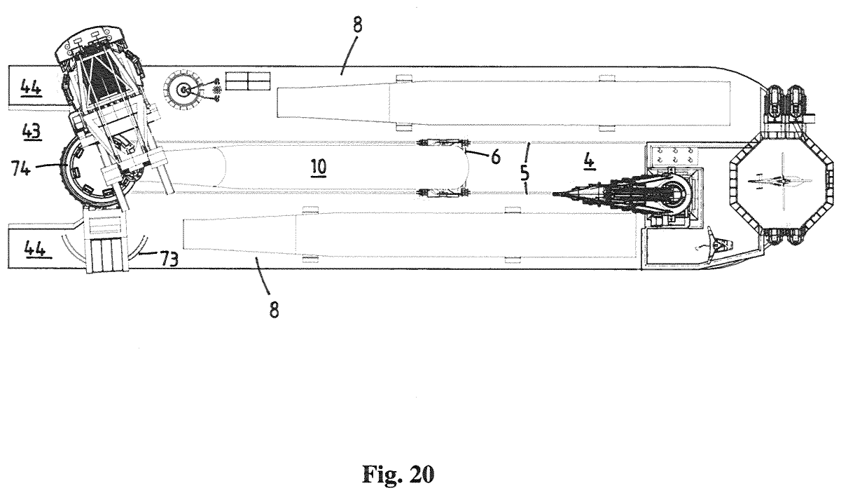

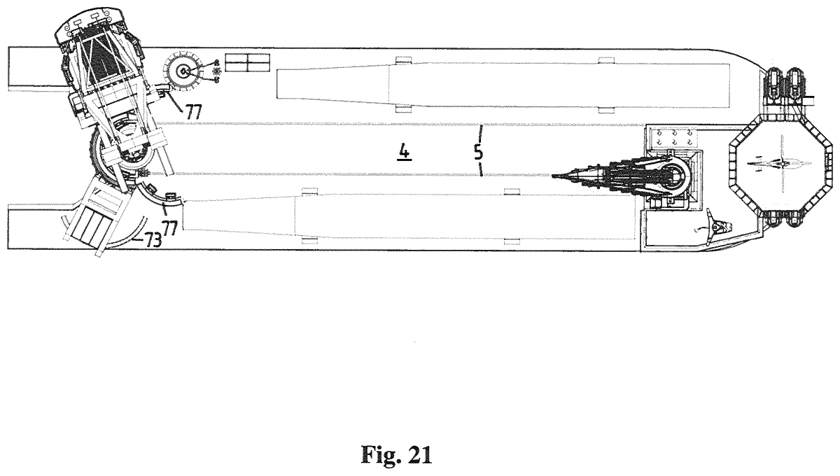

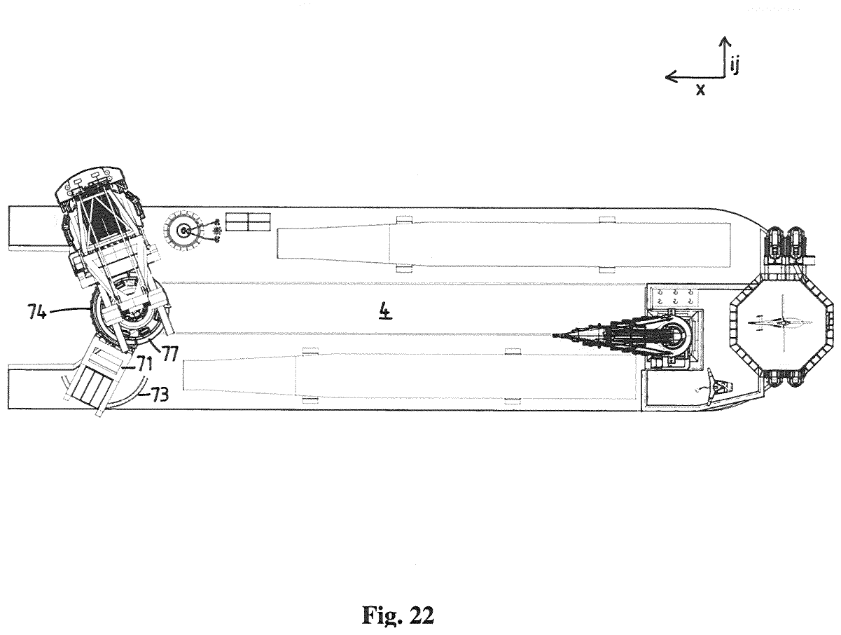

FIGS. 1-23 show a pile installation vessel according to all aspects of the invention.

The figures illustrate different phases of a method for an offshore installation of a monopile 10 for supporting a wind turbine. The vessel 1 is suitable for use in such method. However, the vessel 1 is also suitable for installing other wind turbine components in a similar fashion. Examples are other types of piles, masts of wind turbines, and rotor blades.

The installation involves the onboard storage of the component in horizontal orientation thereof during travel of the vessel 1 towards the offshore installation site for the wind turbine component. Once arrived at the installation site, the actual installation method, which is illustrated in the figures, takes place. This includes the onboard upending of the component to an upright orientation, the displacement of the upended component to the outboard installation location in the X-Y plane, the outboard displacement of the component in the Z-direction to secure it at the installation location, and the release of the component from the vessel 1.

The vessel 1 comprises a hull 2, a lifting device 3, upend deck 4 with a cart track 5 and a support cart 6, and a pile gripper 7. In the embodiment shown there are two storage decks 8 provided, on both lateral sides of the upend deck 4, for storage of multiple monopiles to be installed, during transfer of the vessel 1 to the installation site. The upend deck 4 extends in the X-direction in the lateral center of the vessel 1. In the embodiment shown, the vessel 1 is furthermore provided with an optional storage crane 9. The vessel 1 has an X-direction, which as is known in the art corresponds to the longitudinal direction of the vessel 1, and a Y-direction corresponding to the transverse direction of the vessel 1 and perpendicular to the X-direction. The vessel 1 has an X-Y plane spanned by the X- and Y-directions. It also has a Z-direction perpendicular thereto. When the vessel 1 floats in equilibrium on perfectly flat water, the X-Y plane is horizontal and the Z-direction is vertical.

In the embodiment shown, the vessel 1 has a non-jack-up type floating hull 2, and is configured to maintain a position and orientation relative to an installation site for the pile 10. Thus, the vessel 1 can be positioned adjacent the monopile installation site and install the monopile using the monopile gripper 7 without the vessel 1 having to be anchored by means of the time consuming deployment of jack-up legs.

The hull 2 forms the upend deck 4 and storage decks 8, which are all part of a single vessel deck. On the storage decks 8 three monopiles 10 are stored: two stacked on top of each other at the port side, and one at the starboard side of the vessel 1. In a further embodiment according to the invention, the storage decks may be provided with storage racks for the monopiles, allowing to stack multiple monopiles on top of each other.

Furthermore, a monopile 10 is depicted on the upend deck 4 between the storage decks 8. The crane 1 and the storage crane 9 are configured to each engage and end of a monopile, and thus lift the monopile from the storage deck 8 onto the upend deck 4 and vice versa. The crane 3 and the storage crane 9 are also configured for lifting a monopile 10 from a position adjacent the vessel 1, e.g. on a supply vessel such as a barge or on a quay, prior to moving the monopile to a storage position on the storage decks 8.

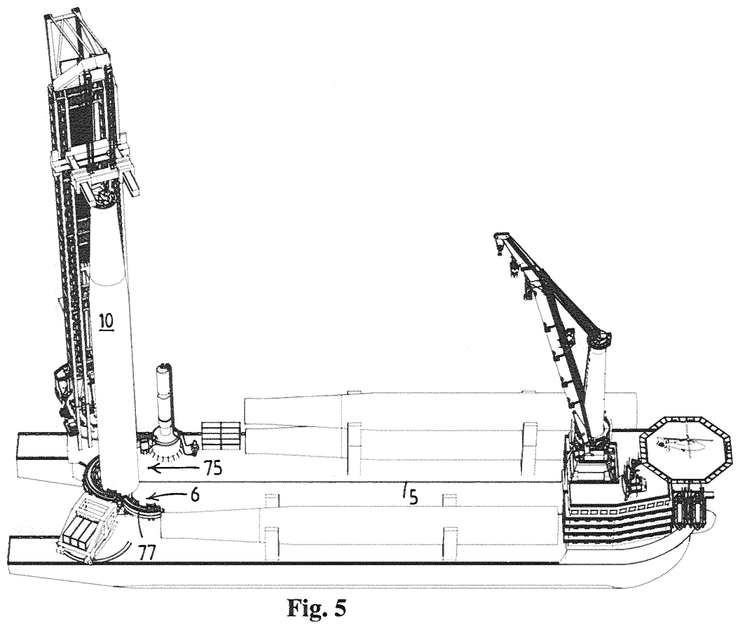

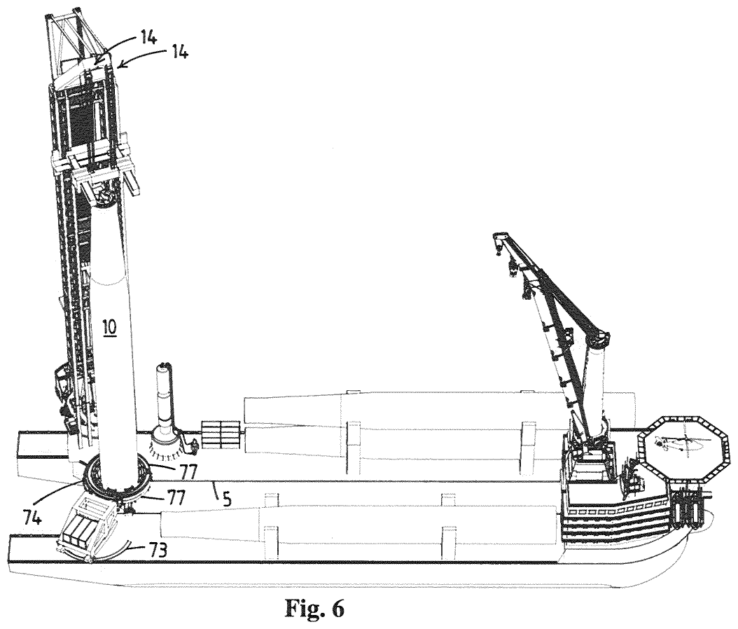

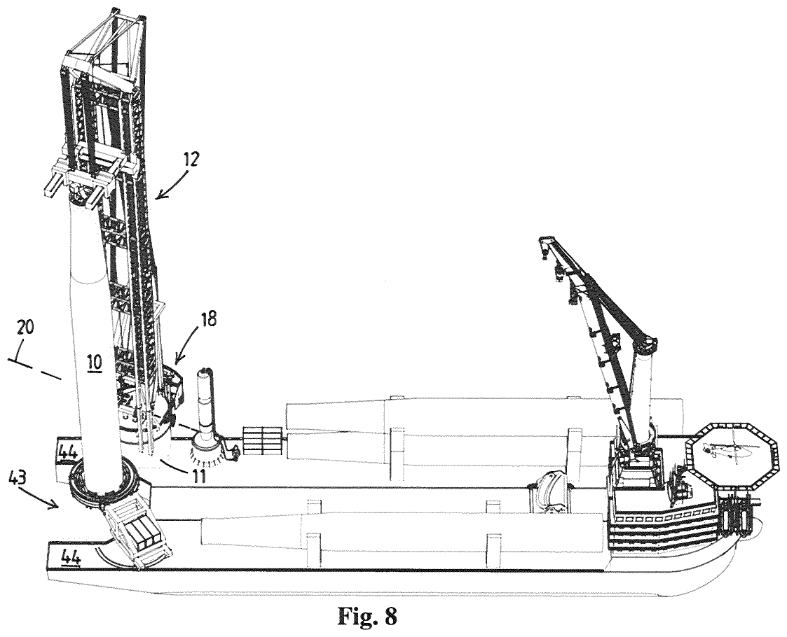

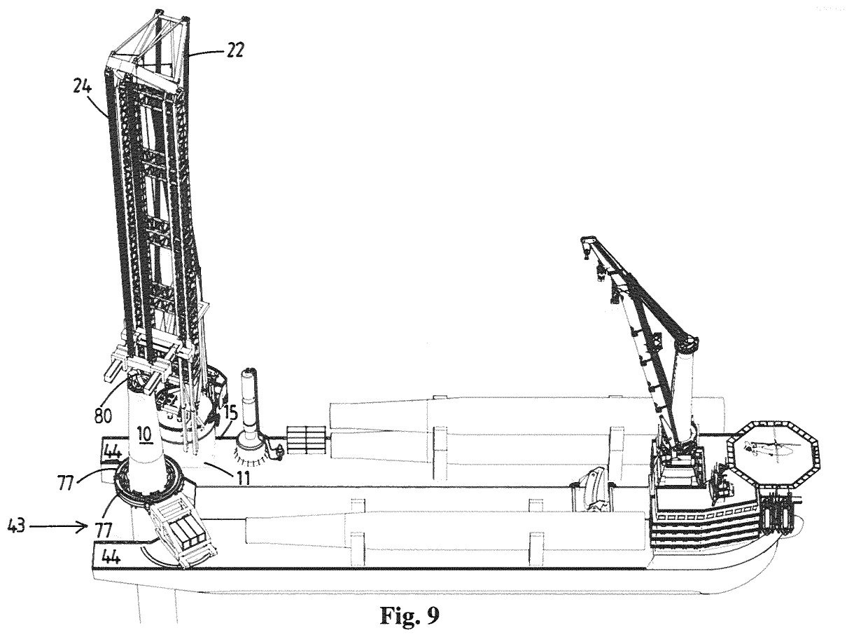

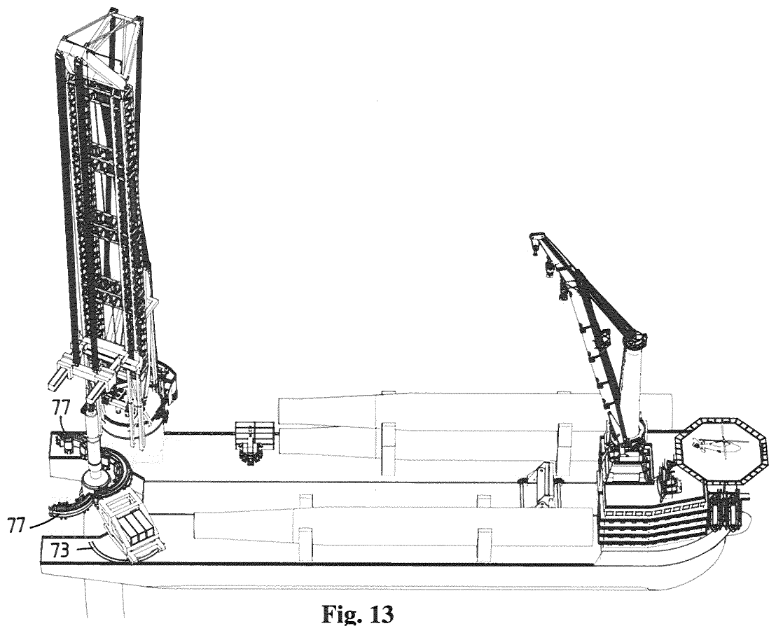

FIGS. 1-13 depict the installation in a perspective view. In particular, FIGS. 1-5 depict the upending of the pile 10 on the upend deck 4 from an initial position in a horizontal orientation, i.e. in the X-Y plane, thereof in FIG. 1 to an onboard retaining position adjacent the lifting device 3 in which it has an upright orientation, i.e. in the Z-direction, in FIG. 5. FIGS. 6-8 depict the displacement of the pile 10 from the onboard retaining position of the pile 10 to the outboard installation position of the pile 10 in FIG. 8. FIGS. 9-12 illustrate securing the pile 10 at the installation location, namely by lowering it towards the sea bottom, FIG. 9, and subsequently pile driving for fixing it in the seabed. FIG. 13 depicts releasing the pile 10 from the vessel 1.

For the upending phase, the lifting device 3, the upend deck 4 with the cart track 5 and the support cart 6 are used. The properties thereof enabling the upending—thus relating to the first aspect of the invention, are discussed first.

For the purpose of upending, the lifting assembly of the lifting device is operated. The operation of the lifting assembly, in particular the operation of the winch 23 such that it hauls in the hoist cable 24, establishes lifting of the top end of the pile. Along the upend deck 4, a bottom end of the pile 10 is movable, over a trajectory extending in the longitudinal direction X of the vessel 1 from, in the initial position of the pile 10, a position of the bottom end that is longitudinally distal from the base 11 of the lifting device 3, which is at the bow of the vessel 1 in the depicted embodiment, to adjacent the base 11 of the lifting device 3, which is at the stern of the vessel 1 in the depicted embodiment. By the lifting of the top end, and the rearwards movement of the bottom end in the X-direction, the pile is upended to its upright orientation alongside the upright superstructure in the inboard retaining position.

To establish the lifting of the top end, the lifting device 3 comprises:
a base 11 via which the lifting device 3 is supported by the hull 2,
an elongate, upright superstructure 12, 18 and
a lifting assembly 14.

In the shown embodiment the lifting device 3 is a crane—although other embodiments are suitable as well.

The shown crane 3 is an upend crane, wherein the lifting assembly 14 is comprises two hoists, and the upright superstructure comprises a crane housing 18 and a boom 12 which is, for the purpose of upending, in a fully raised, upend position in which it extends substantially in the Z-direction of the vessel 1.

The boom 12 extends between a base end 12a and a top end 12b. The boom 12 is at the base end 12a pivotable supported by the crane housing 18 for pivoting about a horizontal boom pivot axis 20. Thus, the boom 12 can be pivoted between lowered positions and a fully raised, upend position. In the figures the boom 12 is depicted in the fully raised upend position. A lowered position serves as a storage position which is used during travel of the vessel between locations. By lowering the boom 12 when not in use, the overall center of gravity of the vessel 1 is lowered, which improves the dynamic behavior of the vessel 1.

The crane base 11 supports a slew bearing 17 between the base 11 and the upright superstructure. The crane housing 18 of the upright superstructure in turn supports the boom 12 of the superstructure. The slew bearing 17 is provided between the crane housing 18 and the crane base 11. The slew bearing 17 enables the crane housing 18, and thus the boom 12 supported by the crane housing, to slew about a vertical slew axis 19 of the crane.

Each hoist 14 comprises a hoisting winch 23 and an associated hoisting wire 24. The hoisting wire 24 is guided via a top block 25 to a load coupling device 26 for coupling with a load, e.g. the top end of a monopile 10, to enable the crane to lift the load using the hoisting winch.

The crane 3 is provided with a luffing winch 21 and an associated luffing wire 22 for pivoting and supporting the boom 12 of the crane 3 in different positions. The luffing winch 21 is mounted on the crane housing 18. The luffing wire 22 extends between the luffing winch and the boom, to enable pivoting the boom between the lowered and the raised position.

The crane 3 comprises a trolley guide 15, in the form of a track comprising one or more guide rails, extending along the boom 12 in the longitudinal direction thereof. The crane 3 further comprises a trolley 16 which is coupled with the trolley guide 15 for being movable along the boom 12, guided by the trolley guide 15. The trolley 16 is provided with a wind turbine component engagement device that is configured to engage, and pivotably support, a wind turbine component at the top end thereof. The wind turbine component engagement device is with a lower part thereof configured to engage and support the top end of a wind turbine component. For engaging piles, the lower part may be in the form of a pile top end clamp, which is configured to engage and secure the top end of the monopile by clamping a surface thereof by means of actuatable clamping elements. Between the lower part and the connection to the trolley, the wind turbine component engagement device has a pivot with a horizontal pivot axis which can be oriented perpendicular to the longitudinal axis of the wind turbine component, for the purpose of upending thereof by moving a top end thereof upwards along the boom 12. The pivoting is necessary to enable the increase in the angle with respect to the pivot axis between the longitudinal axis of the monopile and the Z-axis as upending progresses—as can be verified from the advancement from FIG. 1 to FIG. 5.

In the illustrated case, the wind turbine component engagement device 80 is a pile engagement device 80, in particular a monopile top end clamp. Wind turbine component engagement devices, e.g. monopile top end clamps, for upending are known in the art. The trolley guide 15 is mounted to the boom 12 of the crane 3 for guiding the trolley 16 along the boom 12 of the crane 3. Thus, with the boom 12 being raised into the raised, upright position thereof, the boom 3 can be used for guiding the top end of the monopile 10 during upending.

Each hoist 14 is shown being connected to the pile engagement device 80 via the trolley 16. Each hoist 14 is configured to support the pile engagement device 80 via the trolley 16 by means of the load coupling device 26 of the hoist engaging the trolley 16. The trolley 16 is configured to engage the load coupling device 26, supported by the hoists 14. Thus when engaged, the trolley 16 is movable by the operation of the hoists 14, for guiding the wind turbine component engagement device 80, and thus for guiding the top end of the monopile supported by the wind turbine engagement device 80, along the trolley guide while upending the monopile 10 using the hoists 14. In particular, via the load coupling device 26 and the trolley 16, the hoists 14 is configured to move the pile engagement device 80 in a direction along the upright superstructure 12, between a lower position of the pile engagement device 80 in which the pile engagement device 80 is in a Z-direction of the vessel at or near the base 11 of the crane 3, and an upper position wherein the pile engagement device 80 is in the Z-direction remote from the base 11 wherein the pile 10 extends in an upright orientation alongside the boom 12, for inboard upending of the pile and outboard lowering of the pile. At the start of upending, in FIG. 1, the pile engagement device 80 is in the lower position as shown. The upper position is reached at the end of the upending, in FIG. 5, and is maintained during the subsequent displacement of the pile 10 to the outboard installation position, FIGS. 6-8. For the purpose of the subsequent lowering of the pile 10, the pile engagement device 80 moves downward again, to a relatively low, intermediate position between the lower and upper position.

In the embodiment shown, the boom 12 is an A-frame, and the trolley guide 15 comprises a track provided on both legs of the A-frame. The trolley 16 is coupled with both tracks of the trolley guide, and is thus movable mounted to each leg of the A-frame for being guided along the boom 12.

By the described construction, the pile engagement device 80 is configured, and arranged on the boom 12 via the trolley 16, such as to restrict movement of the engaged top end relative to the superstructure in the X-Y plane, which in the upright position of the pile corresponds to a plane perpendicular to a longitudinal axis of the engaged pile 10. After all, the mount of the trolley guide 15 to the boom 12, the coupling between the trolley guide 15 and the trolley 16, the connection between the trolley 16 and the pile engagement device 80, and the engagement of the pile by the pile engagement device 80, connects the pile to the boom 12. Via this connection, the movement of the top end is restricted relative to the boom 12, and thus, relative to the superstructure.

The crane 3 further comprises a boom securing device—not shown in the figures. The boom securing device comprising a stop for restraining the boom 12 in the raised upend position thereof shown in the figures, and a boom lock, for locking the boom 12 in the raised upend position—and therewith, to maintain the upright orientation of the trolley guide 15, and thus of the pile 10. Thus, the movement trajectory of the trolley 16, and therewith, the pile engagement device 80, are maintained by the locking of the boom 12. In particular, the boom lock is suitable to maintain the upright orientation while the crane 3 supports the pile 10—thus it must be capable of keeping the boom locked despite the force moment being exerted on the boom 12 by the weight of the supported pile 10, which tends to move the boom to lowered positions thereof. The crane 3 also comprises a boom mobiliser for pivoting the boom 12 out of the raised upend position. This boom mobiliser is not shown in the figures, but may be a hydraulic cylinder operative for pushing or pulling of the boom 12, or a boom mobilisation winch with an associated wire for pulling the boom 12 for pivoting the boom 12 out of the raised upend position.

The trolley guide 15 furthermore extends along the base 11 of the crane 3, thus extends below the horizontal boom pivot axis 20 at least when the boom 12 is in the raised upright position. This enables the lower position of the pile engaging device to be below the boom pivot axis, so that the monopile can be engaged at a small height above the deck. With the same height of the monopile, and thus, the same height range between the lower and upper position of the pile engagement device, the height of the top end of the boom 12 can therefore be limited relative to an embodiment wherein the trolley guide 15 does not extend along the base, e.g. extends only along the superstructure.

According to the invention, the installation vessel 1 is configured to guide both the bottom end and the top end of the monopile 10 during upending of the monopile 10. The top end is guided along the superstructure, namely along the boom 12 of the superstructure. For guiding the bottom end, the vessel 1 is provided with the cart track 5 and the support cart 6.

The cart track 5 extends along the upend deck 4. The support cart 6 is supported by the cart track 5 to enable the cart 6 to move along the cart track 5 for guiding the bottom end of the monopile 10 along the upend deck 4. The support cart 6 is configured for supporting the bottom end of a monopile, and for allowing the bottom end of the monopile to pivot while the support cart is moved along the cart track 5. Thereto, an upper part of the support cart is configured for engaging the bottom end. A pivot, with a horizontal pivot axis perpendicular to the longitudinal axis of the pile 10, is provided between the engagement of the cart 6 with the track 5 and the upper part of the support cart 6.

After the upending phase, the next phase in the installation is to displace the upright pile 10 in the X-Y plane from the onboard retaining position to the outboard installation position, so that it can in the subsequent phase be secured in the installation position. As is known in the art this is securing is done by lowering of the pile, through an outboard gripper device of a pile gripper secured to the vessel at or near an edge of the hull of the vessel 1, to the sea bottom and driving it into the seabed. Therein the gripper device holds the pile in the installation position of the pile and maintains its X-Y location. Such pile gripper comprises:
a gripper base via which the pile gripper is supported by the hull, and
a gripper device which is configured to engage the upright oriented pile at a lower end thereof, so as to restrict movement thereof relative to the gripper base in the X-Y plane, i.e. perpendicular to the longitudinal axis of the pile, and to guide a vertical movement of the pile through the gripper device, i.e. in the direction of to the longitudinal axis of the pile.

The displacement of the pile to the outboard installation position is according to the invention established by engaging the lower end of the pile 10 by means of the pile gripper 7, which is placed at a distance from the base 11 of the crane 2, and to move the engaging part thereof, the gripper device, over the same trajectory as the pile engagement device of the crane to the outboard installation position, so as to displace both ends of the pile 10 simultaneously to the outboard installation position. The pile gripper 7 is after the displacement phase, also used in the subsequent phase of securing the pile in the installation position, in the manner known in the art. Thus, according to the invention, the same pile gripper 7 is in addition to the securing phase, also used for holding the pile 10 during the displacement phase. This advantageously obviates the use of a separate facility for holding the pile 10 during the displacement phase, and a transfer from this facility to the gripper device of the pile gripper 7.

The possibility to use the pile gripper 7 for both phases, is enabled in particular by two aspects of the pile gripper 7, which relate to the second and third aspect of the invention.

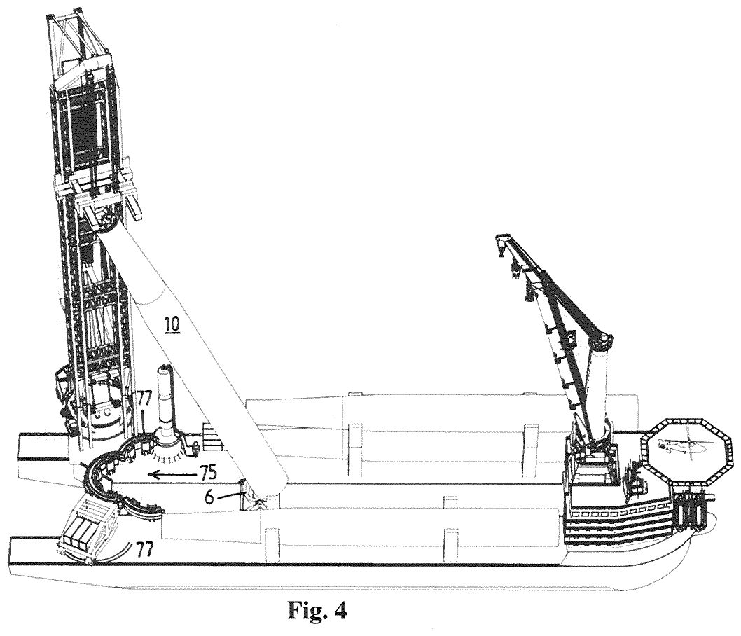

In accordance with the second aspect of the invention, the pile gripper 7 has a receiving mode wherein an opening 75 of the gripper device 7 is directed to the upend deck 4 so that the pile is enabled to pass through the opening with its bottom end when being upended to its upright orientation in the inboard retaining position thereof. This is in particular visible in FIGS. 4, 5, 16, and 21. When the gripper device 71 of the pile gripper 7 is in the inboard installation position of the pile 10, the pile extends upright inside the gripper device 71 after upending is complete. Thus, passing the bottom end of the pile 10 through the opening of the gripper device 71 moves the pile 10 to the onboard retaining position. The second aspect thus allows to receive the pile 10 into the gripper device 7 by upending. The opening 75 is in line with the movement trajectory of the bottom of the pile 10 in the X-direction, and has at least a width corresponding to the pile diameter.

In the shown embodiment the gripper device 71 comprises a ring 74 comprising multiple pile engaging tools 76 distributed about the circumference of the ring 74, each pile engaging tool 76 being adapted to engage an exterior of the pile 10 extending through the ring 74 in the upright orientation thereof, e.g. each pile engaging tool 76 comprising one or more pile guiding rollers. The ring 74 of the gripper device 71 comprises a ring base and one or more movable jaws 77, e.g. two jaws, forming respective segments of the ring and being pivotal relative to the base between a closed position, in which the ring 74 forms a closed annulus, and an opened position, wherein the opening 75 is present. This opened position enables the pile 10 to pass laterally into and out of the ring 74 through the opening 75 in the annulus between the jaws 77.

Other variants are however also possible, for example jaws which do not pivot but slide along the annulus to move to the opened position.

In the shown embodiment the receiving position is enabled by both moving the ring 74 in the onboard retaining position of the pile, that is, such that when the pile 10 is in the onboard retaining position, the ring 74 is able to enclose and engage the exterior of the pile 10. At the end of the upending phase, in FIGS. 5, 18, and 21, the monopile 10 rests with the exterior of its bottom end against the base of the ring 74. The moving of the ring to the retaining position is here established by moving the gripper device 71 in a clockwise direction over the curved rail 73 of the gripper base 72, thereby moving shoes of the gripper device 71 towards the stern, and moving the ring 74 in a direction towards the upend deck 4. To save time, the gripper device 71, which is initially in the outboard installation position so that the ring 74 does not interfere with the top end while the monopile 10 is still stored horizontally, see FIG. 1, the gripper device 71 is moved from this initial position to the retaining position during the upending of the pile by operating the winches 23 of the lifting device 23, see the advancement from FIG. 1 to FIG. 3. As soon as the upper end is lifted above the height of the gripper device, the deck space where the upper end of the pile was stored is cleared for the gripper device, so that it is enabled to move to the retaining position.

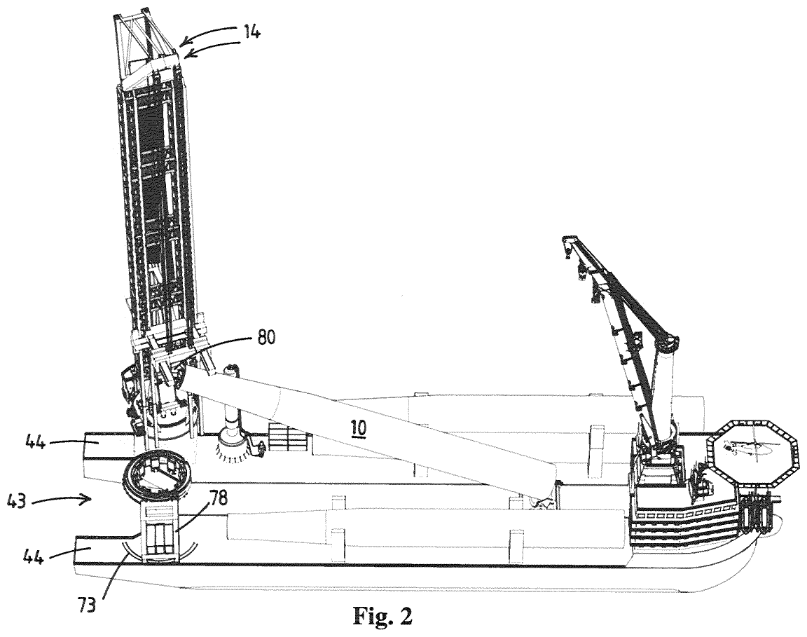

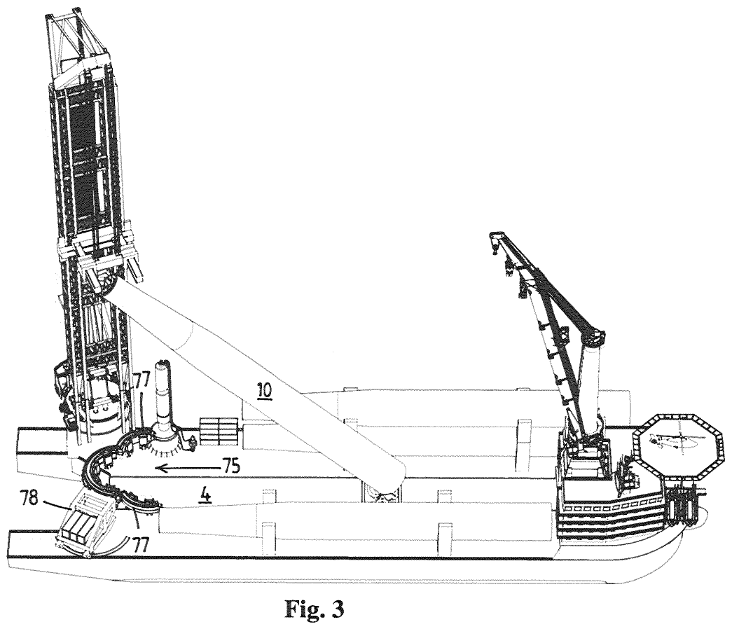

As is shown in FIG. 4, the opening of the gripper device 71 so as to create the opening takes place prior to the arrival of the bottom end near the opening, so that the jaws still have space to pivot outwards without interfering with the upending, in particular with the bottom end being in the way. The opening is in the shown installation method done during the upending of the pile by operating the winches 23 of the lifting device 3, see FIGS. 2 and 3.

After the upending the jaws of the ring 74 are moved to the close the ring 74, so that also the pile engaging tools 76 on the jaws 77 now engage the exterior of the ring 74. The monopile is engaged and supported from above via the pile engagement device 80. By operating the hoists 14, hauling in the hoist wires 24 further on the winches 23, the crane 3 is able to lift the pile 10 from the cart 6 so as to release the pile 10 from the cart 6. The cart 6 is subsequently moved frontwards along the track 5 to a rest position at the front end of the track 5.

In accordance with to the third aspect of the invention, the pile engagement device 80 and the gripper device 71 are, by respective movabilities thereof in the X-Y plane relative to the vessel 1, whilst both engaging the pile 10, and whilst supporting the pile 10, simultaneously movable relative to the hull 2 from the inboard retaining position in which the pile engagement device 80 is in the upper position and the pile 10 is above the hull 2, to the outboard installation position of the pile 10 in which the pile is outside the contour of the vessel. The outboard installation position is shown in FIGS. 8-13, 18, and 23.

In the shown embodiment, the vessel 1 comprises a recess 43 in the longitudinal direction X of the vessel 1 at the stern of the vessel 1. The recess 43 is flanked laterally by two deck portions 44. The trajectory of the movement from the inboard retaining position to the outboard installation position runs laterally in between the two deck portions, and the outboard installation position is, considered in the X-Y plane of the vessel 1, inside the recess 43. This advantageously enables a short movement trajectory from the retaining to the installation position. The recess 43 is in line with the upend deck 4, and therefore, with the movement trajectory of the bottom end of the pile 10 during upending.

As is visible from the advancement from FIG. 6 to FIG. 8, the movement of the pile from the inboard retaining position to the outboard installation position involves a rotation of both the pile engagement device and the gripper device, and thus of the pile when engaged thereby, around the slew axis of the lifting device.

The movability is in the lifting device 3 provided by the slew bearing 17. The lifting device 3 further comprises one or more displacement actuator assemblies, in particular, slewing actuators, between the base 11 and the superstructure 12, 18 for actuating the movement of the pile engagement device 80 from the inboard retaining position to the outboard installation position. In the depicted embodiment, the movability is established by the base 72 of the pile gripper comprising a curved rail 73. The base 72 of the pile gripper 7 further comprises one or more displacement actuator assemblies operative between the gripper base 72 and the gripper device 71 for actuating the movement of the gripper device 72 from the inboard retaining position to the outboard installation position. This slewing of the crane 3 provides the advantages that the slew bearing is a common part for a crane 3, and that a translation of the superstructure along the X-Y plane is omitted. Such translation generally involves more friction, would pose high requirements on tracks and shoes, and could have a negative effect on the stability of the crane 3. In this embodiment, the base 11 can advantageously remain stationary relative to the hull 2.

The movability of the gripper device is provided by the gripper base comprising one or more gripper guides, here the curved gripper rail 73 which forms the segment of a circle. The gripper rail 73 is mounted to the deck of the hull 2 and defines a curved track for the gripper device 71. The gripper device comprises multiple shoes for engaging the track, see e.g. the side views. The movement of the gripper device 71 from the inboard retaining position to the outboard installation position of the pile 10 involves moving the gripper device 71 along the track 73.

Considered in the X-Y plane of the vessel 1, the base 11 of the lifting device and the gripper base 72 are spaced from one another, and the movement of the pile 10 from the inboard retaining position to the outboard installation position has a movement trajectory which passes in between the base 11 of the lifting device 3 and the gripper base 72. This makes that the crane 3 can establish the movement on one side of the pile 10, and the gripper on the other side.

The movement of the pile 10 from the inboard retaining position to the outboard installation position involves a relative movement of the pile engaging device 80 with respect to the base 11 of the lifting device 3 which is opposite to the relative movement of the gripper device 71 with respect to the gripper base 72, namely, clockwise and counter-clockwise, respectively.

During the rotation of the pile engaging device 80 and the gripper device 71 around the slew axis 19 of the crane 3, the pile engaging device 80 and the gripper device 71 make, with respect to the longitudinal axis of the pile 10, opposite angular slewing movements around this longitudinal pile axis, relative to one another. To allow for both the pile engaging device 80 and the gripper device 71 to relatively slew in these opposite angular directions, whilst both remaining to engage the pile 10 during the displacement of the pile 10, the engaging parts of the engaging and gripper device 71 may be provided rotatable relative to a central slew axis thereof that corresponds to the longitudinal pile axis when engaged. This may be provided in, for example, one or more of the following ways:
a slewability of a lower, pile engaging part of the pile engagement device 80 to which clamping devices for engaging the pile surface are provided, e.g. divided along the circumference, relative to an upper part that is attached to the trolley 16, e.g. a pivot with the central slew axis being provided directly above, directly below, or integral with (e.g. in the form of a ball or universal joint) the pivot with the horizontal axis for the purpose of upending,
a rotatability of the individual clamping devices with respect to a remaining part of the pile engagement device 80, a circular circumferential track being provided between the remaining part and the individual clamping devices, the individual clamping devices having shoes for coupling with the track and moving there along,
a slewability or slidability of the engaging surfaces of each the clamping devices, relative to the pile surface engaged, e.g. the surfaces being made out of a low-friction material or e.g. the engaging surfaces being outer surfaces of rollers with respective axes parallel to the engaged surface of the pile,
a rotatability of the individual pile engaging tools 76 with respect to the ring 74, a circular circumferential track being provided between the ring 74 and the individual engaging tools 76, the individual engaging tools having shoes for coupling with the track and moving there along,
a slewability or slidability of the engaging surfaces of each the pile engaging tools 76, relative to the pile exterior surface engaged, e.g. the surfaces being made out of a low-friction material,
a slewability of the ring 74 around the central axis thereof, e.g. the ring 74 comprising an exterior circumferential rail and a support frame 78 supporting the ring 74 on the gripper base 72 comprising shoes engaging the rail.

Other, similar solutions within the scope of the invention may be obtained by the person skilled in the art.

The fact that the superstructure only makes a slewing motion, and the gripper device 71 moves along a rail, which involves a larger movement distance, is advantageous since it is the superstructure which generally bears the majority of, e.g. substantially the entire, weight of the upright pile 10. Thus the gripper device 71 has more of a guiding function, and it will be significantly less demanding for the gripper device 71 than for the crane parts to establish a larger translatory movement over a rail to move to the outboard position of the pile 10.

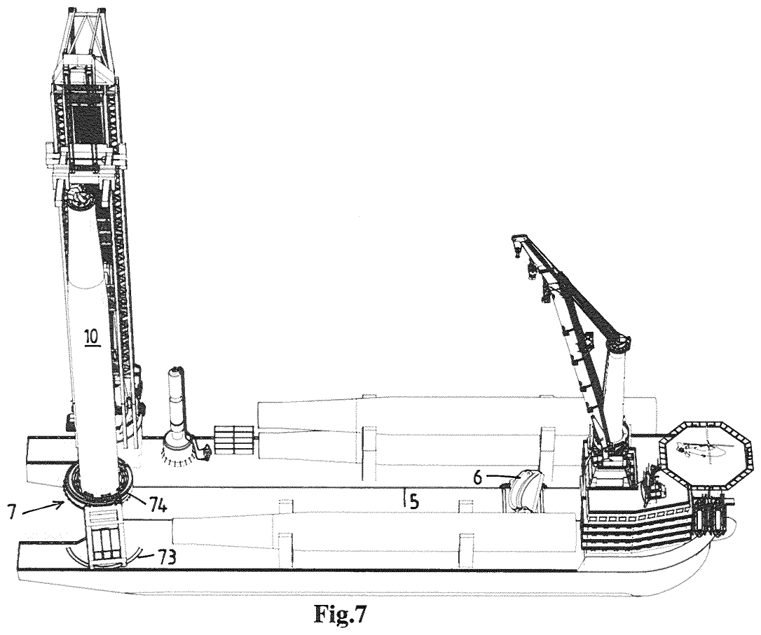

The base 11 of the lifting device is located at the port side of the recess 43, and is partly on the port side deck portion 44. The gripper base 72 is located at the starboard side of the recess 43, partly on the starboard deck portion 44. Halfway the displacement, see FIG. 7, the pile is above the Y-directed frontmost edge of the vessel 1 in the recess 43, and the boom 12, the pile engaging device 80, the pile 10, and the gripper device 71, are substantially in one Y-directed line. This relative positioning of the crane 3 and the gripper 7, the recess 43 and the deck portions, makes that the angular range with respect to the slew axis 19 between the inboard and the halfway position, and that between the halfway position and the outboard position, are both as small as possible. This makes that with a pure slewing motion, the movement trajectory of the pile during the displacement involves only a small lateral movement component, and is thus as much as possible in line with the straight movement trajectory during upending.

Both the pile engagement device 80 and the gripper device can, in addition to the rotational movability around the slew axis, also be moved in the X-Y plane by translation.

In the crane 3, this embodiment has a translatability of the pile engagement device 80 relative to the trolley guide 15 in the X-Y plane, provided in the trolley 16 between the connection to the pile engagement device 80 and the connection to the trolley guide 16. In this embodiment, the pile engagement device 80 is movable in two perpendicular directions in the X-Y plane. One direction is tangential with respect to the slew axis 19, and one is radial with respect thereto. In other embodiments, a translatability in only one direction in the X-Y plane may be provided, for example radially with respect to the slew axis 19.

In the figures, it is shown that the trolley 16 is provided with a frame projecting in the X-Y plane from the trolley guide 17, and the pile engaging device 80 is attached on the bottom side of this frame. The frame comprises guides extending in both directions, in particular one guide in the tangential direction and two guides in the radial direction, with respect to the slew axis 19. The tangentially directed guide engages and is movable along the radially directed guides, thus in the radial direction. The pile engagement device 80 engages and is movable along the tangentially directed guide, thus in the tangential direction. Thereby, movements for the pile engagement device 80 are possible in any direction by combining a movement of the tangential guide over the radial guides and a movement of the pile engagement device 80 over the tangential guide. The perpendicular arrangement of the guides may be advantageous in terms of ease of coordination in movement control and in terms of simplicity and robustness of the construction. Other non-parallel arrangement of the guides are also possible in order to enable movement in intermediate directions by combining.

The trolley is provided with actuators between the tangential and radial guides, and between the connection with the pile engaging device 80 and the tangential guide, for actuating the movements of the pile engagement device 80 in the X-Y plane.

In the pile gripper, this embodiment has a translatability of the gripper device 71 relative to the gripper base 72 in the X-Y plane, provided in the support frame 78 via which the ring 74 is supported on the base 72. An upper part of this support frame is movable in the X-Y plane relative to a lower part, by two perpendicular sets of tracks. The upper part of the support frame is provided on a set of second tracks in the form of guides, and the set of second tracks is provided on the set of first tracks in the form of guides, the first and second track sets extending perpendicular to one another in the X-Y plane of the vessel. Movements for the ring 74 are possible in any direction by combining a movement of the second set of guides over the first set of guides and a movement of the upper part of the support frame 78 over the second set of guides. Other non-parallel arrangements of the track sets are also possible.

In an embodiment the support frame 78 comprises a track between the upper and lower part of the support frame 78 in one direction only, preferably in the direction perpendicular to the curved rail 73. In this case movements in more directions are possible by combining the movement of the pile gripper 71 along the curved rail 73 and along the track in the support frame.

The additional movability may aid in the displacement phase, for example to resolve small disparities between the positions of the ring 74 and the pile engaging device or to correct undue tilting of the pile 10, for example as a consequence of influences of the wind and sea state induced motions of the vessel. Or, to correct undue shifts of the position relative to the vessel, e.g. to the edges of the recess 43.

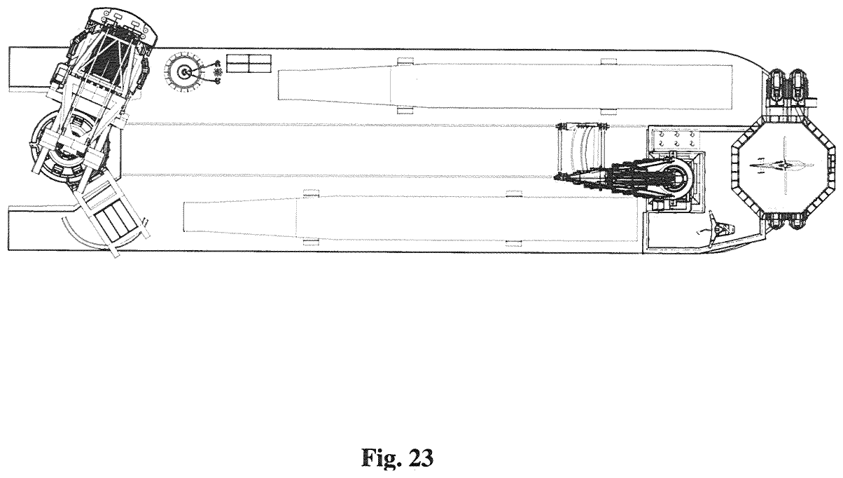

In FIGS. 9-13, 18, and 23 the securing phase is illustrated. Therein FIGS. 9-13 show lowering of the pile towards the sea bottom and subsequent pile driving thereof until it is fixed in the seabed, and FIGS. 18 and 23 both show the result of the lowering only. The lowering is effectuated by operating the winches 23 such that these unwind the hoisting cables 24. The pile engaging tools 76 of the gripper device 71 are configured to enable and guide this vertical movement of the pile 10 through the ring, e.g. comprise rollers with axes tangential to the circumference of the pile. This is known in the art.

This embodiment enables to provide X-Y motion compensation to the pile during the securing phase—although it can optionally be provided during the other phases as well. The X-Y motion compensation enables during lowering, to keep the pile upright in the installation position independent of sea state induced X-Y motions of the vessel relative to the sea bottom, for example due to waves and currents. An active X-Y motion compensation system is provided to both the crane 3 and the pile gripper 7, which makes use of the discussed additional movability of the pile engagement device 80 and the ring 74 relative to the vessel.

In particular, the support frame 78 comprises the active motion compensating actuation system for moving the gripper device relative to the vessel 1 in the X-Y plane of the vessel 1. The actuation system comprises an active wave-induced motion compensation mode in which the actuation system is operated to compensate the ring 74, and thus the bottom end of the pile 10, for sea state induced motion of the vessel in the X-Y plane. This includes maintaining the outboard installation position independent of the sea state induced vessel motion—so that the pile may be kept in place during lowering.

The active motion compensation actuation system of the pile gripper comprises in this embodiment, as is preferred, the earlier discussed first and second tracks. The actuation system further comprising one or more first compensating actuators operative between the first tracks and the second tracks, for moving the second tracks over the first tracks, and one or more second compensating actuators operative between the second tracks and the gripper device, for moving the gripper device over the second tracks. In preferred embodiments these are the same actuators as those discussed before.

The active motion compensating actuation system of the crane 3 comprises the tangential and radial directed tracks in the trolley 16. The active motion compensating actuation system is thereby configured for moving the pile engagement device relative to the trolley guide in an X-Y plane of the vessel, and comprises an active sea state induced motion compensation mode in which the actuation system is operated to compensate the pile engagement device 80, and thus the top end of the pile 10, for wave-induced motion of the vessel in the X-Y plane. This includes maintaining the outboard installation position independent of the sea state induced vessel motion.

The actuation system further comprising one or more first compensating actuator assemblies operative between the tangential guide and the radial guides, for moving the tangential guide over the radial guides, and one or more second compensating actuator assemblies operative between the radial guides and the connection to the pile engagement device for moving the pile engagement device over the radial guides. In preferred embodiments these are the same actuators as those discussed before.

In embodiments, linear recirculating roller bearings may be provided in the shoes that engage guides, for example in those of the cart 6, of the X-Y frame of the trolley 16, of the support frame 78 of the gripper 7, and of the gripper device 71 for engaging the curved rail 73. The linear recirculating roller bearing assemblies described in non-pre-published application NL2028920 are in particular suitable, in view of the high loading of the shoes.

In accordance with the fourth aspect of the invention, the ring 74 of the gripper device is slewable relative to the gripper base around a central, Z-oriented slew axis of the ring 74 in the closed position thereof, by means of one or more ring slew actuators, such that the opening 75 between the jaws 77 in the opened position of the ring 74 is movable from an angular position with respect to the central slew axis in which the opening 75 faces the upend deck 4 of the hull 2 of the vessel 1 in the inboard retaining position of the pile 10, and an angular position with respect to the central slew axis in which the opening 75 faces the water, including in the outboard installation position of the pile 10.

This enables slewing of the pile around its horizontal axis, when enabled by the pile engaging device 80. It also enables, that the gripper device has both the receiving mode, shown in FIGS. 4, 5, 16, and 21, and a release mode, shown in FIG. 13. This release mode is provided for facilitating the last phase of the installation method, namely the release of the pile 10 from the vessel 1 after the securing thereof at the installation location. With respect to the receiving mode, the opening has in release mode rotated around the central axis of the ring 74 such that it faces the water, compare FIGS. 4 and 5 with FIG. 13. The jaws 77 of the ring 74 have thereto rotated around the central axis directly after the displacement of the pile from the inboard to the outboard installation position. In FIG. 8, the jaws are prior to the lowering already rotated so that when opened, the opening faces the water, in particular in the X-direction.

In the shown embodiment, as is preferred, the opening 75 is arranged such, that the pile can pass through the opening by moving the vessel 1 forwards in the X-direction—this can be envisaged from FIG. 13. This facilitates the release of the pile after securing it, however, it also enables that, in case of an anomality, e.g. a sudden instability and/or tilting of the pile prior to or during lowering or pile driving, which cannot be corrected e.g. by employing the DP system of the vessel 1 or the X-Y movement systems of the pile gripper 7 and the trolley 16, it is possible to open the jaws to create the opening, and eject the pile 10 in the X-direction rearwardly away from the vessel, for example by a dedicated ejection system therefor. In addition or alternatively, the vessel 1 may be moved forwardly fast, after opening of the jaws 77, for example in case the pile is tilting rearwardly away from the vessel, or if an ejection system is not present.

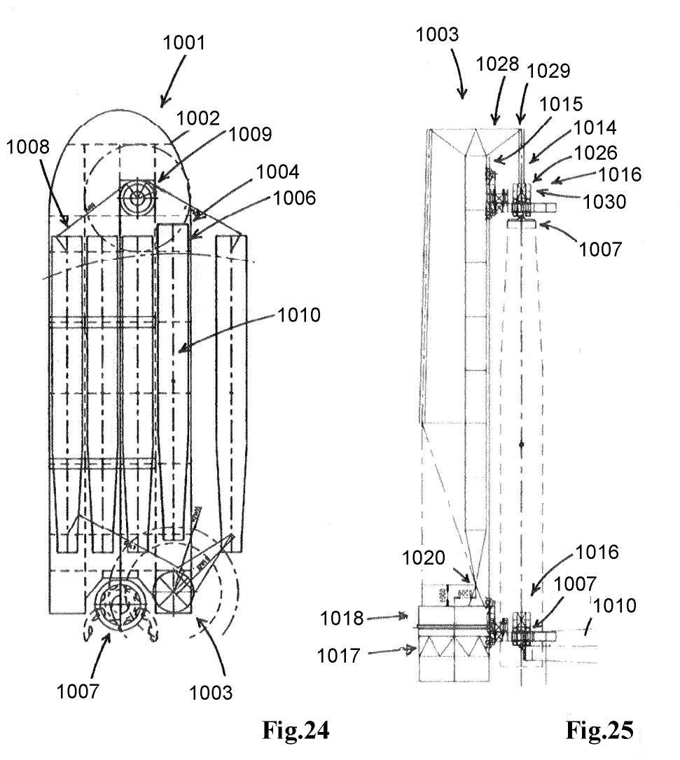

FIG. 24 shows an alternative embodiment of a lifting device 1003 according to the invention, mounted on an installation vessel 1001. The installation vessel 1001 comprises a hull 1002, the crane 1003, an upend deck 1004 with a cart track 1005 and a support cart 1006, a monopile gripper 1007 and a storage deck 1008. In the embodiment shown, the vessel 1001 is furthermore provided with a storage crane 1009.

In the embodiment shown, the vessel 1001 has a non-jack-up type floating hull 1002, and is configured to maintain a position and orientation relative to an installation site. Thus, the vessel can be positioned adjacent a monopile installation site and install a monopile using the monopile gripper 1007 without the vessel having to be anchored jack-up legs having to be deployed.

In the embodiment shown, the hull of the vessel forms an upend deck 1004 and an storage deck 1008. The upend deck and storage deck are both part of a single vessel deck. On the storage deck 8 are stored three monopiles, one next to the other. In a further embodiment according to the invention, the storage deck is provided with storage racks that allow for storage of multiple rows of monopile, one row stack upon the other.

Furthermore, a monopile 1010 is depicted on the upend deck 1004. The crane 1001 and the storage crane 1009 are configured to each engage and end of a monopile, and thus lift the monopile from the storage deck 1008 onto the upend deck 1004 and vice versa. In FIG. 24, the crane 1003 and the storage crane 1008 are depicted lifting a monopile from a position adjacent the vessel, e.g. from a supply vessel such as a barge or from a quay, prior to moving the monopile to a storage position on the storage deck 1008.

FIG. 24 and FIG. 25 show a schematic side view of the crane 1003 of the vessel depicted in FIG. 23.

The crane 1003 is supported by the hull 1002 of the vessel 1001 adjacent the upend deck 1004. The crane 1003 comprises a crane base 1011, a boom 1012, a luffing winch 1013, and a hoist. The crane 1003 is furthermore provided with a trolley guide 1015 and a trolley 1016.

The crane base 1011 supports a slew bearing 1017 and a crane housing 1018, which crane housing in turn supports the boom 1012. The slew bearing 1017 is provided between the crane housing 1018 and the crane base 1011. The slew bearing enables the crane housing 1018, and thus the boom supported by the crane housing, to slew about a vertical slew axis 1019.

The hoist 1014 comprises a hoisting winch 1023 and an associated hoisting wire 1024. The hoisting wire 1024 is guided via a top block 1025 to a load coupling device 1026 for coupling with a load, e.g. the top end of a monopile, to enable the crane to lift the load using the hoisting winch.

The boom 1012 extends between a base end 1012a and a top end 1012b. The boom 1012 is at the base end 1012a pivotable supported by the crane housing 1018 for pivoting about a horizontal boom pivot axis 1020. Thus, the boom 1012 can be pivoted between a lowered position and a raised position. In FIG. 3 the boom is depicted in both a lowered and a raised position.

The crane 1003 is provided with a luffing winch 1021 and an associated luffing wire 1022 for pivoting and supporting the boom 1012 of the crane 1003 in different positions. The luffing winch 1021 is mounted on the crane housing 1018. The luffing wire 1022 extends between the luffing winch and the boom, to enable pivoting the boom between the lowered and the raised position.

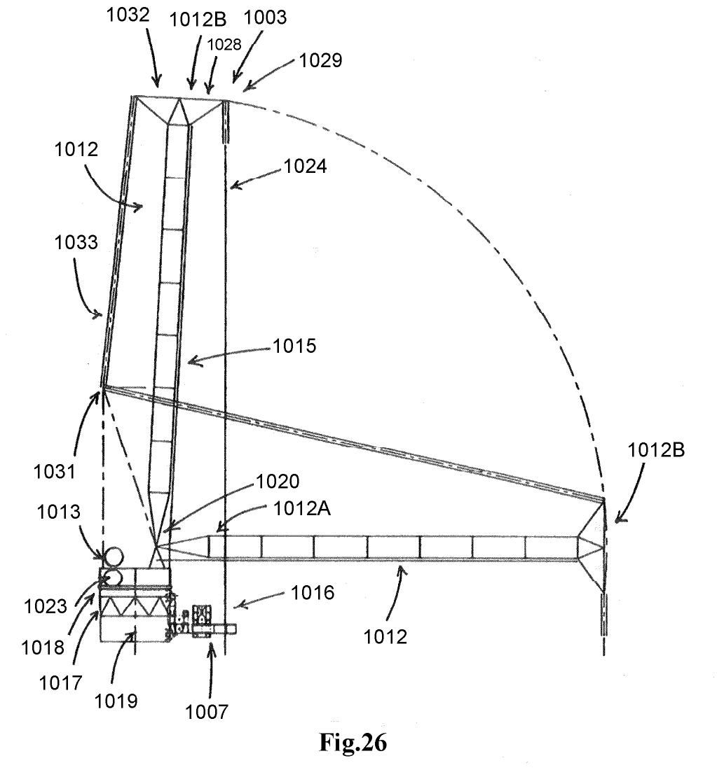

The lowered position in FIG. 26 is a storage position. This position is used during travel of the vessel between locations. By lowering the boom when not in use, the overall center of gravity of the vessel is lowered, which improves the dynamic behavior of the vessel.

The raised position depicted in FIG. 26 is an upend position. With the boom in this upright position, the crane can be used for upending monopiles, as will be explained in more detail below.

It is submitted that the boom can be pivoted, and supported, in many intermediate positions, positions raised relative to the storage position and lowered relative to the upend position, for lifting loads at a located away from the base of the crane. Furthermore, by pivoting the boom while lifting a load, that load can be moved towards or away from the crane base.

In FIG. 24, the range of the crane 1003 and the storage crane 1009 is depicted. It is submitted that, in the embodiment shown, the crane 1003 has to lower the boom to reach a storage position on the far side of the storage deck. Furthermore, to move the monopile over the upend deck to the storage deck, one of or both the crane and the storage crane have to raise their boom, compared to the position of the boom required for lifting the monopile adjacent the vessel.

In FIG. 24 the lifting device 1003 is combined with a monopile gripper that is known from the prior art. The monopile gripper is depicted in FIG. 24 in an opened and in a closed position. It is submitted that monopile grippers are generally known in the art. A monopile gripper is configured to engage a pile, and to thus position the pile, and to keep the pile in that location while the pile is lowered towards the seafloor. Typically, a monopile gripper is provided with a gripper or gripper device, e.g. a circular body provided with monopile guides in the form of rollers, that can be opened to allow for the monopile to be moved into the monopile gripper, and that can be subsequently closed to position the monopile. Also, a monopile can be lowered into a closed monopile gripper. The monopile gripper has to be opened to release the monopile after the monopile is driven into the seafloor.

The installation vessel 1001 is configured to guide both the bottom end and the top end of a monopile during upending of that monopile. The vessel is therefore provided with the cart track 1005 and the support cart 1006 for guiding the bottom end of a monopile, and with the trolley guide 1015 and the trolley 1016 for guiding the top end of a monopile during the upending process.

The cart track 1005 extends along the upend deck 1004. The support cart 1006 is supported by the cart track 1005 to enable the cart to move along the cart track for guiding the bottom end of the monopile along the upend deck from a position distal form the crane to a position adjacent the crane. The support cart 1006 is configured for supporting the bottom end of a monopile, and for allowing the bottom end of the monopile to pivot while the support cart is moved along the cart track 1005.

The trolley guide 1015 is mounted to the boom 1012 of the crane 1003 for guiding the trolley 1016 along the boom 1012 of the crane. Thus, when the boom 1012 is raised into an upright position, the boom can be used for guiding the top end of a monopile during upending.

In the embodiment shown, the boom 1012 is an A-frame, and the trolley guide comprises a track provided on both legs of the A-frame. The trolley 1016 is movable mounted to each leg of the A-frame, and is thus coupled with the trolley guide for being guided along the boom of the crane.

The trolley 1016 is configured to engage the load coupling device 1026, supported by the hoist 1014, for guiding the load coupling device, and thus for guiding the top end of the monopile supported by the load coupling device, along the trolley guide while upending the monopile using the hoist.

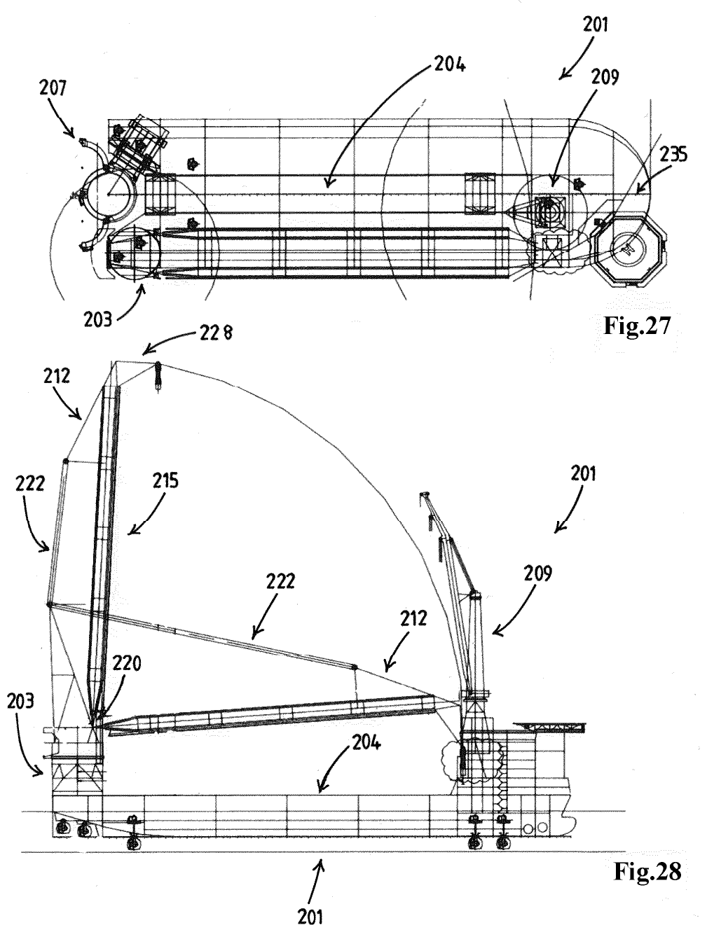

FIG. 27 shows a schematic top view of another exemplary embodiment of an installation vessel 201 according to the invention wherein the vessel is provided with an upend crane 203 and an upend deck 204 that is aligned with the central axis 235 of the vessel.

FIG. 28 shows the vessel 201 of FIG. 27 with the boom 212 of the upend crane 203 depicted in both a raised upend position and a lowered position.

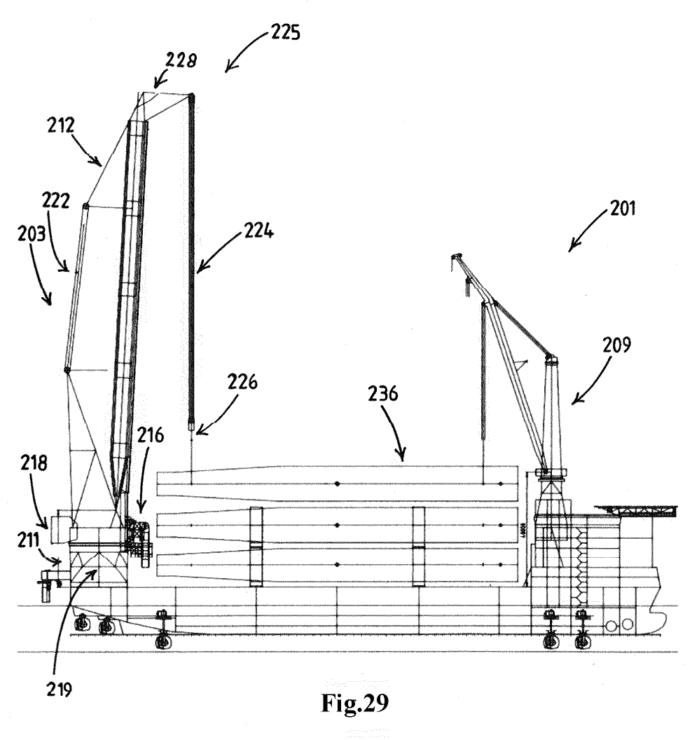

FIG. 29 shows a side view of the vessel 201 of FIG. 27 with the upend crane 203 and a storage crane 209 supporting a wind turbine component 236.

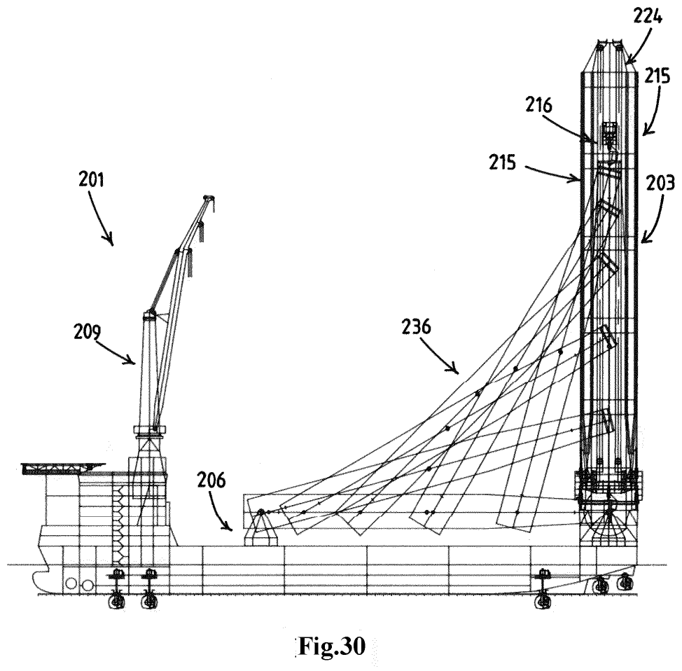

FIG. 30 shows a side view of the vessel of FIG. 27 with the boom 212 of the upend crane 203 in the upend position and shows a monopile 236 depicted in multiple intermediate positions of the upend process.

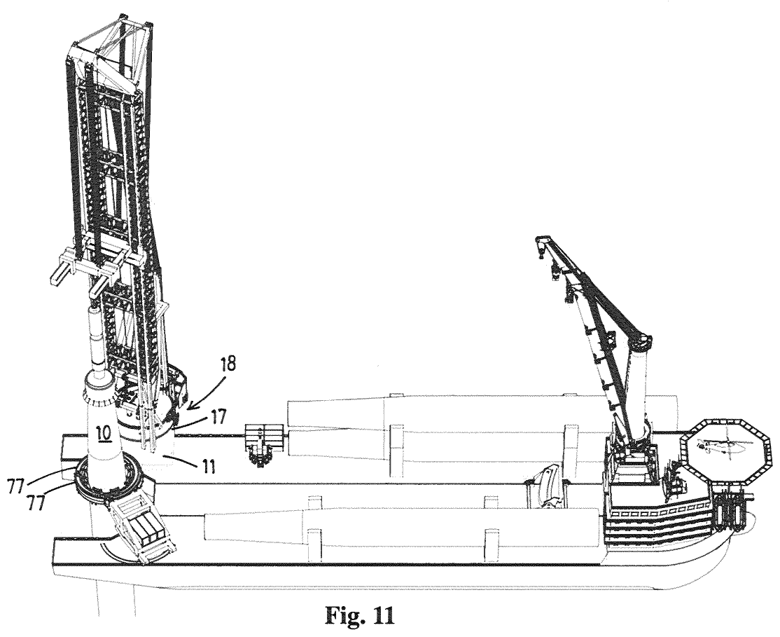

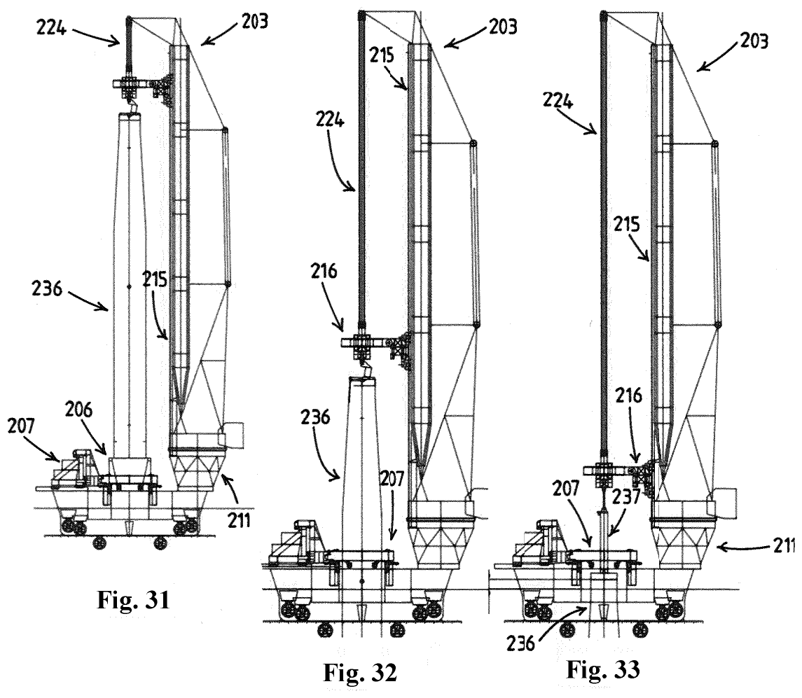

FIG. 31-33 show how the process following the upending of the monopile 236. Once the monopile 236 is upended, the crane 203 furthermore lifts the monopile in a vertical direction from the support cart 206 and slews about the vertical slew axis 219 to position the monopile above the monopile gripper 207, see FIG. 11. Subsequently, the crane 203 is used to lower the monopile 236 towards the seafloor, while the monopile is guided by the pile gripper 207, see FIG. 32. Once the monopile 236 is landed on the seafloor, the crane 203 is used to mount a hammer 237 on top of the monopile 236, and the monopile is driven into the seafloor, see FIG. 33.

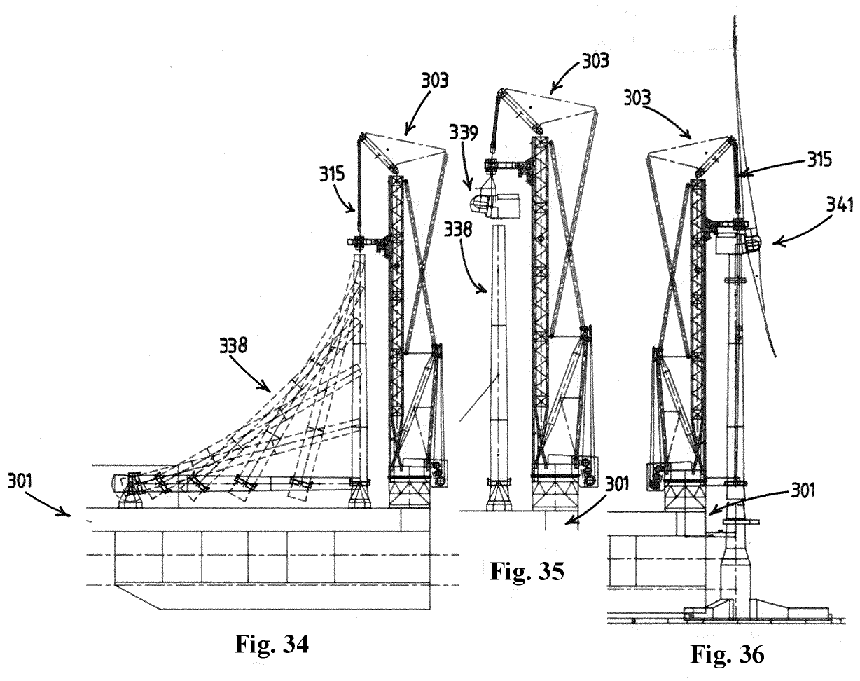

FIG. 34 shows a side view of the vessel 301 and shows a mast 338 depicted in multiple intermediate positions of the upend process.

FIG. 35 shows a side view of the vessel 301 and shows the upend crane 303 mounting a nacelle 339 on the mast 338, the mast being supported in an upright position.

FIG. 36 shows a side view of the vessel 301 and shows the upend crane 303 supporting an assembled wind turbine 341 in an overboard position, i.e. outside a contour of the vessel 301, at an installation location.

FIG. 37 shows a top view of another exemplary embodiment of a vessel 401 according to the invention, wherein the vessel 401 is configured for transporting wind turbine components, for assembling a wind turbine, and for mounting the assembled wind turbine on a foundation. The vessel 401 is provided with an upend crane 403 and an upend deck 404 that is aligned with the central axis 435 of the vessel 401.

FIG. 38 shows a schematic side view of the crane 403 with the boom 412 of the crane in the upend position, and with a trolley 416 supporting a blade installer device 442 supporting a blade 440 adjacent a nacelle 439 of a wind turbine being assembled.

FIG. 39 shows in close up the blade installer device 442.

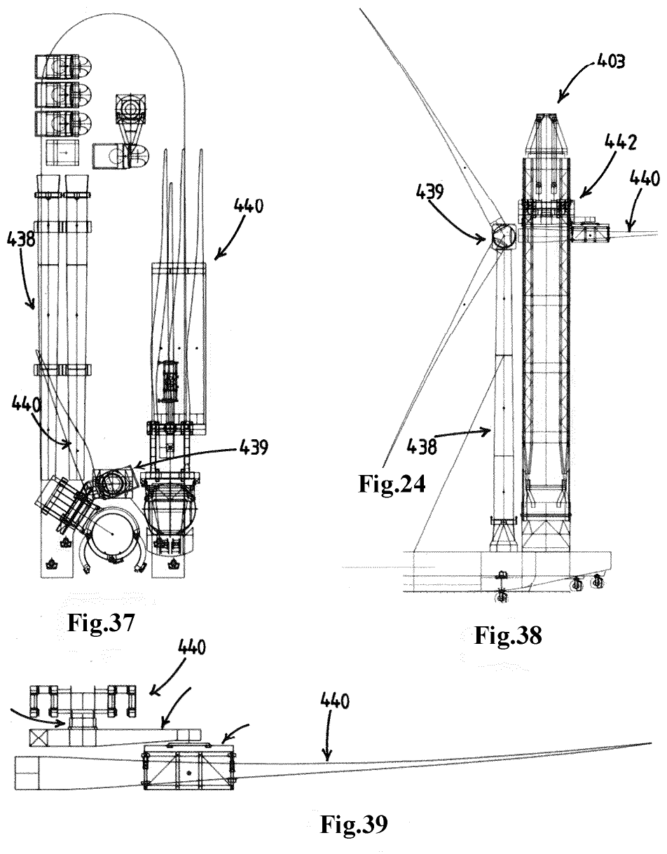

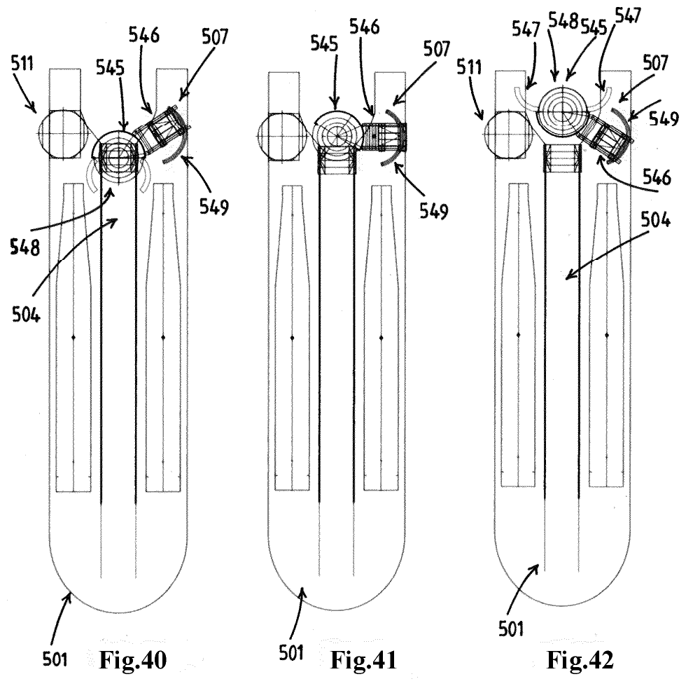

FIG. 40 shows a top view of another exemplary embodiment of a vessel 501 according to the invention. The vessel 501 is provided with an upend crane 503, of which only the crane base 511 is depicted, an upend deck 504 that is aligned with the central axis 535 of the vessel, and a gripper 507 for guiding monopiles 536.

In the embodiment shown, the vessel 501 comprises a recess 543, i.e. a setback in the contour of the vessel, at the aft of the vessel. The recess 543 is flanked by two deck portions 544. The gripper is a mono pile gripper 507 configured to guide a monopile 535, which is supported by the upend crane 503 in the recess 543.

In the particular embodiment shown, the monopile gripper comprises a gripper device or gripper ring 545 for guiding the monopile, and a frame 546 for supporting the gripper ring outside the contour of the vessel and for moving the gripper ring in the horizontal plane to compensate for movements of the vessel relative to the installation site, and thus relative to the pile supported at the installation site.

The gripper ring 545 is provided with two door sections 547, which in a closed position form part of the gripper ring, and which can be opened to provide an entry opening that allows for the monopile to be moved into or out of the gripper ring in a lateral direction relative to the gripper ring. FIG. 40 depicts the ring with the door sections closed, FIG. 40 and FIG. 42 shows the ring with the door sections opened.

In the particular embodiment shown, the gripper ring 545 is movable supported by the support frame 546, such that the gripper ring can be rotated about a vertical axis, and thus the entry opening 548 of the gripper ring can be moved. Thus, the gripper ring 456 can be positioned with the entry opening 548 facing the bow of the vessel for receiving a monopile supported by the upend crane 503 at the upend position, as shown in FIG. 40, and can be positioned with the entry opening facing the aft of the vessel for allowing a monopile that is driven into the sea floor to be move out of the gripper ring by the vessel moving away from the installation location. The latter position of the gripper ring is shown in FIG. 42.

Furthermore, in the exemplary embodiment shown. the support frame 546 is pivotable supported with one end mounted on a semi-circular support track 549, such that the frame can be pivoted about a vertical pivot axis, see FIGS. 40-42. The frame is configured to telescopically support the gripper ring, such that it can move the gripper ring towards and away from the semi-circular track. Thus, the gripper ring can be moved in the horizontal plane relative to the vessel, and the gripper ring can move with the lower end of a monopile being moved along the central axis of the vessel from an onboard position into an overboard position. Thus, the monopile is fully supported, at its top end by the trolley and at its lower end by the gripper ring, while the monopile is moved.

The gripper 507 is supported on the deck of the vessel 501. The gripper 507 is positioned to receive the lower end of a monopile 535 supported by the upend crane 503.

FIG. 41 shows a top view of the vessel 501. The gripper 507 moves with the crane to transfer the monopile 535 from an onboard position, depicted in FIG. 40, to an offboard position, depicted in FIG. 42.

FIG. 42 shows a top view of the vessel 501, wherein the gripper 507 is positioned to guide the monopile 535 at the installation location.

The invention can be summarized according to one or more of the following clauses:
31. Lifting device for upending an elongate wind turbine component, e.g. a foundation pile for supporting a wind turbine or a mast for supporting the nacelle of a wind turbine, onboard a vessel, the lifting device comprising:
   a base, wherein the base is configured to secure the lifting device to the hull of the vessel,
   an elongate, upright superstructure,
   a trolley guide, e.g. a track comprising one or more guide rails, extending along the upright superstructure in the longitudinal direction thereof,
   a trolley, coupled with the trolley guide for being movable along the upright superstructure, guided by the trolley guide, wherein the trolley is provided with a wind turbine component engagement device that is configured to engage, and pivotably support, a wind turbine component at the top end thereof, or wherein the trolley is configured to receive such a wind turbine component engagement device, optionally via a coupler provided to the trolley, for supporting a wind turbine component engagement device,
   a lifting assembly connected or connectable to the wind turbine component engagement device and/or the coupler therefor, e.g. via the trolley, and configured to move the trolley with the wind turbine component engagement device, and/or the coupler therefor, when connected, and therewith, the top end of the supported wind turbine component, along the trolley guide, and therewith along the superstructure from a lower position of the wind turbine component with its top end at or near the base to an upper position with the top end remote from the base and an upright orientation of the wind turbine component alongside the superstructure.
32. Lifting device according to clause 31 wherein the lifting assembly is a hoisting assembly comprising a hoisting winch and an associated hoisting wire, so that the trolley, and therewith the wind turbine engagement device and/or the coupler therefor, when connected, is movable along the guide by operating the hoisting winch.
33. Lifting device according to clause 32, wherein the hoisting assembly comprises an upper sheave assembly at the upright superstructure, and the hoisting assembly is connected or connectable to wind turbine component engagement device and/or the coupler therefor via a load coupling device comprising a lower sheave assembly, e.g. by means of a connection thereof to the trolley, the hoist wire being arranged in multiple falls through the upper and lower sheave assemblies to enable the crane to lift the load using the hoisting winch.
34. Lifting device according clause 32 or 33, wherein the lifting device is a crane, the base of the lifting device is a crane base, the upright superstructure is an upright crane superstructure, and wherein the crane superstructure comprises:
   a crane housing; and
   a boom,
wherein the boom extends between a boom base end and a boom top end, wherein the boom is at the boom base end pivotable supported by the crane housing around a horizontal boom pivot axis, the boom having lowered positions for lifting a load at a horizontal distance from the crane base, and a raised upend position to form the upright superstructure, for upending the pile alongside the crane base, and wherein preferably at least part of the trolley guide is mounted to the boom, and
wherein the crane further comprises:
   a luffing winch and an associated luffing wire, wherein the luffing winch is mounted on the crane housing and the luffing wire extends between the luffing winch and the boom, to enable pivoting of the boom between the lowered and the raised upend position around the horizontal boom pivot axis.
35 Lifting device according to any one or more of the clauses 31-34, wherein the lifting device, e.g. crane, further comprises a slew bearing provided between the base and the superstructure, e.g. between the crane base and the crane housing, wherein the slew bearing enables the superstructure to slew about a vertical slew axis relative to the base.
36. Lifting device according to at least clause 34, wherein the crane further comprises a boom securing device, the boom securing device comprising a stop for restraining the boom in the raised upend position thereof, and a locking device, for locking the boom in the raised upend position.
37. Lifting device according to at least clause 34, wherein the crane further comprises a boom mobiliser for pivoting the boom out of the raised upend position, e.g. a hydraulic cylinder operative for pushing or pulling of the boom, or a boom mobilisation winch with an associated wire for pulling the boom for pivoting the boom, out of the raised upend position.
38. Lifting device according to any one or more of the clauses 31-37, wherein the trolley guide furthermore extends along the base of the crane, and in a lifting device according to clause 34 extending below the horizontal boom pivot axis at least when the boom is in the upend position.
39 Lifting device according to clause 38, wherein the trolley guide comprises a boom section that is mounted to the boom of the crane, and a base section that is mounted to the base of the crane, wherein the trolley is movable from the boom section onto the base section, for example for coupling the top end of the wind turbine component to the wind turbine component engagement device.
40. Lifting device according to one or more of the clauses 31-39, wherein the wind turbine component engagement device, and/or the coupler therefor, if present, is arranged on an active X-Y motion device, configured for moving the wind turbine component engagement device e.g. via the coupler therefor, if present, relative to the trolley guide in an X-Y plane of the vessel, when the lifting device is secured to the hull.
41. Lifting device according to clause 40, wherein the active X-Y motion device comprises an X-Y motion compensating actuation control system, wherein the active motion compensating actuation system has an active sea-state induced motion compensation mode in which the actuation system is operated to compensate for sea-state induced motion of the vessel in the X-Y plane.
42. Lifting device according to clause 40 or 41, wherein the active X-Y motion device, e.g. including the active motion compensation actuation control system, comprises one or more first tracks, e.g. rails, and one or more second tracks, e.g. rails, extending non-parallel to one another in the X-Y plane of the vessel when the lifting device is secured to the hull, which second tracks are movable over the first tracks, the actuation system further comprising one or more first X-Y motion actuator assemblies operative between the first tracks and the second tracks, for moving the second tracks over the first tracks, and one or more second X-Y motion actuator assemblies operative between the second tracks and the wind turbine component engagement device and/or the coupler therefor, for moving the wind turbine component engagement device and/or the coupler over the second tracks.
43. Lifting device according to clause 42, wherein the first and second X-Y motion actuator assemblies of the active X-Y motion device are motor powered displacement actuator assemblies, e.g. hydraulic power assemblies each including a pump and one or more hydraulic cylinders, or winch assemblies.
44. Lifting device according to at least clause 35, wherein the crane further comprises a crane tower for supporting the wind turbine component, wherein the boom is provided on the crane at one side thereof relative to the slew axis of the crane, and the crane tower is provided on the opposite side of the crane relative to the slew axis, wherein the crane tower extends between a base end and a top end thereof, and is mounted in a fixed and upright orientation on the crane housing for slewing with the boom of the crane about the slew axis,
wherein the crane tower is provided with:
   a tower trolley guide, e.g. a track comprising one or more guide rails, extending along the tower in a longitudinal direction thereof;
   a tower trolley, coupled with the tower trolley guide for being movable along the tower, guided by the tower trolley guide, e.g. wherein the tower trolley is provided with a wind turbine component engagement device that is configured to couple to, and support, a wind turbine component at the top end thereof, or e.g. wherein the trolley is configured to receive such a wind turbine component engagement device and/or a coupler for supporting a wind turbine component engagement device; and
   a tower hoisting winch and an associated hoisting wire, wherein the hoisting wire is guided via the top of the crane tower for hoisting the crane trolley along the trolley guide for lifting and lowering the wind turbine component.
45. Lifting device according to at least clause 35, wherein the lifting device is provided with wind turbine component securing arms or tuggers for engaging a lower section of a wind turbine component supported by the lifting device in its upright orientation, in particular for preventing sway of the wind turbine component during slewing of the crane whilst supporting the wind turbine component in the upright orientation.
46. Lifting device according to at least clause 33, wherein the one or more hoisting wires pass between the upper sheave assembly and the lower sheave assembly, and wherein the hoisting winch has a power sufficient to support and lift the wind turbine component, e.g. to lift an assembled wind turbine or a pile.
47. Lifting device according to at least clauses 33 and 34, wherein the boom comprises a jib, and wherein the upper sheave assembly is provided in the jib such that the hoisting wires, at least when connected to the wind turbine component engagement device, e.g. via the coupler and/or trolley, extends horizontally spaced from the boom, and are preferably substantially in line with the central axis of a wind turbine component supported in its upright orientation by the wind turbine component engagement device.
48. Lifting device according to at least clauses 53 and 47, wherein a portion of the hoisting wires that extends between the trolley and the upper sheave assembly runs parallel to the trolley guide.
49. Lifting device according to at least clause 34, wherein the crane boom at the base end thereof comprises a gantry, and at the top end comprises a gantry jib, and is provided with one or more gantry wires extending between the gantry and the gantry jib, and wherein the luffing wire extends between the luffing winch and the boom extends between the luffing winch and the gantry of the boom.
50. Lifting device according to at least clause 32, wherein the boom forms an A-frame, comprising two legs, and wherein the trolley guide is provided on both legs of the A-frame, e.g. one or more tracks, e.g. rails, on each leg.
51. Lifting device according to at least clause 33, wherein the trolley is provided with a wind turbine component engagement device that is configured to pivotably support a wind turbine component at the top end thereof, and wherein the trolley is configured to be coupled with the load coupling device of the hoist.
52. Lifting device according to at least clause 33, wherein the trolley is configured to receive a wind turbine component engagement device that is supported by the load coupling device of the hoist.
53. Lifting device according to at least clause 33, wherein the trolley is configured to receive the load coupling device of the hoist, which load coupling device is supporting a wind turbine component engagement device that is configured to pivotably support a wind turbine component at the top end thereof.
54. Lifting device according to at least clause 32, wherein the crane further comprises a trolley hoist comprising a trolley hoisting winch with an associated trolley hoisting wire, and wherein the trolley hoisting wire is guided via a crown block to the trolley for moving the trolley along the trolley guide.
55. Lifting device according to at least clause 32, wherein the crane further comprises a secondary hoist comprising a secondary hoisting winch with an associated secondary hoisting wire supporting a secondary load coupling device configured to be connected to a load, and wherein the hoisting wire is guided via a crown block to the load coupling device for lifting a load horizontally spaced from the crane base using the secondary hoisting winch.
56. Installation vessel, for installation and preferably transport of wind turbine components, e.g. piles, e.g. monopiles, or masts, the installation vessel comprising:
   a hull, the hull forming an upend deck,
   a lifting device according to one or more of the clauses 31-55, wherein the lifting device is supported by the hull of the vessel adjacent the upend deck,
   a cart track, extending along the upend deck;
   a support cart for supporting a bottom end of the wind turbine component, wherein the support cart is supported by the cart track to enable the cart to move along the cart track for guiding the bottom end of the wind turbine component along the upend deck from a position distal from the crane to a position adjacent the crane;
   a gripper, the gripper extending outside a contour of the vessel, e.g. for guiding a monopile being lowered in a vertical position into the water adjacent the vessel or for engaging, and preferably stabilising, a floating foundation for mounting a mast.
57. Vessel according to one or more of the preceding clauses, wherein the vessel furthermore comprises a storage deck, supported by the hull of the vessel, wherein the storage deck is provided with storage racks for supporting multiple wind turbine components in a horizontal position, wherein the storage deck and the storage racks are configured to support multiple wind turbine components parallel to each other and preferably parallel to a longitudinal axis of the vessel.
58. Vessel according to clause 56 or clause 57, wherein the lifting device comprises a jib at a top end of the upright superstructure, for spacing the hoisting wire at a distance from the upright superstructure, and a slew bearing, for slewing the upright superstructure about a vertical slew axis relative to the base.
59. Vessel according to clause 58, wherein the lifting device is located at one end of the storage deck, and wherein the vessel is provided with a storage crane at an opposite end of the storage deck, and wherein the lifting device and the storage crane are configured to together lift wind turbine components from the storage deck to the upend deck, the lifting device and the storage crane each lifting an end of the wind turbine component.
60. Vessel according to clause 58 or clause 59, wherein the upend deck and the lifting device are configured such that the wind turbine component, when supported in a horizontal position on the upend deck and with the top end of the wind turbine components coupled to the load coupling device, is parallel to a longitudinal axis of the vessel.
61. Vessel according to one or more of the clauses 58-60, wherein the cart track is aligned with the slew axis of the lifting device, such that a central axis of the wind turbine component supported at one end by the cart and at an opposite end coupled with the trolley is aligned with the slew axis of the lifting device.
62. Vessel according to one or more of the clauses 58-60, wherein the upend deck with the cart track is located on the central axis of the vessel, and the lifting device is mounted away from the central axis of the vessel, e.g. along the side of the vessel, and wherein the cart track is thus not aligned with the slew axis of the lifting device.
63. Vessel according to one or more of the clauses 57-62, wherein the gripper is a pilegripper and is located at the stern of the vessel for engaging a pile that is supported by the lifting device on the central longitudinal axis of the vessel.
64. Vessel according to clause 63, wherein the vessel comprises a recess at the stern of the vessel, the recess being flanked by two deck portions, and wherein the pilegripper configured to guide a monopile in the recess.
65. Vessel according to clause 64, wherein the pilegripper is mounted on one of the deck portions and the upend crane is mounted on the opposite deck portion.
66. Vessel according to clause 65, wherein the upend deck is provided on the central axis of the vessel, and is aligned with the recess, and wherein on opposite sides of the upend deck a storage deck is provided, the storage decks being aligned with the deck portions, and wherein the storage deck aligned with the deck portion on which the crane is mounted, is provided with storage for wind turbine blades.
67. Vessel according to one or more of the clauses 57-66, wherein the vessel is provided with a wind turbine assembly station at an end of the upend deck and adjacent the lifting device, for assembling a wind turbine, i.e. for mounting a nacelle on a mast and for providing the nacelle with blades,
68. Vessel according to one or more of the clauses 57-67, wherein the lifting device comprises a blade installer device, which blade installer device can be mounted to the trolley, for supporting a wind turbine blade and for positioning the blade relative to a nacelle mounted on a mast supported in a wind turbine assembly station adjacent the lifting device.
69. Vessel according to clause 68, wherein the blade installer device comprises:
   a base configured to be mounted to the trolley, or to be integrated with a dedicated trolley;
   a connector, wherein the connector is configured for engaging a wind turbine blade, or for engaging a blade support that is removably mounted on the blade;
   a pivot arm, which is at a base end is connected to the base for, in use, pivoting about a vertical axis. and is at an opposite end connected to the connector for, in used pivoting about a vertical axis.
70. Vessel according to one or more of the clauses 57-69, wherein the trolley is configured for supporting an assembled wind turbine, and wherein the lifting device is provided with a second trolley, for engaging the mast of the assembled wind turbine at a lower end thereof, to stabilise the assembled wind turbine when supported by the lifting device.
71. Vessel according to one or more of the clauses 57-70, wherein the gripper is foundation gripper, configured to engage a floating foundation, to position the floating foundation in the horizontal plane relative to the vessel and/or to stabilise the floating foundation relative to the vessel.
72. Vessel according to one or more of the clauses 57-70, wherein the gripper is a monopile gripper, configured for guiding a monopile that is being lowered adjacent the vessel using the upend crane.
73. Vessel according to one or more of the clauses 57-72, wherein the vessel comprises a foundation gripper and a monopile gripper, preferably the pile gripper is integrated in the foundation gripper.
74. Method for upending a wind turbine component using a installation vessel according to one or more of the clauses 57-73, wherein the method comprising the steps:
   lifting a wind turbine component in a horizontal position onto an upend deck, using the crane with the boom in a hoisting position for lifting one end of the wind turbine component and a storage crane lifting an opposite end of the wind turbine component;
   moving the boom from the hoisting position into the raised upending position;
   engaging the wind turbine component with a wind turbine component engagement device supported by the load coupling device and/or the trolley;
   upending the wind turbine component using the crane with the boom in the upend position for lifting one end of the wind turbine component by moving the trolley along the boom from a lowered coupling position to a raised support position.
75. Method according to clause 74, wherein the wind turbine component is a monopile, wherein the gripper is a monopile gripper, and wherein the method further comprises the steps:
   after upending, moving the monopile from an upend location above the upend deck to an installation position, in which installation position the monopile is aligned with the monopile gripper, by slewing the crane about the vertical slew axis, over a slew angle of at least 180 degrees, preferably over a slew angle of more than 180 degrees, e.g. over an slew angle of 190 degrees, moving the monopile from the upend deck over the side of the vessel, and subsequently towards a monopile gripper mounted to the rear end of the hull of the vessel.

1. A vessel for offshore installation of a pile for supporting a wind turbine, the vessel comprising a hull, a lifting device, and a pile gripper, and having an X-Y plane,
wherein the lifting device comprises:
a base via which the lifting device is supported by hull;
an elongate, upright superstructure;
a pile engagement device movably arranged on the upright superstructure for movement in a Z-direction along the upright superstructure and configured to engage a top end of a pile; and
a lifting assembly connected to the pile engagement device and configured to move the pile engagement device in the Z-direction along the upright superstructure between a lower position in which the pile engagement device is at or near the base of the lifting device and an upper position wherein the pile engagement device is remote from the base and the pile extends in an upright orientation alongside the upright superstructure, for inboard upending of the pile and outboard lowering of the pile,
wherein the pile engagement device is configured to restrict movement of the engaged top end of a pile relative to the upright superstructure in a plane perpendicular to a longitudinal axis of the engaged pile,
wherein the pile gripper comprises:
a gripper base via which the pile gripper is supported by the hull; and
a gripper device configured to engage the upright oriented pile at a lower end thereof, so as to restrict movement thereof relative to the gripper base in the X-Y plane, perpendicular to the longitudinal axis of the pile in upright orientation, and to guide a vertical movement of the pile through the gripper device, in the direction of to the longitudinal axis of the pile,
wherein the pile engagement device and the gripper device are, whilst both engaging and supporting the pile, configured to be simultaneously movable relative to the hull in the X-Y plane from an inboard retaining position in which the pile engagement device is in the upper position and the pile is above the hull, to an outboard installation position in which the pile is outside a contour of the vessel, and
wherein the lifting device further comprises one or more displacement actuator assemblies operative between the vessel and the pile engagement device, and wherein the gripper base of the pile gripper further comprises one or more displacement actuator assemblies operative between the gripper base and the gripper device for actuating the movement of the pile engagement device and of the gripper device from the inboard retaining position to the outboard installation position.

2. The vessel according to claim 1, wherein the lifting device comprises a slew bearing between the base and the upright superstructure of the lifting device, wherein the slew bearing enables the superstructure to slew relative to the base about a slew axis extending in the Z-direction, and
wherein, considered in the X-Y plane of the vessel, the movement of the pile from the inboard retaining position to the outboard installation position involves a rotation of both the pile engagement device and the gripper device, and thus of the pile when engaged thereby, around the slew axis of the lifting device.

3. The vessel according to claim 1, wherein the gripper base comprises one or more gripper guides mounted to a deck of the hull and defining a track for the gripper device, the gripper device comprising one or more shoes for engaging the track, wherein the movement of the gripper device from the inboard retaining position to the outboard installation position of the pile involves moving the gripper device along the track.

4. The vessel according to claim 2, wherein the gripper base comprises one or more gripper guides mounted to a deck of the hull and defining a track for the gripper device, the gripper device comprising one or more shoes for engaging the track, wherein the movement of the gripper device from the inboard retaining position to the outboard installation position of the pile involves moving the gripper device along the track, and
wherein the movement of the gripper device from the inboard retaining position to the outboard installation position of the pile has a movement trajectory for the pile engagement device defined by the slew bearing of the lifting device, and for the gripper device by the track therefor, the track being a curved track.

5. The vessel according to claim 1, wherein, considered in the X-Y plane of the vessel, the base of the lifting device and the gripper base are spaced from one another, and the movement of the pile from the inboard retaining position to the outboard installation position has a movement trajectory which passes in between the base of the lifting device and the gripper base.

6. The vessel according to claim 1, wherein the movement of the pile from the inboard retaining position to the outboard installation position involves a relative movement of the pile engagement device with respect to the base of the lifting device opposite to the relative movement of the gripper device with respect to the gripper base.

7. The vessel according to claim 1, wherein the vessel comprises a recess in the longitudinal direction (X) of the vessel at a stern of the vessel, the recess being flanked laterally by two deck portions, wherein the trajectory of the movement from the inboard retaining position to the outboard installation position runs laterally in between the two deck portions, and wherein the outboard installation position is, considered in the X-Y plane of the vessel, inside the recess.

8. The vessel according to claim 5, wherein the vessel comprises a recess in the longitudinal direction (X) of the vessel at a stern of the vessel, the recess being flanked laterally by two deck portions, wherein the trajectory of the movement from the inboard retaining position to the outboard installation position runs laterally in between the two deck portions, and wherein the outboard installation position is, considered in the X-Y plane of the vessel, inside the recess, and
wherein the base of the lifting device is located at one lateral side of the recess, and the gripper base is located at the other lateral side of the recess.

9. The vessel according to claim 1, wherein the vessel comprises an upend deck, along which, for the purpose of upending by operation of the lifting assembly of the lifting device for lifting the top end of the pile, a bottom end of the pile is movable along a trajectory extending in the longitudinal direction (X) of the vessel from a position longitudinally distal from the base of the lifting device, to adjacent the base of the lifting device, in which the pile is upended to an upright orientation thereof alongside the upright superstructure in the inboard retaining position.

10. The vessel according to claim 1, wherein the gripper device comprises a ring comprising multiple pile engaging tools distributed about the circumference of the ring, each pile engaging tool being adapted to engage an exterior of the pile extending through the ring in the upright orientation thereof, each pile engaging tool comprising one or more pile guiding rollers.

11. The vessel according to claim 10, wherein the ring of the gripper device comprises a ring base and movable jaws forming respective segments of the ring and being movable between a closed position, in which the ring forms a closed annulus, and an opened position, the opened position enabling the pile to pass laterally into and out of the ring through an opening in the annulus between the jaws.

12. The vessel according to claim 9, wherein the ring of the gripper device comprises a ring base and movable jaws forming respective segments of the ring and being movable between a closed position, in which the ring forms a closed annulus, and an opened position, the opened position enabling the pile to pass laterally into and out of the ring through an opening in the annulus between the jaws, and
wherein the ring of the gripper device is slewable relative to the gripper base around a central slew axis of the ring in the closed position thereof, by means of one or more ring slew actuators, such that the opening between the jaws in the opened position of the ring is movable from an angular position with respect to the central slew axis in which the opening faces the upend deck of the hull of the vessel in the inboard retaining position of the pile, and an angular position with respect to the central slew axis in which the opening faces the water, including in the outboard installation position of the pile.

13. The vessel according to claim 1, further comprising a control unit operatively connected to the displacement actuator assemblies of the lifting device and to the displacement actuator assemblies of the gripper, the control unit being programmed for simultaneously operating the actuator assemblies of the lifting device and the pile gripper for simultaneously moving the pile engagement device and the gripper device relative to the vessel, and therewith, moving the engaged and supported pile, from the inboard retaining position to the outboard installation position.

14. The vessel according to claim 1, wherein the lifting device is a crane, the base of the lifting device is a crane base, the upright superstructure is an upright crane superstructure, and the lifting assembly is a hoisting assembly comprising one or more hoisting winches and one or more associated hoisting wires.

15. The vessel according to claim 1, wherein the upright superstructure of the lifting device is provided with a trolley guide comprising one or more guide rails extending along the upright superstructure in the longitudinal direction thereof, and the pile engaging device is arranged on the superstructure via a trolley movable along the trolley guide, wherein the lifting assembly is connected to the pile engagement device by a connection thereof to the trolley.

16. The vessel according to claim 14, wherein the upright superstructure of the lifting device is provided with a trolley guide comprising one or more guide rails extending along the upright superstructure in the longitudinal direction thereof, and the pile engaging device is arranged on the superstructure via a trolley movable along the trolley guide, wherein the lifting assembly is connected to the pile engagement device by a connection thereof to the trolley, and
wherein the hoisting assembly comprises an upper sheave assembly at the upright superstructure, and the hoisting assembly is connected to the pile engagement device via a load coupling device comprising a lower sheave assembly, the hoist wire being arranged in multiple falls through the upper and lower sheave assemblies to enable the crane to lift the load using the hoisting winch.

17. The vessel according to claim 14, wherein the upright crane superstructure comprises;
a crane housing; and
a boom, wherein the boom extends between a boom base end and a boom top end,
wherein the boom is, at the boom base end, pivotable supported by the crane housing around a horizontal boom pivot axis, the boom having lowered positions for lifting a load at a horizontal distance from the crane base, and a raised upend position to form the upright superstructure, for upending the pile alongside the crane base, and
wherein the crane further comprises a luffing winch and an associated luffing wire, wherein the luffing winch is mounted on the crane housing and the luffing wire extends between the luffing winch and the boom, to enable pivoting of the boom between the lowered and the raised upend position around the horizontal boom pivot axis.

18. The vessel according to claim 1, wherein the pile gripper comprises an active motion compensating actuation system for moving the gripper device relative to the vessel in an X-Y plane of the vessel, wherein the active motion compensating actuation system comprises an active sea state induced motion compensation mode in which the actuation system is operated to compensate for sea state induced motion of the vessel in the X-Y plane, including maintaining the outboard installation position independent of the sea state induced vessel motion.

19. The vessel according to claim 18, wherein the active motion compensation actuation system of the gripper comprises one or more first tracks and one or more second tracks extending non-parallel to one another in the X-Y plane of the vessel, the second tracks being movable over the first tracks, the actuation system further comprising one or more first compensating actuators operative between the first tracks and the second tracks, for moving the second tracks over the first tracks, and one or more second compensating actuators operative between the second tracks and the gripper device, for moving the gripper device over the second tracks.

20. The vessel according to claim 1, wherein the pile engagement device is arranged on an active motion compensating actuation system of the trolley, wherein the active motion compensating actuation system is configured for moving the pile engagement device relative to the trolley guide in an X-Y plane of the vessel, wherein the actuation system comprises an active sea state induced motion compensation mode in which the actuation system is operated to compensate for wave-induced motion of the vessel in the X-Y plane, including maintaining the outboard installation position independent of the sea state induced vessel motion.

21. The vessel according to claim 20, wherein the active motion compensation actuation system of the trolley comprises one or more first tracks and one or more second tracks extending non-parallel to one another in the X-Y plane of the vessel, the second tracks being movable over the first tracks, the actuation system further comprising one or more first compensating actuator assemblies operative between the first tracks and the second tracks, for moving the second tracks over the first tracks, and one or more second compensating actuator assemblies operative between the second tracks and the pile engagement device and/or the coupler therefor, for moving the pile engagement device and/or the coupler over the second tracks.

22. The vessel according to claim 13, wherein the control unit is operatively connected to, and programmed to simultaneously operate, the active motion compensating actuation systems of the lifting device and the pile gripper, for synchronously and correspondingly moving in the X-Y plane of the vessel the pile engagement device and the gripper device relative to the vessel, so as to compensate for sea state induced motions of the vessel in the X-Y plane, including maintaining the outboard installation position independent of the sea state induced vessel motion.

23.-30. (canceled)
